(19) United States
(12) Patent Application Publication
(10) Pub. No.: US 2026/0339266 A1
(43) Pub. Date: Oct. 29, 2026

(54) IMAGE FORMING APPARATUS

(71) Applicant: CANON KABUSHIKI KAISHA, Tokyo (JP)

(72) Inventors: Noriyuki Komatsu, Shizuoka (JP); Osamu Koyama, Shizuoka (JP); Takuya Kawakami, Shizuoka (JP)

(21) Appl. No.: 19/649,228

(22) Filed: Apr. 16, 2026

(30) Foreign Application Priority Data
Apr. 23, 2025 (JP) 2025-071833

(51) Int. Cl. G03G 21/18; G03G 15/01; G03G 15/08; G03G 21/16

(52) U.S. Cl. CPC G03G 21/185; G03G 15/0121; G03G 15/0126; G03G 15/0189; G03G 15/0808; G03G 15/0865; G03G 15/0886; G03G 21/1619; G03G 21/1647; G03G 2221/1654

(57) ABSTRACT

An image forming apparatus includes an apparatus main body, a pull-out unit that includes a photosensitive drum, a first frame, and a developing unit, and that is movable between an inner position and an outer position, and a toner cartridge that is attachable to and detachable from the developing unit. The developing unit includes (i) a developing roller, (ii) a second frame movable with respect to the first frame, and (iii) a rotary member disposed to protrude in the first direction with respect to an end surface of the second frame in the first direction and configured to rotate in contact with the first frame in a case where the developing roller comes into contact with or separates from the photosensitive drum.

### BACKGROUND

### Field of the Technology

The present disclosure relates to an image forming apparatus that forms an image on a recording medium.

### Description of the Related Art

Japanese Patent Application Laid-Open No. 2011-186068 discloses an image forming apparatus including a drum unit that includes a photosensitive drum and that can be pulled out from an image forming apparatus main body, a developing cartridge attachable to and detachable from the drum unit, and a toner cartridge attachable to and detachable from the developing cartridge.

### SUMMARY

An aspect of the present disclosure provides an image forming apparatus including an apparatus main body, a pull-out unit that includes a photosensitive drum configured to rotate about a rotation axis extending in a first direction, a first frame configured to support the photosensitive drum, and a developing unit, and that is movable between an inner position where the pull-out unit is accommodated in the apparatus main body and an outer position to which the pull-out unit is pulled out from the inner position toward an outside of the apparatus main body, and a toner cartridge that is configured to store toner to be supplied to the developing unit and that is attachable to and detachable from the developing unit in a case where the pull-out unit is at the outer position, wherein the developing unit includes (i) a developing roller configured to supply the toner to the photosensitive drum, (ii) a second frame configured to support the developing roller and movable with respect to the first frame such that the developing roller comes into contact with and separates from the photosensitive drum, and (iii) a rotary member disposed to protrude in the first direction with respect to an end surface of the second frame in the first direction and configured to rotate in contact with the first frame in a case where the developing roller comes into contact with or separates from the photosensitive drum.

Another aspect of the present disclosure provides an image forming apparatus including an apparatus main body, a pull-out unit that includes a photosensitive drum configured to rotate about a rotation axis extending in a first direction, a first frame configured to support the photosensitive drum, and a developing unit, and that is movable between an inner position where the pull-out unit is accommodated in the apparatus main body and an outer position to which the pull-out unit is pulled out from the inner position toward an outside of the apparatus main body, and a toner cartridge that is configured to store toner to be supplied to the developing unit and that is attachable to and detachable from the developing unit in a case where the pull-out unit is at the outer position, wherein the developing unit includes (i) a developing roller configured to supply the toner to the photosensitive drum, (ii) a second frame configured to support the developing roller and movable in an intersecting direction intersecting with the first direction with respect to the first frame, and (iii) a movable member that is movable in the first direction between a first position and a second position with respect to the second frame and configured to move in the intersecting direction together with the second frame, the movable member including a shaft extending in the first direction, a first abutting portion provided on a first end side of the shaft in the first direction, and a second abutting portion provided on a second end side of the shaft in the first direction, wherein the first frame is provided with a first abutted portion and a second abutted portion, wherein the developing roller is configured to abut the photosensitive drum in a case where the movable member is positioned at the first position, and wherein the first abutting portion and the second abutting portion are configured to abut the first abutted portion and the second abutted portion, respectively, to receive force in the intersecting direction in a case where the movable member moves from the first position toward the second position, such that the developing roller separates from the photosensitive drum.

Another aspect of the present disclosure provides an image forming apparatus including an apparatus main body having an opening, a pull-out unit that includes a first attachment portion and a second attachment portion and that is movable between an inner position and an outer position through the opening, the inner position being a position where the pull-out unit is accommodated in the apparatus main body, the outer position being a position to which the pull-out unit is pulled out from the inner position toward an outside of the apparatus main body, a first toner cartridge that is configured to store first toner and that is attachable to and detachable from the first attachment portion in a case where the pull-out unit is at the outer position, and a second toner cartridge that is configured to store second toner and that is attachable to and detachable from the second attachment portion in the case where the pull-out unit is at the outer position, wherein the first toner cartridge includes a first engaging portion, wherein the second toner cartridge includes a second engaging portion, wherein the pull-out unit includes a first engaged portion and a second engaged portion, wherein in a case where the first toner cartridge is attached to the first attachment portion, the first engaging portion engages with the first engaged portion, and entirety of the first toner cartridge is inside the opening as viewed in a movement direction in which the pull-out unit moves from the outer position toward the inner position, wherein in a case where the second toner cartridge is attached to the second attachment portion, the second engaging portion engages with the second engaged portion, and entirety of the second toner cartridge is inside the opening as viewed in the movement direction, wherein in a case where the first toner cartridge is attached to the second attachment portion, the first engaging portion does not engage with the second engaged portion, and at least part of the first toner cartridge is outside the opening as viewed in the movement direction, and wherein in a case where the second toner cartridge is attached to the first attachment portion, the second engaging portion does not engage with the first engaged portion, and at least part of the second toner cartridge is outside the opening as viewed in the movement direction.

Features of the present disclosure will become apparent from the following description of embodiments with reference to the attached drawings. The following description of embodiments is described by way of example.

### BRIEF DESCRIPTION OF THE DRAWINGS

FIG. 1 is a section view of an image forming apparatus according to a first embodiment.

FIGS. 2A and 2B are each a perspective view of the image forming apparatus according to the first embodiment.

FIG. 3 is a perspective view of a cartridge tray and toner cartridges according to the first embodiment.

FIG. 4 is a section view of the cartridge tray and a toner cartridge according to the first embodiment.

FIGS. 5A and 5B are each a perspective view of the toner cartridge according to the first embodiment.

FIG. 6 is a section view of the toner cartridge according to the first embodiment.

FIG. 7 is a perspective view of a shutter of the toner cartridge according to the first embodiment.

FIG. 8 is a perspective view of part of the toner cartridge according to the first embodiment.

FIG. 9A is a perspective view of a developing unit according to the first embodiment.

FIG. 9B is a side view of the developing unit according to the first embodiment.

FIG. 10A is a perspective view of the developing unit according to the first embodiment.

FIG. 10B is a side view of the developing unit according to the first embodiment.

FIG. 11 is an exploded perspective view of the developing unit according to the first embodiment.

FIG. 12 is an exploded perspective view of the developing unit according to the first embodiment.

FIG. 13 is a section view of the developing unit according to the first embodiment.

FIG. 14 is a perspective view of the developing unit according to the first embodiment.

FIGS. 15A and 15B are each a perspective view of a shutter of the developing unit according to the first embodiment.

FIG. 16 is a perspective view of a memory tag unit of the developing unit according to the first embodiment.

FIG. 17 is an exploded perspective view of the memory tag unit of the developing unit according to the first embodiment.

FIG. 18 is a perspective view of the cartridge tray according to the first embodiment.

FIG. 19 is a perspective view of the cartridge tray according to the first embodiment.

FIG. 20 is a perspective view of the cartridge tray according to the first embodiment.

FIG. 21 is a side view of the cartridge tray according to the first embodiment.

FIG. 22 is a perspective view of the cartridge tray according to the first embodiment.

FIG. 23 is a side view of the cartridge tray according to the first embodiment.

FIG. 24 is a section view of the cartridge tray according to the first embodiment.

FIG. 25 is an enlarged perspective view of the cartridge tray according to the first embodiment.

FIG. 26 is an explanatory diagram of coupling of the developing unit according to the first embodiment.

FIG. 27 is an explanatory diagram of coupling of the developing unit according to the first embodiment.

FIG. 28 is an explanatory diagram of coupling of the developing unit according to the first embodiment.

FIG. 29 is an explanatory diagram of coupling of the developing unit according to the first embodiment.

FIGS. 30A to 30C are each an explanatory diagram of an operation of a developing unit pressing member according to the first embodiment.

FIG. 31A is a perspective view of a developing unit locking member according to the first embodiment.

FIG. 31B is a side view of a developing unit locking member according to the first embodiment.

FIGS. 32A and 32B are each an explanatory diagram of coupling of the memory tag unit of the developing unit according to the first embodiment.

FIG. 33 is a section view of the cartridge tray according to the first embodiment.

FIG. 34 is a section view of the cartridge tray according to the first embodiment.

FIG. 35 is an explanatory diagram of attachment of the toner cartridge according to the first embodiment.

FIG. 36 is an explanatory diagram of attachment of the toner cartridge according to the first embodiment.

FIGS. 37A and 37B are each an explanatory diagram of attachment of the toner cartridge according to the first embodiment.

FIGS. 38A to 38C are each an explanatory diagram of attachment of the toner cartridge according to the first embodiment.

FIGS. 39A and 39B are each a section view illustrating an operation of the shutter according to the first embodiment.

FIG. 40 is a section view of the developing unit and the toner cartridge according to the first embodiment.

FIG. 41 is a diagram illustrating the positional relationship between rolling members and the toner cartridge according to the first embodiment.

FIG. 42 is an exploded perspective view of a separation member according to the first embodiment.

FIGS. 43A and 43B are each a top view of the separation member and the toner cartridge according to the first embodiment.

FIG. 44 is a section view of a photosensitive drum, the developing unit, and the toner cartridge according to the first embodiment.

FIG. 45 is a top view of the developing unit and the toner cartridge according to the first embodiment.

FIG. 46 is a section view of the photosensitive drum, the developing unit, and the toner cartridge according to the first embodiment.

FIG. 47 is a top view of the developing unit and the toner cartridge according to the first embodiment.

FIG. 48 is a perspective view of guide portions according to a modification example.

FIGS. 49A and 49B are each an explanatory diagram of attachment of toner cartridges according to a second embodiment.

FIG. 50 is a perspective view of the toner cartridge according to the second embodiment.

FIGS. 51A to 51C are each an explanatory diagram of attachment of the toner cartridge according to the second embodiment.

FIGS. 52A and 52B are each an explanatory diagram of attachment of toner cartridges according to a modification example.

FIG. 53 is an explanatory diagram of attachment of a toner cartridge according to a modification example.

### DESCRIPTION OF THE EMBODIMENTS

Embodiments of the present disclosure will be described with reference to drawings.

### First Embodiment

An image forming apparatus 1 according to an embodiment (first embodiment) of the present disclosure will be described with reference to drawings.

In the description below, the direction of a rotation axis of a photosensitive drum 4 included in the image forming apparatus 1 will be referred to as a drum axis direction D1. A movement direction which intersects with the drum axis direction D1 and in which a toner cartridge 100 is attached to and detached from a cartridge tray 3 (process unit, pull-out unit) will be referred to as a cartridge attachment/detachment direction D2. A movement direction in which the cartridge tray 3 is attached to and detached from an apparatus main body of the image forming apparatus 1 will be referred to as a tray movement direction D3. The drum axis direction D1 and the cartridge attachment/detachment direction D2 intersect with each other, preferably at a right angle. In addition, the cartridge attachment/detachment direction D2 and the tray movement direction D3 intersect with each other, preferably at a right angle. In addition, the tray movement direction D3 and the drum axis direction D1 intersect with each other, preferably at a right angle.

One of the drum axis direction D1, the cartridge attachment/detachment direction D2, and the tray movement direction D3 can be referred to as a first direction, another of the three directions can be referred to as a second direction, and the remaining one of the three directions can be referred to as a third direction. For example, in the case where the drum axis direction D1 is referred to as a first direction, the cartridge attachment/detachment direction D2 can be referred to as a second direction, and the tray movement direction D3 can be referred to as a third direction.

The drum axis direction D1 may be referred to as the longitudinal direction of a developing unit 8, or simply as a longitudinal direction in some cases. In addition, in the description below, with respect to the image forming apparatus 1, the side on which a front door 40 is provided will be referred to as a front side or front-face side, and the side opposite to the front side will be referred to as a rear side or rear-face side. In addition, in each embodiment described below, at least part of a driving system for driving the photosensitive drum 4 and the like is disposed on the left side of the image forming apparatus 1 in the case where the image forming apparatus 1 is viewed from the front side to the rear side. Therefore, in each embodiment described below, the left side of the image forming apparatus 1 as viewed from the front side will be referred to as a driving side, and the right side of the image forming apparatus 1 will be referred to as a non-driving side.

The drum axis direction D1 and the tray movement direction D3 in the embodiments described below are each a direction closer to the horizontal direction than to the vertical direction (gravity direction). The cartridge attachment/detachment direction D2 is a direction closer to the vertical direction (gravity direction) than to the horizontal direction. The drum axis direction D1 and the tray movement direction D3 may be horizontal. The cartridge attachment/detachment direction D2 may coincide with the vertical direction (gravity direction).

### Overview of Image Forming Apparatus

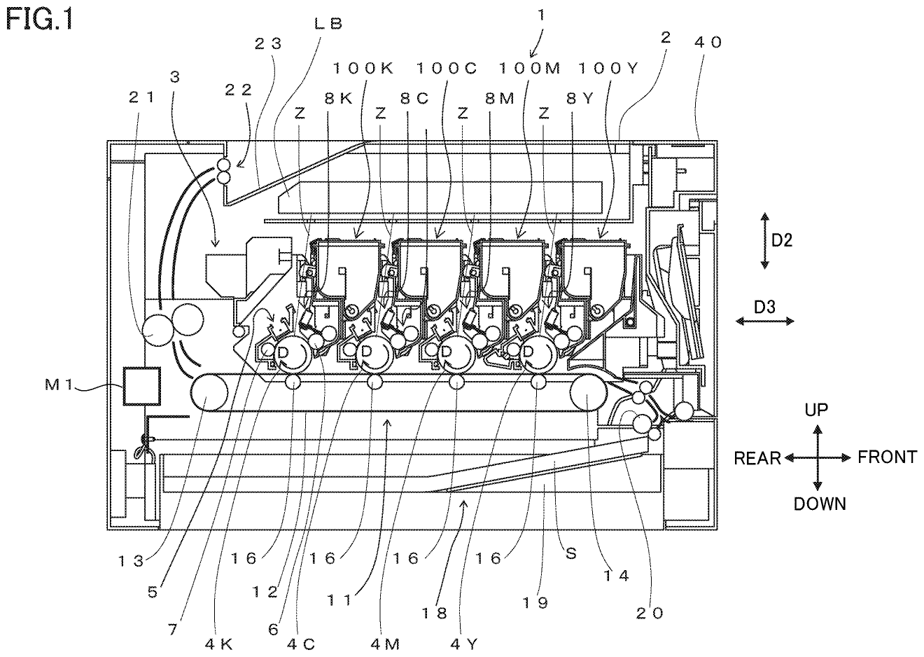

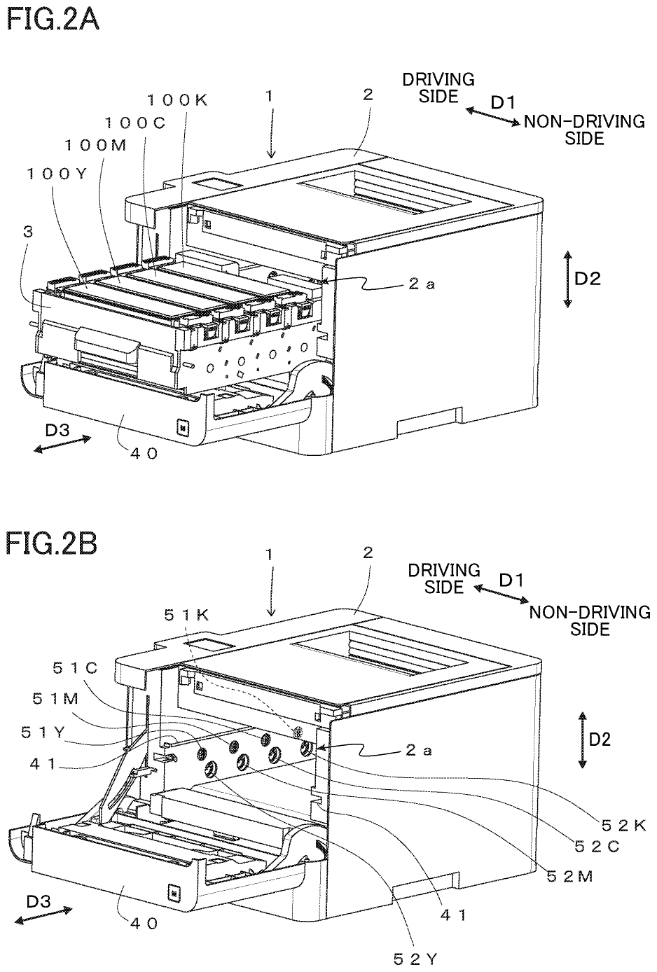

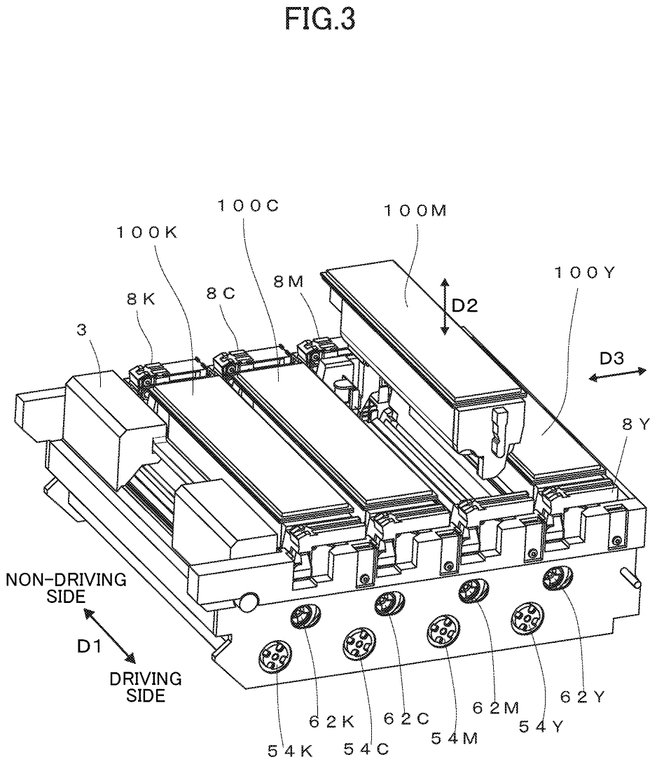

An overall configuration of the image forming apparatus 1 will be described. FIG. 1 is a schematic diagram illustrating a cross-section of the image forming apparatus 1 according to the present embodiment. FIGS. 2A and 2B are each a perspective view of the image forming apparatus 1 according to the present embodiment. FIG. 3 is a perspective view of the cartridge tray 3, developing units 8Y, 8M, 8C, and 8K, and toner cartridges 100Y, 100M, 100C, and 100K.

As illustrated in FIGS. 1, 2A, and 2B, the image forming apparatus 1 includes an apparatus main body 2, a cartridge tray 3, developing units 8, and toner cartridges 100. The image forming apparatus 1 is a four-color full-color laser printer capable of forming a color image on a recording medium S by an electrophotographic process.

The apparatus main body 2 according to the present embodiment is a part of the image forming apparatus 1 excluding the cartridge tray 3, the developing units 8Y to 8K, and the toner cartridges 100Y to 100K.

The cartridge tray 3 includes four photosensitive drums 4Y, 4M, 4C, and 4K, and four developing units 8Y, 8M, 8C, and 8K. The toner cartridges 100Y, 100M, 100C, and 100K are detachably attached to the cartridge tray 3. The toner cartridges 100Y, 100M, 100C, and 100K of the present embodiment are respectively detachably attached to the developing units 8Y, 8M, 8C, and 8K. The toner cartridge 100 stores toner. In a state in which the toner cartridge 100 is attached to the developing unit 8, the toner stored in the toner cartridge 100 is supplied to the developing unit 8.

The photosensitive drums 4Y to 4K may have the same configuration. The suffices Y, M, C, and K of the reference signs of the developing units 8Y, 8M, 8C, and 8K and the toner cartridges 100Y, 100M, 100C, and 100K indicate the color of toner used as developer (Y: yellow, M: magenta, C: cyan, K: black). The four developing units 8Y to 8K may have the same configuration except for the color of toner. The four toner cartridges 100Y to 100K may have the same configuration except for the color of toner. In the description below, “photosensitive drum 4” refers to an arbitrary one of the photosensitive drums 4Y to 4K, “developing unit 8” refers to arbitrary one of the developing units 8Y to 8K, and “toner cartridge 100” refers to arbitrary one of the toner cartridges 100Y to 100K.

One of the photosensitive drums 4Y to 4K can be referred to as a first photosensitive drum, and the developing unit 8 corresponding to this can be referred to as a first developing unit. Another one of the photosensitive drums 4Y to 4K can be referred to as a second photosensitive drum, and the developing unit 8 corresponding to this can be referred to as a second developing unit.

In the present embodiment, the four developing units 8Y to 8K are accommodated in one cartridge tray 3. The four developing units 8Y to 8K respectively store toners of different colors (for example, yellow, cyan, magenta, and black). To be noted, the number of the developing units 8 attached to the cartridge tray 3 may be 3 or less, or 5 or more. In addition, the color of the toner stored in the developing unit 8 is not limited to the colors described above.

As illustrated in FIGS. 1 to 3, the image forming apparatus 1 includes a laser scanner unit LB serving as an exposing means, an electrostatic transfer device 11 serving as a transfer means, and a feeding unit 18 serving as a feeding means. In addition, the image forming apparatus 1 includes a fixing unit 21 serving as a fixing means, and a discharge unit 22 serving as a discharge means.

The laser scanner unit LB is provided above the cartridge tray 3. The laser scanner unit LB outputs laser light Z in correspondence with image information, and thus scans and exposes the surface of the photosensitive drums 4Y, 4M, 4C, and 4K.

The electrostatic transfer device 11 is provided below the developing units 8Y to 8K and the cartridge tray 3. The electrostatic transfer device 11 includes a driving roller 13, a driven roller 14, and a transfer belt 12 stretched by the driving roller 13 and the driven roller 14. Each photosensitive drum 4 is in contact with the outer peripheral surface of the transfer belt 12. Transfer rollers 16 are disposed on the inner peripheral side of the transfer belt 12 so as to oppose the respective photosensitive drums 4.

The feeding unit 18 is provided below the electrostatic transfer device 11. The feeding unit 18 includes a feeding tray 19 in which recording media S are stacked and stored, and a feeding roller 20 serving as a feeding member that feeds the recording medium S from the feeding tray 19. To be noted, as the recording medium S, a wide variety of sheet materials of different sizes and materials can be used. Examples of the sheet materials include paper sheets such as plain paper sheets and cardboards, surface-treated sheet materials such as coated paper sheets, sheet materials of irregular shapes such as envelopes and index paper sheets, plastic films, and cloths.

The fixing unit 21 and the discharge unit 22 are provided in an upper portion of the apparatus main body 2. The fixing unit 21 includes, for example, a fixing roller serving as a heating member, a pressurizing roller serving as a pressurizing member that forms a fixing nip together with the fixing roller, and a heating means that heats the fixing roller. As the heating means, a halogen lamp that radiates heat, or a coil for generating heat in a conductive layer in the fixing roller by induction heating can be used. A discharge tray 23 on which recording media S discharged to the outside of the apparatus main body 2 are to be stacked is provided on the upper surface of the apparatus main body 2.

As illustrated in FIGS. 2A and 2B, the image forming apparatus 1 includes a front door 40. A body opening 2a serving as an opening of the apparatus main body 2 is formed on the front side of the image forming apparatus 1. The front door 40 is movable (openable and closable) between a closed position (FIG. 1) to close the body opening 2a and an open position (FIGS. 2A and 2B) to open the body opening 2a with respect to the apparatus main body 2.

In a state in which the front door 40 is at the open position, the user can pull out the cartridge tray 3 to the outside of the apparatus main body 2 as illustrated in FIG. 2A. The apparatus main body 2 is provided with tray pull-out rails 41 that guide the movement of the cartridge tray 3 (FIG. 2B). The tray pull-out rails 41 guide guided portions provided at respective end portions of the cartridge tray 3 in the drum axis direction D1.

The cartridge tray 3 is movable to an inner position (FIG. 1) where the cartridge tray 3 is accommodated in the apparatus main body 2, and an outer position (FIG. 2A) where the cartridge tray 3 has been pulled out toward the outside of the apparatus main body 2 from the inner position. The image forming operation that will be described later is executed in a state in which the cartridge tray 3 is at the inner position. In addition, in a state in which the cartridge tray 3 is at the outer position, the attachment and detachment of the toner cartridge 100 to and from an attachment portion 150 of the cartridge tray 3 are allowed.

The cartridge tray 3 moves between the inner position and the outer position in the tray movement direction D3 intersecting with the drum axis direction D1. In the tray movement direction D3, a direction from the inner position toward the outer position will be referred to as a pull-out direction of the cartridge tray 3, and a direction from the outer position toward the inner position will be referred to as an attachment direction of the cartridge tray 3.

Each toner cartridge 100 is attachable to and detachable from an attachment portion provided in the cartridge tray 3. The toner cartridge 100 is attachable to and detachable from the apparatus main body 2 by the attachment and detachment to and from the cartridge tray 3. That is, as a result of the cartridge tray 3 being accommodated in the inner position in a state in which the toner cartridge 100 is attached to the cartridge tray 3, the toner cartridge 100 is attached to the apparatus main body 2. In addition, the toner cartridge 100 is detached from the apparatus main body 2 by detaching the toner cartridge 100 from the cartridge tray 3 pulled out to the outer position.

The toner cartridges 100Y, 100M, 100C, and 100K of the present embodiment are individually attachable to and detachable from the developing units 8Y, 8M, 8C, and 8K provided on the cartridge tray 3. FIG. 3 illustrates a state in which one toner cartridge 100M has been detached from the cartridge tray 3.

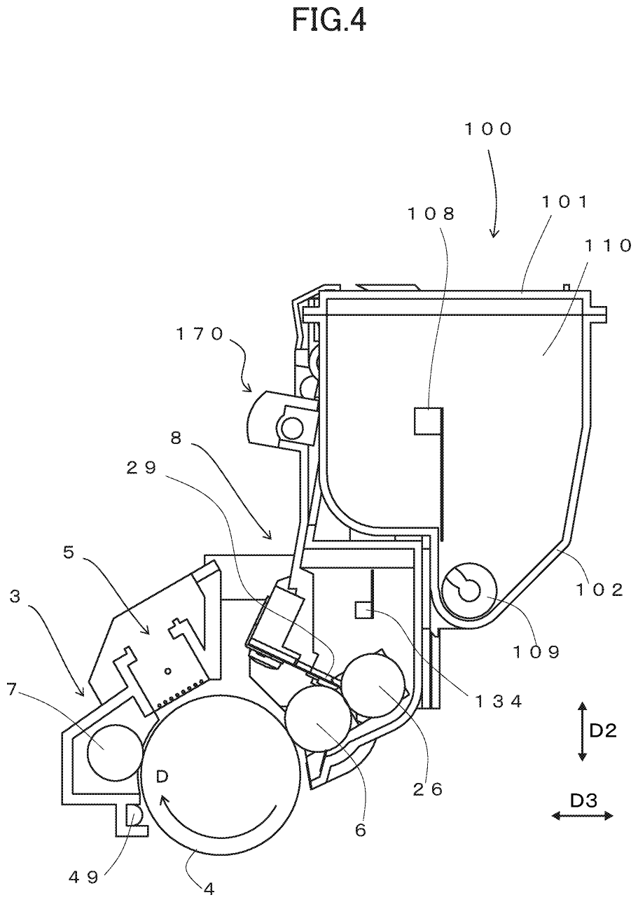

FIG. 4 is a section view of part of the cartridge tray 3 and the toner cartridge 100 according to the present embodiment. In FIG. 4, one photosensitive drum 4 and one developing unit 8 on the cartridge tray 3, and one toner cartridge 100 corresponding to the developing unit 8 are illustrated.

As illustrated in FIG. 4, the cartridge tray 3 includes photosensitive drums 4, developing units 8, corona chargers 5 serving as charging means, and cleaning rollers 7 serving as cleaning means. The photosensitive drum 4 rotates about a rotation axis extending in the drum axis direction D1. The developing unit 8, the corona charger 5, and the cleaning roller 7 are disposed in correspondence with each photosensitive drum 4.

The developing unit 8 includes a toner storage portion 110, and a developing roller 6. The developing roller 6 rotates about a rotation axis extending in the drum axis direction D1. The developing roller 6 functions as a developer bearing member that bears toner stored in the toner storage portion 110 and supplies the toner to the photosensitive drum 4. Details of the developing unit 8 will be described later.

One photosensitive drum 4, and a developing unit 8, a corona charger 5, and a cleaning roller 7 corresponding to this photosensitive drum 4 constitute one process portion. The cartridge tray 3 of the present embodiment includes four process portions.

### Image Forming Operation

The image forming operation will be described with reference to FIGS. 1 to 4. The image forming operation is a series of operations in which the image forming apparatus 1 forms an image on a recording medium S while conveying the recording medium S. The image forming operation of forming a full-color image will be described below.

The image forming operation is executed in a state in which the cartridge tray 3 and the toner cartridges 100Y to 100K are attached to the image forming apparatus 1 as illustrated in FIG. 1. That is, the toner cartridges 100Y to 100K are attached to the cartridge tray 3, the cartridge tray 3 is inserted to the inner position, the front door 40 is closed, and thus attachment of the cartridge tray 3 and the toner cartridges 100Y to 100K is completed.

In accordance with the operation of closing the front door 40, drum driving couplings 52Y, 52M, 52C, and 52K provided in the image forming apparatus 1 engage with drum input couplings 54Y, 54M, 54C, and 54K provided in the cartridge tray 3 (FIGS. 2B and 3). The drum driving couplings 52Y, 52M, 52C, and 52K are coupled to a motor M1 (FIG. 1) serving as a drive source disposed in the apparatus main body 2 via a drive transmission portion such as a gear train. The drum input couplings 54Y, 54M, 54C, and 54K are respectively coupled to the photosensitive drums 4Y, 4M, 4C, and 4K.

In the image forming operation, each photosensitive drum 4 is rotationally driven by the motor M1 of the apparatus main body 2. That is, the driving force of the motor M1 is transmitted to the photosensitive drums 4Y, 4M, 4C, and 4K via engagement between the drum driving couplings 52Y, 52M, 52C, and 52K and the drum input couplings 54Y, 54M, 54C, and 54K. As a result of this, each photosensitive drum 4 rotates in a predetermined rotation direction (arrow D direction in FIG. 1) at a predetermined peripheral speed (process speed). As a result of application of a charging voltage to the corona charger 5 (FIG. 4) corresponding to each photosensitive drum 4, the surface of the photosensitive drum 4 is uniformly charged to a predetermined potential and a predetermined polarity.

The laser scanner unit LB is driven on the basis of a time-series image signal (video signal) generated by the controller of the image forming apparatus 1 on the basis of, for example, image information received from the outside. The laser scanner unit LB emits laser light Z (FIG. 1) on the basis of the video signal, and exposes the surface of each photosensitive drum 4 by scanning the surface with the laser light Z. As a result of this, an electrostatic latent image is formed on the surface of each photosensitive drum 4. This electrostatic latent image is developed by the developing unit 8. The developing roller 6 is rotationally driven at a predetermined speed, supplies toner to an opposing portion (developing portion, developing gap) where the developing roller 6 opposes the photosensitive drum 4, and thus develops the electrostatic latent image into a toner image.

As a result of this process, a yellow toner image corresponding to a yellow component of the image information is formed on the first photosensitive drum 4Y. Similarly, magenta, cyan, and black toner images are formed on the second to fourth photosensitive drums 4M, 4C, and 4K.

Meanwhile, the recording media S are fed one by one at a predetermined control timing. The transfer belt 12 is rotationally driven in a counterclockwise direction in FIG. 1 by the rotation of the driving roller 13. The recording medium S is conveyed to the transfer portion formed between each photosensitive drum 4 and the transfer roller 16 corresponding thereto in a state in which the recording medium S is electrostatically attracted to the outer peripheral surface of the transfer belt 12.

A transfer voltage is applied to the transfer roller 16, charges are supplied to the recording medium S, and thus a bias electric field is formed at the transfer portion. As a result of this electric field, a toner image is transferred from the photosensitive drum 4 onto the recording medium S when the recording medium S passes through the transfer portion. While the recording medium S passes through the four transfer portions, toner images of respective colors are transferred onto the recording medium S so as to be superimposed on each other, and thus a full-color toner image is formed on the recording medium S.

The recording medium S to which a toner image has been transferred is subjected to a fixing process of the image by the fixing unit 21. The fixing unit 21 executes the fixing process by heating and pressurizing the toner on the recording medium S while nipping and conveying the recording medium S at a fixing nip. The recording medium S having passed through the fixing unit 21 is discharged to the outside of the apparatus main body 2 by the discharge unit 22, and is stacked on the discharge tray 23.

### Toner Cartridge

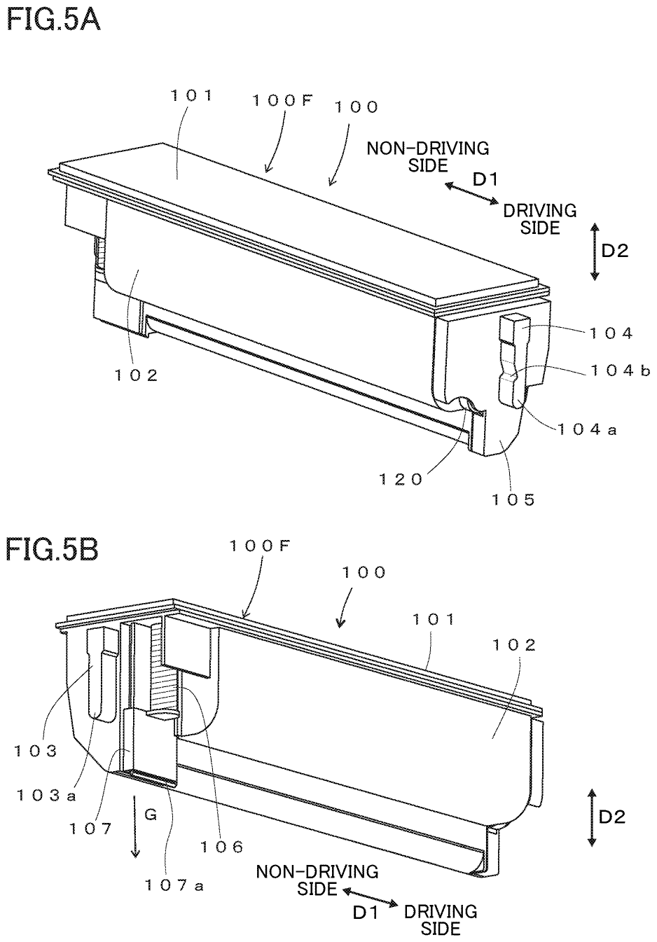

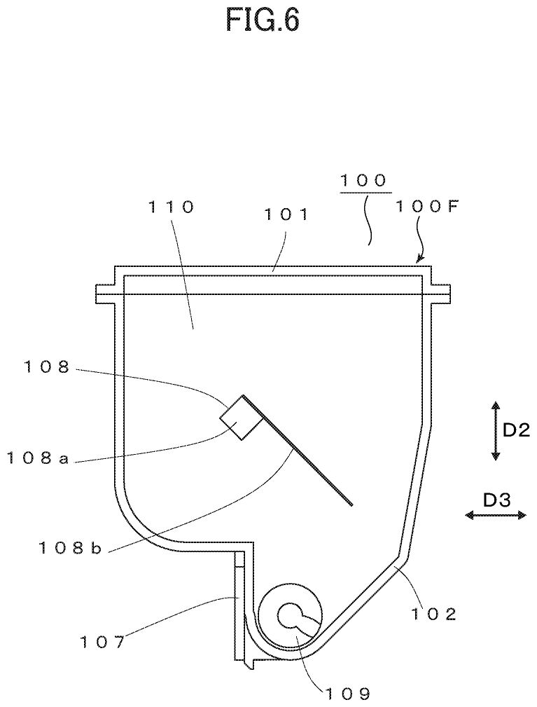

A configuration of the toner cartridge 100 will be described with reference to FIGS. 5A to 8. FIGS. 5A and 5B are each a perspective view of the toner cartridge 100. FIG. 6 is a section view of the toner cartridge 100.

As illustrated in FIGS. 5A, 5B, and 6, the toner cartridge 100 includes a storage frame 102, a lid member 101, a cover member 105, and a discharge port shutter 107. The storage frame 102 and the lid member 101 define a toner storage portion 110 (toner storage chamber, storage space) for storing toner in the toner cartridge 100.

As illustrated in FIG. 5A, the cover member 105 is attached to a driving-side end portion of the toner cartridge 100. The cover member 105 is fixed to the storage frame 102 with a screw member, an adhesive, or the like. In the present embodiment, the storage frame 102, the lid member 101, and the cover member 105 fixed to each other constitute a frame 100F of the toner cartridge 100.

The cover member 105 is provided with a guide 104. In addition, as illustrated in FIG. 5B, a guide 103, the discharge port shutter 107, and a shutter spring 106 are provided at a non-driving-side end portion of the toner cartridge 100.

Guides 103 and 104 engage with part of the developing unit 8 when attaching the toner cartridge 100 to the developing unit 8. The guides 103 and 104 will be described in detail later.

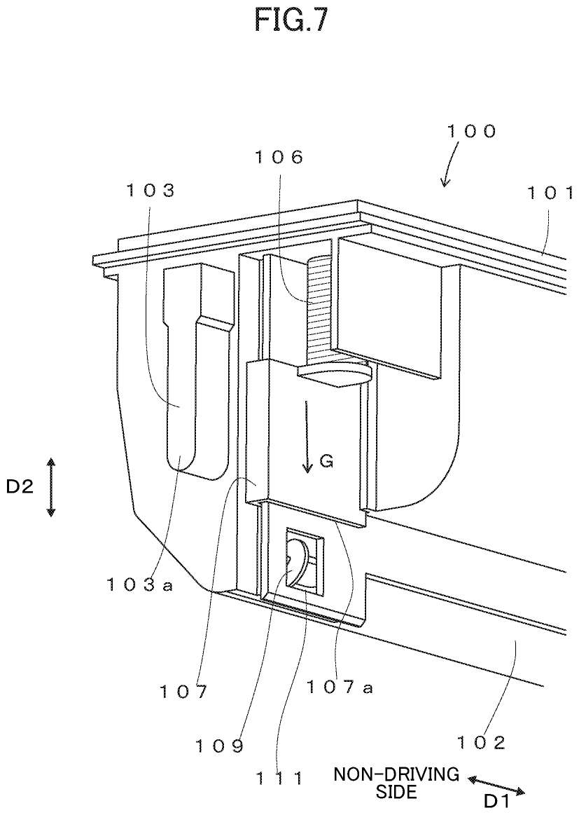

The configuration related to the discharge port shutter 107 will be described with reference to FIGS. 5B and 7. FIG. 7 is a perspective view of the non-driving-side end portion of the toner cartridge 100 in a state in which the discharge port shutter 107 is open.

As illustrated in FIG. 7, a discharge port 111 for discharging the toner in the toner storage portion 110 is provided in the storage frame 102. The discharge port shutter 107 is movable between a closed position (FIG. 5A) to close the discharge port 111 and an open position (FIG. 7) to open the discharge port 111 with respect to the storage frame 102. The discharge port shutter 107 is urged in a direction from the open position toward the closed position (arrow G in the drawings) by the shutter spring 106.

The discharge port shutter 107 includes a force receiving portion 107a. As a result of the force receiving portion 107a receiving a force in a direction opposite to the urging direction (arrow G in the drawings) of the shutter spring 106 in a state in which the discharge port shutter 107 is at the closed position as illustrated in FIG. 5B, the discharge port shutter 107 can move from the closed position to the open position.

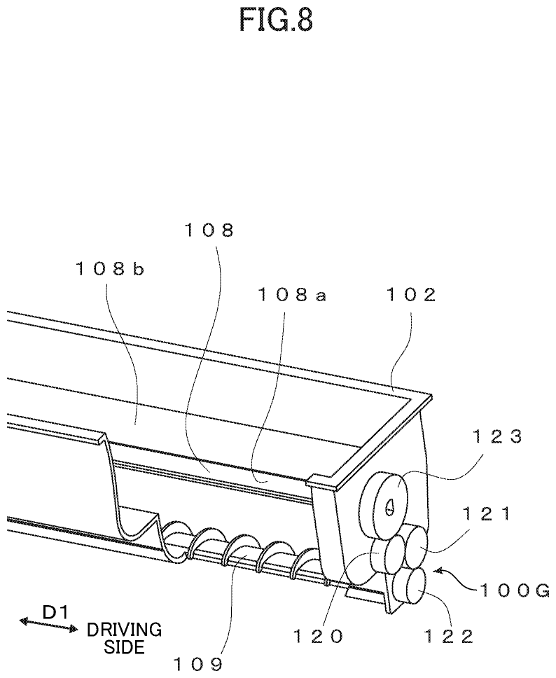

Next, agitation and conveyance of the toner in the toner storage portion 110 will be described. FIG. 8 is a perspective view of the toner storage portion 110. In FIG. 8, for the sake of convenience of description, illustration of some parts (for example, the cover member 105) is omitted, and some parts (for example, the storage frame 102) is illustrated in a cutout state. As illustrated in FIGS. 6 and 8, a toner agitation member 108 and a toner conveyance member 109 are provided in the toner storage portion 110.

The toner agitation member 108 includes an agitation shaft 108a extending in the longitudinal direction, and an agitation sheet 108b fixed to the agitation shaft 108a. The toner agitation member 108 rotates about an axis passing through the agitation shaft 108a, and agitates the toner in the toner storage portion 110 by the agitation sheet 108b.

The toner conveyance member 109 is, for example, a screw, and rotates about an axis extending in the longitudinal direction. When the toner conveyance member 109 is rotationally driven, the toner in the toner storage portion 110 is conveyed from the driving side toward the non-driving side in the longitudinal direction. The discharge port 111 is disposed at an end portion of the toner storage portion 110 on the non-driving side. The toner in the toner storage portion 110 can be efficiently discharged through the discharge port 111 by the toner conveyance member 109.

A configuration for driving the toner agitation member 108 and the toner conveyance member 109 will be described. As illustrated in FIG. 8, a drive input gear 120, an agitation gear 123, a conveyance gear 122, and an idler gear 121 are provided at the driving-side end portion of the toner cartridge 100. The drive input gear 120, the agitation gear 123, the conveyance gear 122, and the idler gear 121 constitute a gear train 100G serving as a drive transmission mechanism in the toner cartridge 100.

The agitation gear 123 is coupled to the driving-side end portion of the toner agitation member 108 (end portion of the agitation shaft 108a). The conveyance gear 122 is coupled to the driving-side end portion of the toner conveyance member 109. The agitation gear 123 is engaged with the drive input gear 120. The conveyance gear 122 is engaged with the drive input gear 120 via the idler gear 121.

A driving force is input to the drive input gear 120 from the motor M1 (FIG. 1) serving as a drive source provided in the apparatus main body 2. The driving force of the motor M1 is input to the drive input gear 120 of the present embodiment via the developing unit 8. The drive transmission from the developing unit 8 to the toner cartridge 100 will be described later.

As a result of the driving force input to the drive input gear 120 from the developing unit 8 being transmitted to the agitation gear 123, the toner agitation member 108 is rotationally driven. In addition, as a result of the driving force input from the developing unit 8 to the drive input gear 120 being transmitted to the conveyance gear 122 via the idler gear 121, the toner conveyance member 109 is rotationally driven.

### Developing Unit

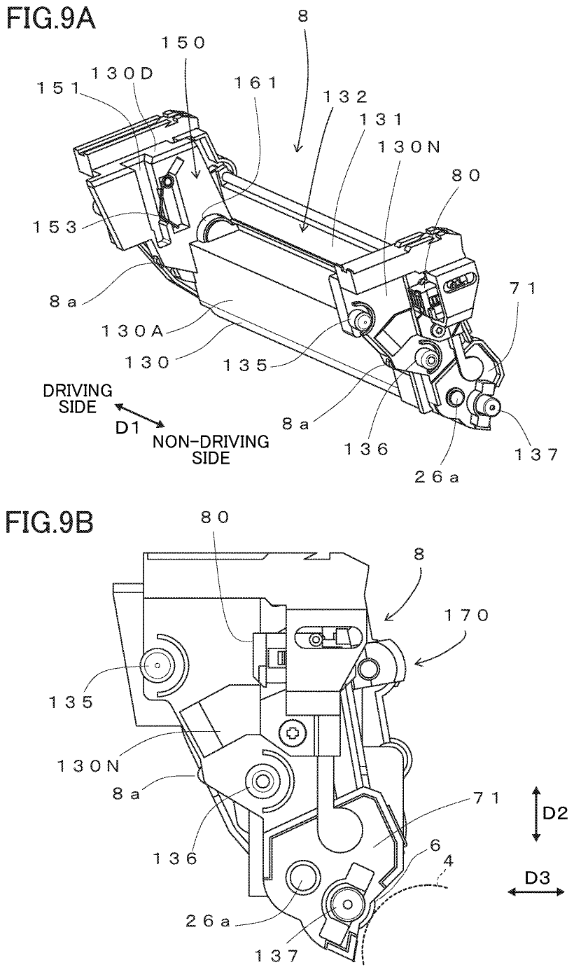

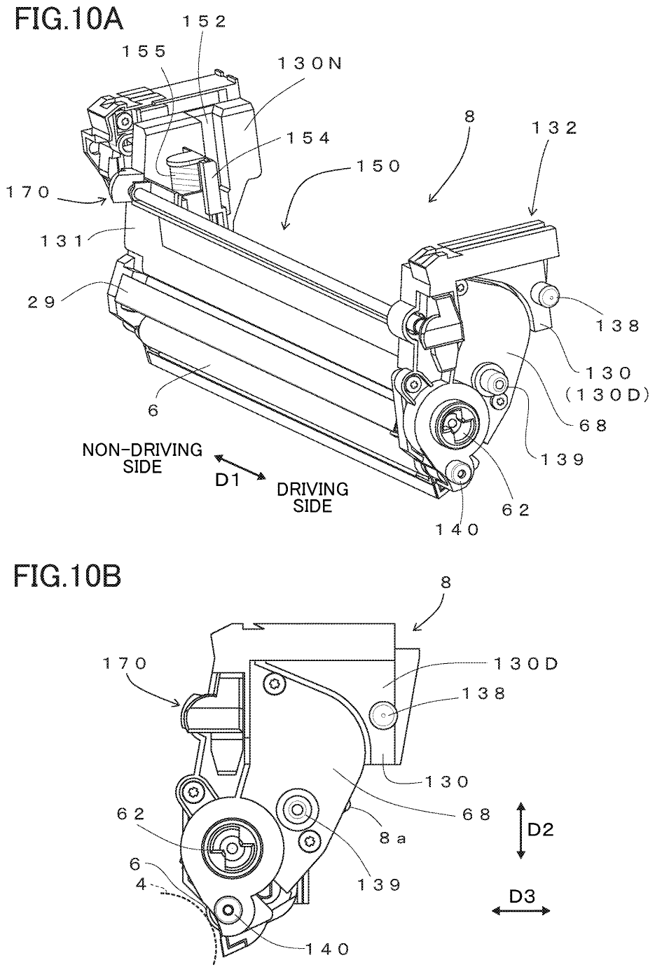

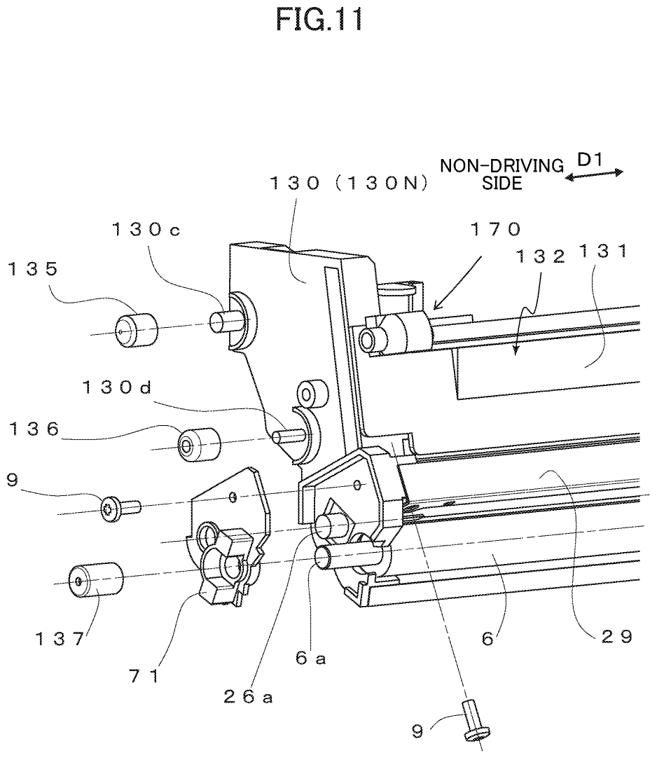

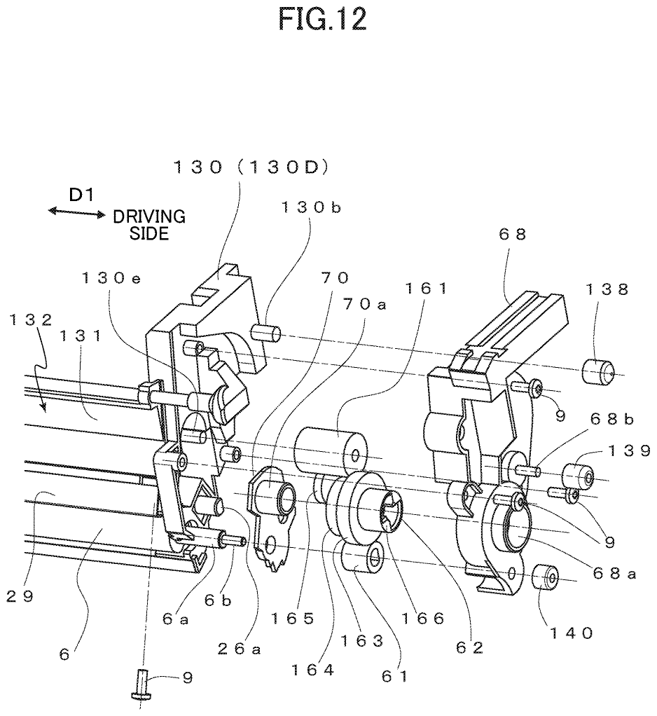

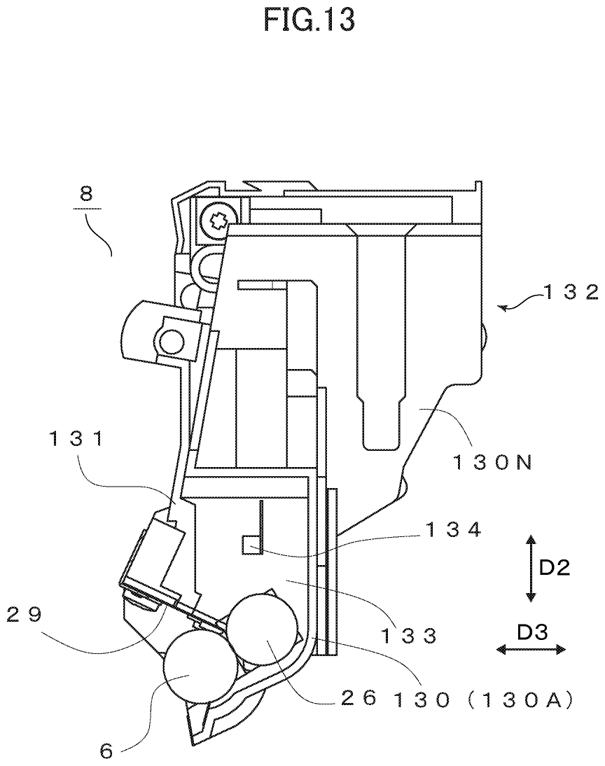

The developing unit 8 will be described with reference to FIGS. 9A to 17. FIG. 9A is a perspective view of the developing unit 8 as viewed from the non-driving side. FIG. 9B is a side view of the developing unit 8 as viewed from the non-driving side. FIG. 10A is a perspective view of the developing unit 8 as viewed from the driving side. FIG. 10B is a side view of the developing unit 8 as viewed from the driving side. FIG. 11 is an exploded perspective view of the non-driving-side end portion of the developing unit 8. FIG. 12 is an exploded perspective view of the driving-side end portion of the developing unit 8. FIG. 13 is a section view of the developing unit 8 taken along a plane orthogonal to the longitudinal direction.

As illustrated in FIGS. 9A, 10A, and 13, the developing unit 8 includes a main frame 130, a sub frame 131, a developing roller 6, a supply roller 26, a developing blade 29, a side cover 68, a developing input coupling 62, and a memory tag unit 80.

As illustrated in FIG. 13, the main frame 130, the sub frame 131, and the side cover 68 constitute a developing frame 132 serving as a frame of the developing unit 8. The developing frame 132 is a second frame movable with respect to a tray frame 30 (first frame) such that the developing roller 6 comes into contact with and separates from the photosensitive drum 4. In addition, the main frame 130 and the sub frame 131 define a developing chamber 133 serving as a storage space for storing toner. The main frame 130 and the sub frame 131 constitute a developing container defining the developing chamber 133.

The main frame 130 includes a developing chamber defining portion 130A extending in the longitudinal direction, a first side portion 130D coupled to a driving-side end of the developing chamber defining portion 130A, and a second side portion 130N coupled to a non-driving-side end of the developing chamber defining portion 130A. The first side portion 130D and the second side portion 130N extend in a direction intersecting with the longitudinal direction. The area of the first side portion 130D as viewed in the longitudinal direction is larger than the cross-sectional area of the developing chamber 133, and the area of the second side portion 130N as viewed in the longitudinal direction is larger than the cross-sectional area of the developing chamber 133. In addition, an attachment portion 150 to which the toner cartridge 100 is to be attached is formed between the first side portion 130D and the second side portion 130N in the longitudinal direction. The attachment portion 150 will be described later.

The developing roller 6 and the supply roller 26 are disposed in the developing chamber 133. The developing roller 6 and the supply roller 26 are each rotatable about a rotation axis extending in the longitudinal direction. The supply roller 26 supplies toner in the developing chamber 133 to the developing roller 6. The developing roller 6 rotates while bearing toner as described above, and supplies the toner to the corresponding photosensitive drum 4.

In addition, an agitation member 134 is disposed in the developing chamber 133. The agitation member 134 includes a rotation shaft extending in the longitudinal direction and a sheet member attached to the rotation shaft. The agitation member 134 receives a driving force transmitted to the rotation shaft to rotate, and thus agitates the toner in the developing chamber 133 by the sheet member.

The distal end of the developing blade 29 abuts the developing roller 6 (FIG. 13). The developing blade 29 regulates the amount (coating thickness) of toner borne on the developing roller 6, and thus forms a thin layer of toner on the developing roller 6. The developing blade 29 is fixed to the main frame 130 by using, for example, screws 9 (see FIGS. 11 and 12). As the developing blade 29, a plate-like member formed from a stainless steel (SUS) material or a rubber material, or a member formed by sticking a rubber plate on the distal end of a stainless steel plate may be used.

As illustrated in FIGS. 9A and 9B, a first roller 135, a second roller 136, a third roller 137, and a memory tag unit 80 are disposed at the non-driving-side end portion of the developing unit 8. As illustrated in FIGS. 10A and 10B, a fourth roller 138, a fifth roller 139, a sixth roller 140, and a developing input coupling 62 are disposed at the driving-side end portion of the developing unit 8. The details of the memory tag unit 80 will be described later.

The first roller 135, the second roller 136, the third roller 137, the fourth roller 138, the fifth roller 139, and the sixth roller 140 are each an example of a rotary member (rolling member). The first roller 135, the second roller 136, the third roller 137, the fourth roller 138, the fifth roller 139, and the sixth roller 140 are rotatable (pivotable) with respect to the developing frame 132.

The first roller 135, the second roller 136, and the third roller 137 each protrude toward the non-driving side with respect to a non-driving-side end surface of the developing frame 132. The fourth roller 138, the fifth roller 139, and the sixth roller 140 each protrude toward the driving side with respect to a driving-side end surface of the developing frame 132. In the present embodiment, the first roller 135, the second roller 136, the third roller 137, the fourth roller 138, the fifth roller 139, and the sixth roller 140 each rotate about an axis extending in the longitudinal direction.

In other words, the first to sixth rolling members (135 to 140) are each disposed to protrude in the drum axis direction D1 with respect to an end surface of the developing frame 132 (second frame) in the drum axis direction D1 (first direction). These rolling members are each an example of a rotary member that rotates in contact with the tray frame 30 (first frame) when the developing roller 6 comes into contact with or separates from the photosensitive drum 4.

In the case where one of the rolling members (135 to 137) on the non-driving side is referred to as a first rotary member, one of the rolling members (138 to 140) on the driving side can be referred to as a second rotary member.

The first roller 135, the second roller 136, the third roller 137, the fourth roller 138, the fifth roller 139, and the sixth roller 140 each function as a guide for coupling the developing unit 8 to the cartridge tray 3 or a guide for separating the developing roller 6 from the photosensitive drum 4. The details will be described later.

The developing input coupling 62 is a drive input portion through which the driving force of the motor M1 (FIG. 1) serving as a drive source provided in the apparatus main body 2 is input to the developing unit 8. The developing input coupling 62 engages with a developing driving coupling of the apparatus main body 2. In the present embodiment, the developing input coupling 62 provided on each of the developing units 8Y, 8M, 8C, and 8K engages with the corresponding one of the developing driving couplings 51Y, 51M, 51C, and 51K (see FIG. 2B).

Assembly of parts of the developing unit 8 will be described. First, assembly on the non-driving side will be described. As illustrated in FIG. 11, the developing roller 6 includes a metal shaft 6a serving as a roller shaft. The supply roller 26 includes a metal shaft 26a serving as a roller shaft. The non-driving-side end of the metal shaft 6a of the developing roller 6 and the non-driving-side end of the metal shaft 26a of the supply roller 26 are rotatably supported by a developing bearing 71 attached to the developing frame 132. The developing bearing 71 is a bearing portion on the non-driving side. The developing bearing 71 may be a shaft receiving hole formed in the developing frame 132.

The developing bearing 71 is fixed to the main frame 130 with, for example, screws 9 or an adhesive. In addition, the developing bearing 71 is formed from a conductive resin. The conductive resin is a resin material having conductivity or a resin material imparted with conductivity by dispersing conductive particles such as carbon in a base resin.

The third roller 137 is pivotably supported on the non-driving-side end of the metal shaft 6a of the developing roller 6. Detachment of the third roller 137 from the metal shaft 6a is suppressed by, for example, a snap-fit mechanism. The third roller 137 is formed from a conductive resin.

A first cylindrical boss 130c and a second cylindrical boss 130d are formed on the non-driving side of the main frame 130. The first cylindrical boss 130c and the second cylindrical boss 130d are each a protrusion portion protruding from an end surface of the main frame 130 on the non-driving side further to the non-driving side. The first cylindrical boss 130c and the second cylindrical boss 130d are each a shaft portion extending in the drum axis direction D1 (first direction).

The first roller 135 is fit on the first cylindrical boss 130c of the main frame 130, and is thus supported by the developing frame 132 in a state of being rotatable about the first cylindrical boss 130c. The second roller 136 is fit on the second cylindrical boss 130d of the main frame 130, and is thus supported by the developing frame 132 in a state of being rotatable about the second cylindrical boss 130d. Detachment of the first roller 135 and the second roller 136 respectively from the first cylindrical boss 130c and the second cylindrical boss 130d is suppressed by, for example, a snap-fit mechanism.

Next, assembly of parts on the driving side will be described. As illustrated in FIG. 12, part of the metal shaft 6a of the developing roller 6 near the driving-side end portion and the driving-side end of the metal shaft 26a of the supply roller 26 are rotatably supported by a developing bearing 70 attached to the developing frame 132. The developing bearing 70 is a bearing portion on the driving side. The developing bearing 70 may be a shaft receiving hole formed in the developing frame 132.

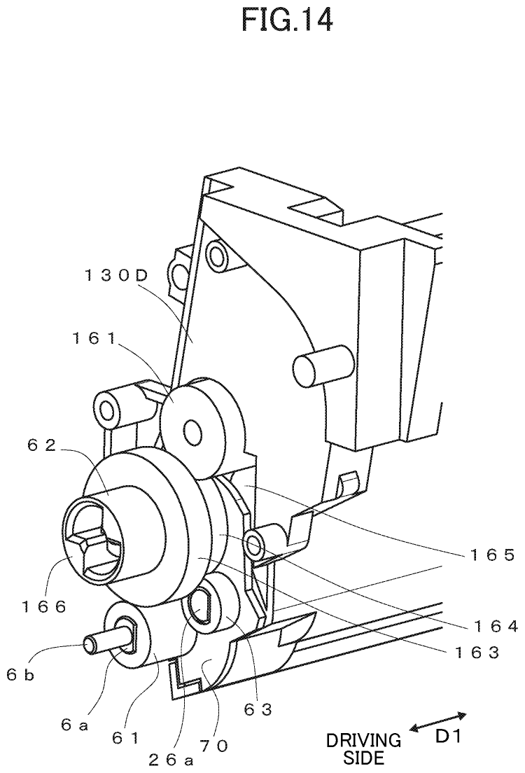

The developing roller gear 61 and the supply roller gear 63 are disposed further on the outside (driving side) of the developing bearing 70 in the longitudinal direction (see FIG. 14 for the supply roller gear 63). The developing roller gear 61 is attached to the metal shaft 6a of the developing roller 6. The supply roller gear 63 is attached to the metal shaft 26a of the supply roller 26 (FIG. 14). The developing roller gear 61 and the supply roller gear 63 are disposed between the developing bearing 70 and the side cover 68 in the longitudinal direction.

The sixth roller 140 is rotatably supported at a distal end portion 6b of the metal shaft 6a of the developing roller 6 on the driving side. Detachment of the sixth roller 140 is suppressed by, for example, a snap-fit.

A third cylindrical boss 130b is formed on the driving side of the main frame 130. A cylindrical boss 68b is formed on the side cover 68. The third cylindrical boss 130b is a protrusion portion protruding further toward the driving side from an end surface of the main frame 130 on the driving side. The cylindrical boss 68b is a protrusion portion protruding further toward the driving side from an end surface of the side cover 68 on the driving side.

The fourth roller 138 is fit on the third cylindrical boss 130b of the main frame 130, and is thus supported by the developing frame 132 in a state of being rotatable about the third cylindrical boss 130b. The fifth roller 139 is fit on a cylindrical boss 68b of the side cover 68, and is thus supported by the developing frame 132 in a state of being rotatable about the cylindrical boss 68b. Detachment of the fourth roller 138 and the fifth roller 139 respectively from the third cylindrical boss 130b and the cylindrical boss 68b is suppressed by, for example, a snap-fit.

### Driving of Developing Unit

The driving configuration of the developing unit 8 will be described with reference to FIG. 14. FIG. 14 is a perspective view of the driving-side end portion of the developing unit 8 in a state in which the side cover 68 is detached.

The developing input coupling 62, the developing roller gear 61, and the supply roller gear 63 described above are disposed at the driving-side end portion of the developing unit 8. In addition, a cartridge driving gear 161 and an agitation gear 165 are disposed at the driving-side end portion of the developing unit 8.

The developing input coupling 62 includes a coupling portion 166, a first gear portion 163, and a second gear portion 164. The coupling portion 166, the first gear portion 163, and the second gear portion 164 integrally rotate about an axis extending in the longitudinal direction. The coupling portion 166 engages with one of the developing driving couplings 51Y, 51M, 51C, and 51K of the apparatus main body 2 (FIG. 2A). The driving force is transmitted from the motor M1 (FIG. 1) of the apparatus main body 2 to the driving unit 8 via the engagement between the coupling portion 166 and the developing driving coupling.

The first gear portion 163 of the developing input coupling 62 is engaged with the developing roller gear 61. The second gear portion 164 of the developing input coupling 62 is engaged with the supply roller gear 63. When the developing input coupling 62 rotates, a driving force is transmitted from the first gear portion 163 to the developing roller gear 61 to rotate the developing roller 6, and a driving force is transmitted from the second gear portion 164 to the supply roller gear 63 to rotate the supply roller 26.

The second gear portion 164 of the developing input coupling 62 is also engaged with the cartridge driving gear 161. The cartridge driving gear 161 is engaged with the agitation gear 165.

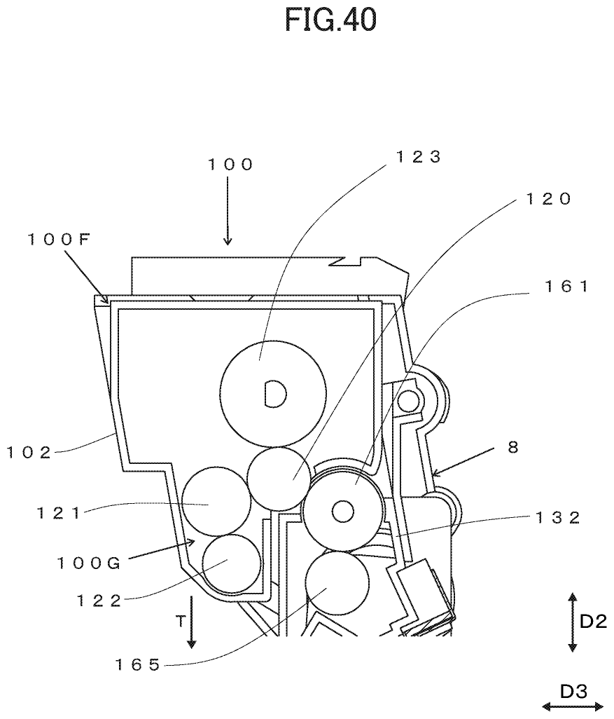

Part of the cartridge driving gear 161 extends to a position more on the inside than the first side portion 130D of the main frame 130 in the longitudinal direction, and is exposed to the attachment portion 150 of the toner cartridge 100 (FIG. 9A, also see FIG. 40). When the developing input coupling 62 rotates, a driving force is transmitted from the second gear portion 164 to the cartridge driving gear 161, and thus the cartridge driving gear 161 rotates. As a result of this, the driving force is transmitted from the developing unit 8 to the toner cartridge 100. The details of the drive transmission from the developing unit 8 to the toner cartridge 100 will be described later.

In addition, the agitation gear 165 is attached to a driving-side end of the rotation shaft of the agitation member 134 (FIG. 13). When the developing input coupling 62 rotates, a driving force is transmitted from the second gear portion 164 to the agitation gear 165 via the cartridge driving gear 161, and thus the agitation member 134 rotates.

Assembly of the developing input coupling 62 and the cartridge driving gear 161 will be described. As illustrated in FIG. 12, a support boss 70a is provided on the developing bearing 70. A support hole 68a is formed in the side cover 68. A hole portion that fits with the support boss 70a is formed in an inner portion of the developing input coupling 62 in the longitudinal direction. The outer surface of an outer portion of the developing input coupling 62 in the longitudinal direction (outer peripheral surface of the coupling portion 166) opposes the support hole 68a. The developing input coupling 62 is rotatably supported by the support boss 70a and the support hole 68a, and rotates about an axis extending in the longitudinal direction.

A fourth cylindrical boss 130e is formed on the main frame 130. The cartridge driving gear 161 is rotatably supported by the fourth cylindrical boss 130e.

The side cover 68 is fixed to the main frame 130 by using, for example, the screw 9 such that the developing bearing 70, the developing input coupling 62, and the gears are interposed therebetween. The gears mentioned herein include the developing roller gear 61, the supply roller gear 63, and the cartridge driving gear 161.

To be noted, the drive transmission path from the drive source of the apparatus main body 2 to a driving target in the developing unit 8 is not limited to the drive transmission path described above. For example, drive may be transmitted from the developing input coupling 62 to the supply roller gear 63 via the developing roller gear 61. In addition, drive may be transmitted from the developing input coupling 62 to the cartridge driving gear 161 via another gear. In addition, for example, the cartridge driving gear 161 may be coaxially provided with the developing input coupling 62 so as to integrally rotate with the coupling portion 166.

### Toner Receiving Portion of Developing Unit

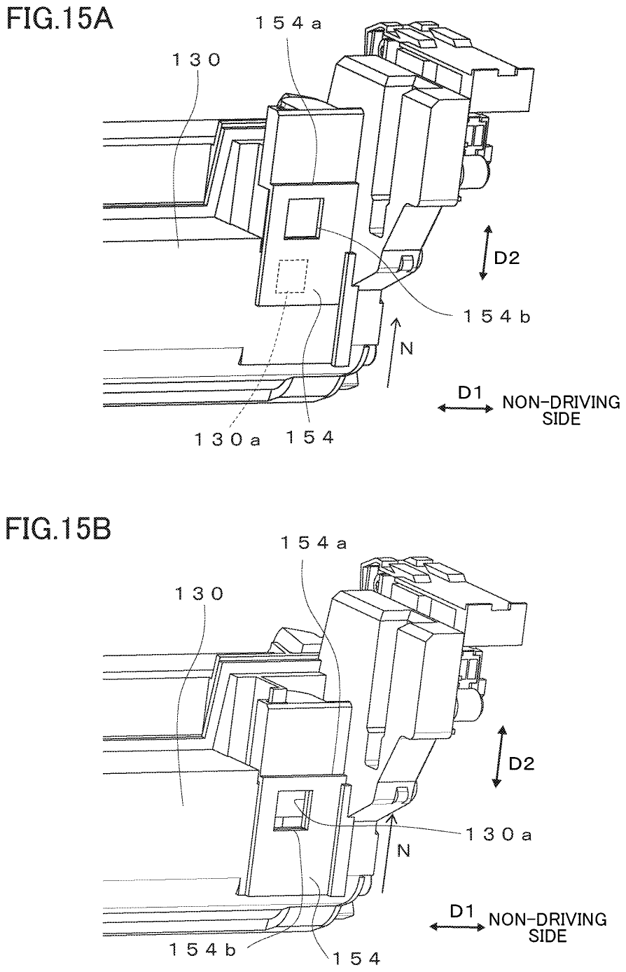

A toner receiving portion by which the developing unit 8 receives toner discharged from the toner cartridge 100 will be described with reference to FIGS. 15A and 15B. FIGS. 15A and 15B are each a perspective view of the toner receiving portion.

As illustrated in FIGS. 15A and 15B, the developing unit 8 is provided with a toner inlet port 130a, an inlet port shutter 154, and a shutter spring 155 (FIG. 10A). In addition, the inlet port shutter 154 is provided with an opening portion 154b. In the present embodiment, the toner inlet port 130a is disposed on the inside of the second side portion 130N in the longitudinal direction.

The toner inlet port 130a is a hole (opening) provided in the main frame 130. The toner inlet port 130a penetrates to the outside of the developing frame 132 from the developing chamber 133 on the inside of the developing frame 132. Toner is supplied from the outside of the developing unit 8 to the developing chamber 133 through the toner inlet port 130a. The toner inlet port 130a of the present embodiment is positioned at an end portion of the developing chamber 133 on the non-driving side.

The inlet port shutter 154 is movable between a closed position (FIG. 15A) to close the toner inlet port 130a and an open position (FIG. 15B) to open the toner inlet port 130a. The inlet port shutter 154 of the present embodiment is movable (slidable) in a direction intersecting with the longitudinal direction with respect to the main frame 130. In addition, the inlet port shutter 154 is urged in a direction from the open position toward the closed position (arrow N direction in the drawings) by the shutter spring 155 (FIG. 10A).

The inlet port shutter 154 can move from the closed position to the open position as illustrated in FIG. 15B by receiving a force in a direction opposite to the arrow N direction in the drawings. In the case where the inlet port shutter 154 is at the open position, the toner inlet port 130a overlaps with an opening portion 154b of the inlet port shutter 154 at least partially as viewed in a direction intersecting with the longitudinal direction. As a result of this, the developing unit 8 takes an open state in which toner can be supplied from the outside to the developing chamber 133.

### Memory Tag Unit

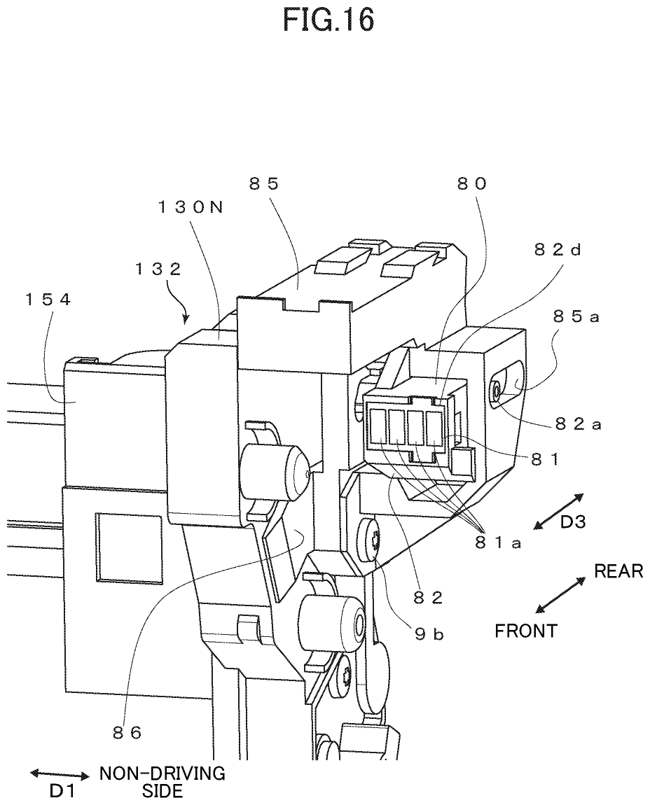

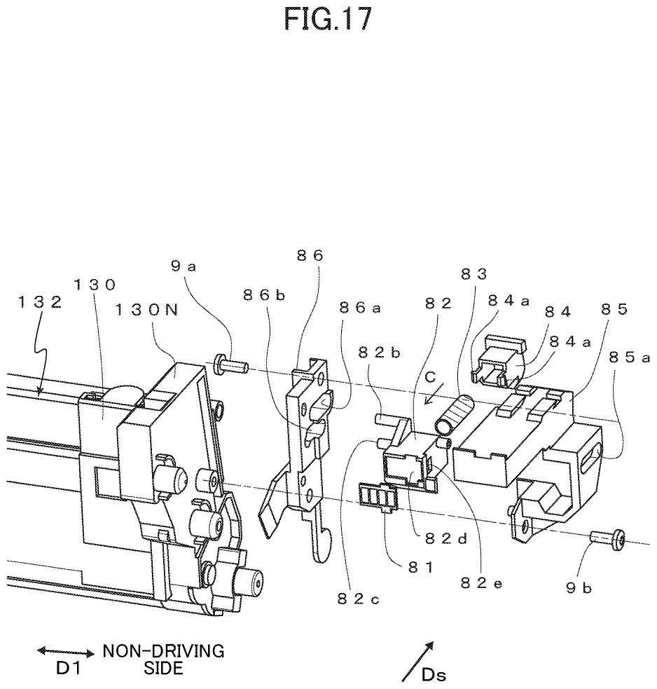

The memory tag unit 80 of the developing unit 8 will be described below. FIG. 16 is a perspective view of part (near the memory tag unit 80) of the developing unit 8. FIG. 17 is an exploded perspective view of the memory tag unit 80.

As illustrated in FIGS. 16 and 17, the memory tag unit 80 includes a memory tag 81, a tag support member 82, a tag pressing spring 83, and a spring receiving member 84.

The memory tag 81 is, for example, an integrated circuit (IC) chip of a contact type. The memory tag 81 includes an electric contact portion 81a exposed to the outside of the developing unit 8. The electric contact portion 81a includes, for example, a plurality of metal plates aligned in the longitudinal direction as a plurality of contacts. The memory tag 81 is electrically connected to the controller of the image forming apparatus 1 provided in the apparatus main body 2 via the electric contact portion 81a, and thus information therein is loaded by the controller. The information stored in the memory tag 81 is not particularly limited, and examples thereof include identification information such as a production number of the developing unit 8, a type of the developing unit 8 (toner color), and the amount of toner therein.

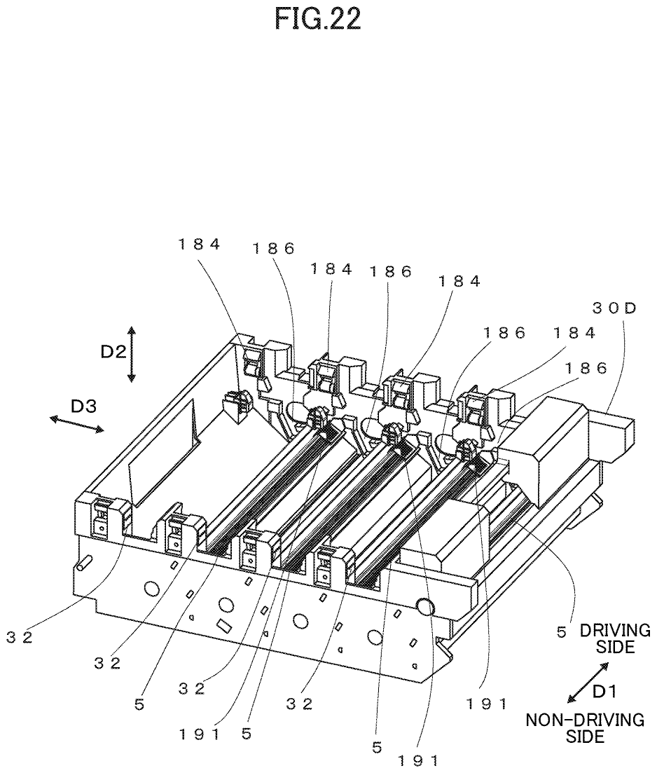

The electric contact portion 81a of the memory tag 81 of the present embodiment comes into contact with a tray-side contact portion 32 (see FIG. 22) serving as an electric contact portion provided on the cartridge tray 3. The tray-side contact portion 32 includes a plurality of contacts 32a aligned in the drum axis direction D1. The tray-side contact portion 32 is electrically connected to a second tray-side contact portion provided on the cartridge tray 3. The second tray-side contact portion comes into contact with a body-side contact portion provided in the apparatus main body 2 in the case where the cartridge tray 3 is at the inner position. The body-side contact portion is connected to the controller via the wiring of the apparatus main body 2. The memory tag 81 of the present embodiment is electrically connected to the controller via the electric contact portion 81a, the tray-side contact portion 32, the second tray-side contact portion, and the body-side contact portion. To be noted, the electric contact portion 81a of the memory tag 81 may be configured to directly come into contact with the body-side contact portion provided at a position opposing the electric contact portion 81a.

The tag support member 82 supports the memory tag 81. The memory tag 81 is fixed to the tag support member 82. As illustrated in FIG. 17, the memory tag 81 of the present embodiment is fixed to a fixing portion 82d of the tag support member 82 by a means such as an adhesive.

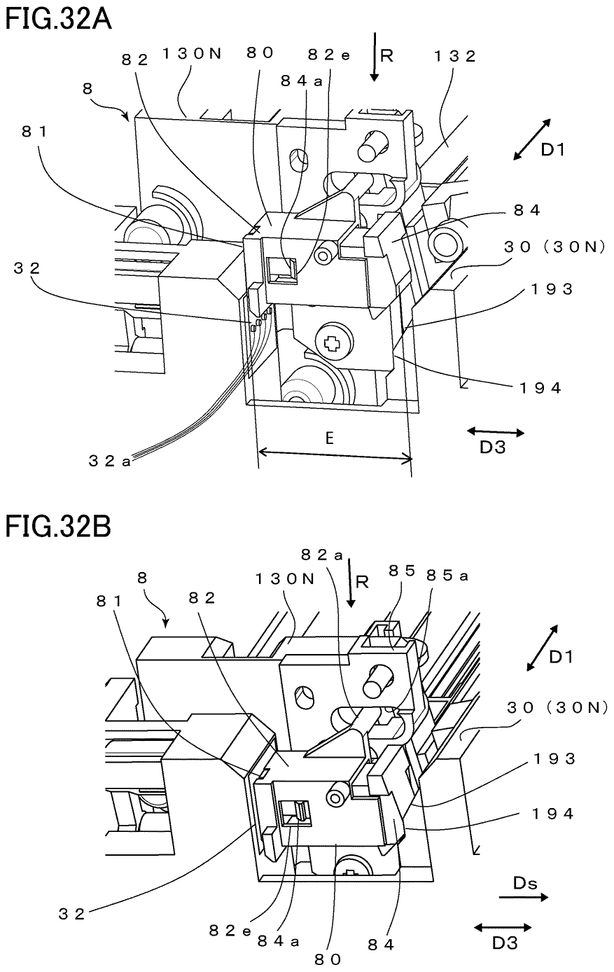

The spring receiving member 84 is attached to the tag support member 82 on the side opposite to the side on which the electric contact portion 81a of the memory tag 81 is exposed. The tag pressing spring 83 is sandwiched between the tag support member 82 and the spring receiving member 84. That is, the spring receiving member 84 is coupled to the tag support member 82 such that the spring receiving member 84 is pushed in the arrow C direction in FIG. 17 while compressing the tag pressing spring 83. The tag support member 82 and the spring receiving member 84 are engaged with, for example, a snap-fit portion. The snap-fit portion includes an opening 82e provided in one of the tag support member 82 and the spring receiving member 84, and a claw 84a that is elastically deformable, that is provided in the other of the tag support member 82 and the spring receiving member 84, and that engages with the opening 82e (also see FIGS. 32A and 32B).

The tag support member 82 is urged in the arrow C direction (that is, direction in which the electric contact portion 81a faces) by the urging force of the tag pressing spring 83. In addition, in the engagement portion (snap-fit portion) between the tag support member 82 and the spring receiving member 84, a clearance for allowing the tag support member 82 to move with respect to the spring receiving member 84 in the arrow C direction is set. Therefore, in the case where the memory tag 81 receives a force in a direction opposite to the arrow C direction, the memory tag 81 and the tag support member 82 are allowed to move closer to the spring receiving member 84 by the amount of the clearance.

Coupling of the memory tag unit 80 to the developing unit 8 will be described. As illustrated in FIG. 17, the developing unit 8 includes a holder 85 and a holder base 86 as a support portion of the memory tag unit 80. The memory tag unit 80 of the present embodiment is configured to be movable with respect to the developing frame 132 by being movably supported by a support portion fixed to the developing frame 132. The holder 85 and the holder base 86 constituting the support portion of the present embodiment are supported by the second side portion 130N of the main frame 130.

The holder 85 is provided with a first posture regulation hole 85a. The holder base 86 is provided with a second posture regulation hole 86a and a third posture regulation hole 86b. The tag support member 82 is provided with a first posture regulation boss 82a, a second posture regulation boss 82b, and a third posture regulation boss 82c.

As illustrated in FIGS. 16 and 17, the first posture regulation boss 82a of the tag support member 82 is inserted in the first posture regulation hole 85a of the holder 85. The second posture regulation boss 82b and the third posture regulation boss 82c of the tag support member 82 are respectively inserted in the second posture regulation hole 86a and the third posture regulation hole 86b of the holder base 86. Further, the holder 85 and the holder base 86 are engaged with each other by using, for example, a screw 9a such that the memory tag unit 80 is sandwiched between the holder 85 and the holder base 86. The holder 85 and the holder base 86 are fixed together to the main frame 130 by using, for example, a screw 9b.

As illustrated in FIGS. 16 and 17, a clearance is provided between each of the posture regulation bosses (82a, 82b, and 82c) and the corresponding one of the posture regulation holes (85a, 86a, and 86b). As a result of this configuration, the memory tag unit 80 is movable with respect to the developing frame 132 by the amount of the clearance. That is, a clearance is provided between a protrusion portion (boss) provided in one of the support portion (85 or 86) provided in the developing frame 132 and the memory tag unit 80 and a recess portion (hole) provided in the other of the support portion (85 or 86) and the memory tag unit 80. According to this configuration, the contact between the electric contact portion 81a of the memory tag 81 and the tray-side contact portion 32 can be maintained even in the case where the developing unit 8 moves.

### Separation Member

The developing unit 8 includes a separation member 170. The separation member 170 is a movable member that is movable in the drum axis direction D1 (first direction) between a first position and a second position with respect to the developing frame 132 (second frame), and that moves in an intersecting direction intersecting with the drum axis direction D1 together with the developing frame 132 (second frame).

The separation member 170 can move the developing unit 8 between an abutting position where the developing roller 6 abuts the photosensitive drum 4 and a separated position where the developing roller 6 is separated from the photosensitive drum 4. In addition, the separation member 170 can switch the developing unit 8 between an abutting state in which the developing roller 6 abuts the photosensitive drum 4, and a separated state in which the developing roller 6 is separated from the photosensitive drum 4. The movement of the developing unit 8 by the separation member 170 will be described later, and the configuration of the separation member 170 will be described first.

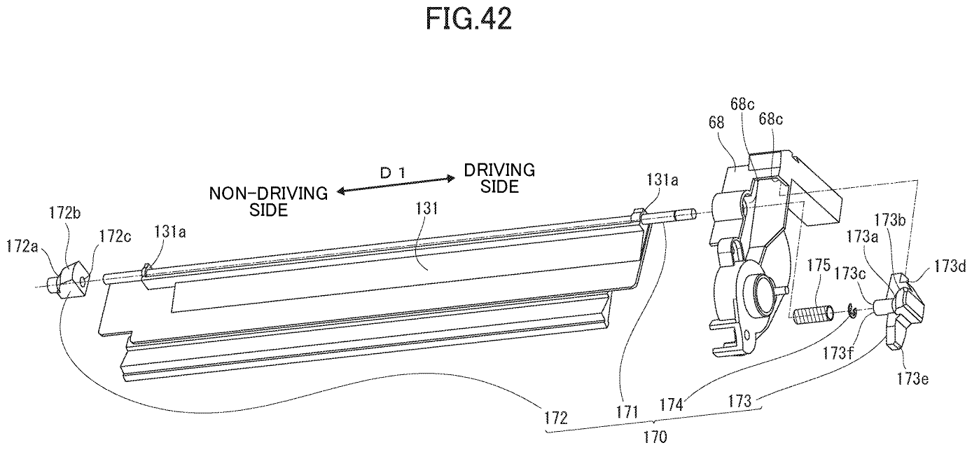

FIG. 42 is an exploded perspective view of the separation member 170. As illustrated in FIG. 42, the separation member 170 includes a shaft 171, a first cam 172, a second cam 173, and a stopper ring 174. In addition, the developing unit 8 includes an urging spring 175 that urges the separation member 170.

The shaft 171 is a shaft member extending in the drum axis direction D1 (longitudinal direction). The shaft 171 of the present embodiment is longer than the total length of the developing chamber 133 in the drum axis direction D1. The shaft 171 is supported by the sub frame 131 in a state in which the shaft 171 is movable (slidable) in the drum axis direction D1 with respect to the developing frame 132. Therefore, the separation member 170 is movable in the drum axis direction D1 with respect to the developing frame 132.

The shaft 171 is a cylindrical member extending in a direction substantially parallel to the drum axis direction D1, and is formed from, for example, metal such as steel. To be noted, the shaft 171 may be formed in, for example, a prismatic shape. In addition, the material of the shaft 171 may be resin. In addition, a plate-like member extending in the drum axis direction D1 may be used instead of the shaft 171.

A shaft support hole 131a having an inner diameter slightly larger than the outer diameter of the shaft 171 is provided at each end of the sub frame 131 in the drum axis direction D1. In a state in which each end of the shaft 171 is inserted in the shaft support hole 131a, the shaft 171 is supported by the sub frame 131 to be movable in the drum axis direction D1.

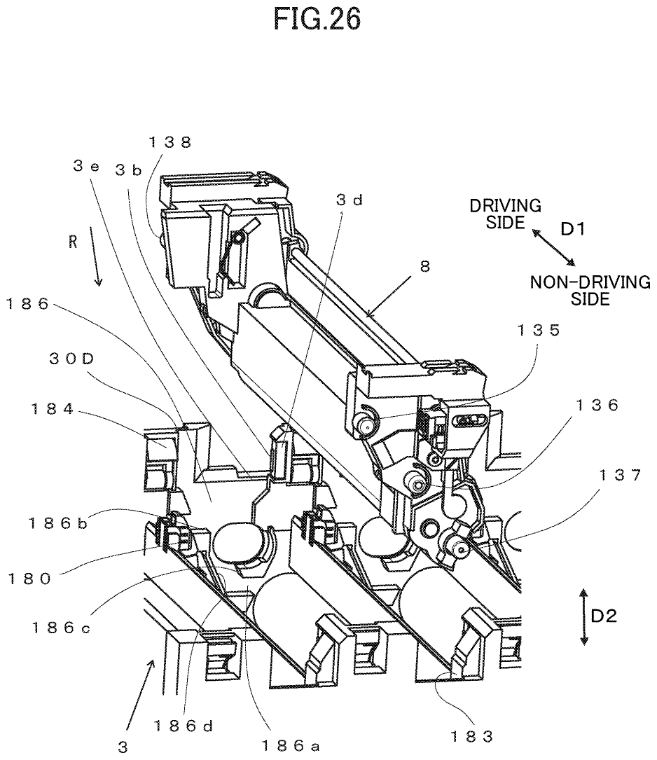

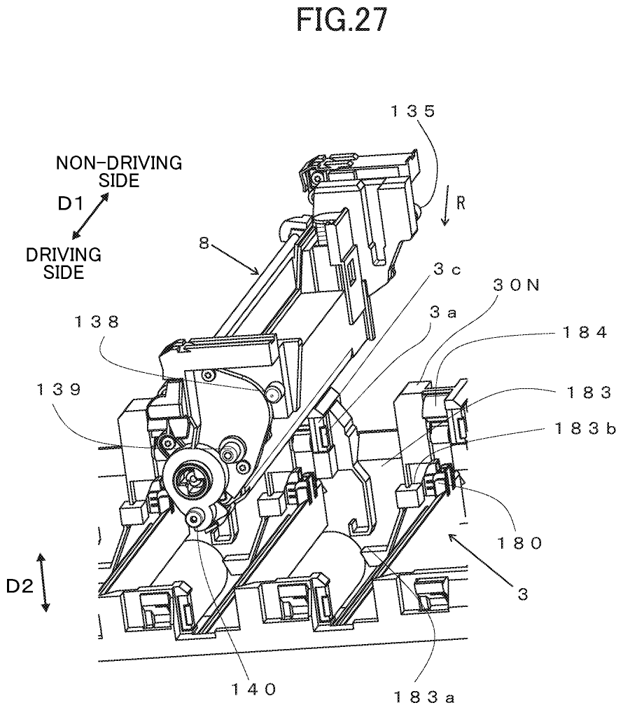

The first cam 172 is attached to an end portion of the shaft 171 on the non-driving side (first end side). The second cam 173 is attached to an end portion of the shaft 171 on the driving side (second end side). The first cam 172 is an abutting portion (first abutting portion) that abuts a first guide roller 3a (FIG. 27) serving as an abutted portion (first abutted portion) provided in the cartridge tray 3 that will be described later. The second cam 173 is an abutting portion (second abutting portion) that abuts a second guide roller 3b (FIG. 26) serving as an abutted portion (second abutted portion) provided in the cartridge tray 3 that will be described later.

The stopper ring 174 is attached to the driving side of the shaft 171. The separation urging spring 175 is a coil spring, the shaft 171 is inserted in the coil, and the separation urging spring 175 is attached in a compressed state between the stopper ring 174 and the side cover 68. The separation member 170 receives an urging force of the separation urging spring 175 by the stopper ring 174 serving as a force receiving portion, and is thus urged toward the driving side in the drum axis direction D1.

The first cam 172 is formed from rubber, resin, or the like. The first cam 172 has a coupling hole 172c, a first inclined surface 172a, and a third inclined surface 172b.

The first cam 172 is fixed to the non-driving-side end portion of the shaft 171 in a state in which the shaft 171 is inserted in the coupling hole 172c. The first cam 172 may be fixed by an arbitrary method such as coupling using a snap-fit or the stopper ring, gluing, or press-fitting.

The first inclined surface 172a and the third inclined surface 172b are inclined in a direction obliquely intersecting with drum axis direction D1 as viewed in a direction orthogonal to the drum axis direction D1. The first inclined surface 172a and the third inclined surface 172b of the present embodiment are each a conical surface coaxial with the center axis of the shaft 171. The first inclined surface 172a is provided at a position further on the non-driving side than the third inclined surface 172b. The driving-side end of the first inclined surface 172a may be continuous with the non-driving-side end of the third inclined surface 172b.

The first inclined surface 172a and the third inclined surface 172b are each inclined such that the distance thereof from the outer surface of the shaft 171 is larger on the driving side than on the non-driving side in the drum axis direction D1. That is, the first inclined surface 172a is formed such that the distance thereof from the outer surface of the shaft 171 in a direction orthogonal to the drum axis direction D1 is larger on the driving side (second end side) than on the non-driving side (first end side) in the drum axis direction D1 (first direction). In addition, the inclination angle of the first inclined surface 172a is larger than the inclination angle of the third inclined surface 172b. That is, as viewed in a direction orthogonal to the drum axis direction D1, an angle formed between a virtual straight line along the first inclined surface 172a and a virtual straight line extending in the drum axis direction D1 is larger than an angle formed between a virtual straight line along the third inclined surface 172b and a virtual straight line extending in the drum axis direction D1. In the present embodiment, the angle of the first inclined surface 172a with respect to the drum axis direction D1 is, for example, 45°.

The second cam 173 is formed from rubber, resin, or the like. The second cam 173 has a coupling hole 173c, a second inclined surface 173a, a fourth inclined surface 173b, a position regulation portion 173d, a guided portion 173e, and a force receiving portion 173f.

The second cam 173 is fixed to the driving-side end portion of the shaft 171 in a state in which the shaft 171 is inserted in the coupling hole 173c. The force receiving portion 173f comes into contact with the stopper ring 174, and receives the urging force of the separation urging spring 175 via the stopper ring 174.

The position regulation portion 173d is a surface facing the driving side in the drum axis direction D1, and opposes a positioning portion 68c provided on the side cover 68. As a result of the position regulation portion 173d abutting the positioning portion 68c by the urging force of the separation urging spring 175, the position of the separation member 170 in the drum axis direction D1 is regulated.

The second inclined surface 173a and the fourth inclined surface 173b are inclined in a direction obliquely intersecting with drum axis direction D1 as viewed in a direction orthogonal to the drum axis direction D1. The second inclined surface 173a and the fourth inclined surface 173b of the present embodiment are each a conical surface coaxial with the center axis of the shaft 171. The second inclined surface 173a is provided at a position further on the non-driving side than the fourth inclined surface 173b. The driving-side end of the second inclined surface 173a may be continuous with the non-driving-side end of the fourth inclined surface 173b.

The second inclined surface 173a and the fourth inclined surface 173b are each inclined such that the distance thereof from the outer surface of the shaft 171 is larger on the driving side than on the non-driving side in the drum axis direction D1. That is, the second inclined surface 173a is formed such that the distance thereof from the outer surface of the shaft 171 in a direction orthogonal to the drum axis direction D1 is larger on the driving side (second end side) than on the non-driving side (first end side) in the drum axis direction D1 (first direction). In addition, the inclination angle of the second inclined surface 173a is larger than the inclination angle of the fourth inclined surface 173b. That is, as viewed in a direction orthogonal to the drum axis direction D1, an angle formed between a virtual straight line along the second inclined surface 173a and a virtual straight line extending in the drum axis direction D1 is larger than an angle formed between a virtual straight line along the fourth inclined surface 173b and a virtual straight line extending in the drum axis direction D1. In the present embodiment, the angle of the second inclined surface 173a with respect to the drum axis direction D1 is, for example, 45°.

To be noted, the shape of the abutting surface (cam surface) by which the first cam 172 and the second cam 173 each abut the guide portion of the cartridge tray 3 is not limited to the example described in the present embodiment. For example, the first inclined surface 172a, the third inclined surface 172b, the second inclined surface 173a, and the fourth inclined surface 173b may be each in a polygonal pyramid shape instead of a conical shape. In addition, the first cam 172 or the second cam 173 may have a recess or a protrusion such as a step in the middle of the cam surface thereof, or may have a curved cam surface whose inclination angle with respect to the drum axis direction D1 changes continuously. The shape of the cam surface of the first cam 172 or the second cam 173 may be appropriately selected such that the separation operation of the developing unit 8 is performed smoothly.

As described above, the first cam 172, the second cam 173, and the shaft 171 are integrally movable in the drum axis direction D1. In addition, the first cam 172, the second cam 173, and the shaft 171 are urged toward the driving side in the drum axis direction D1 by the separation urging spring 175.

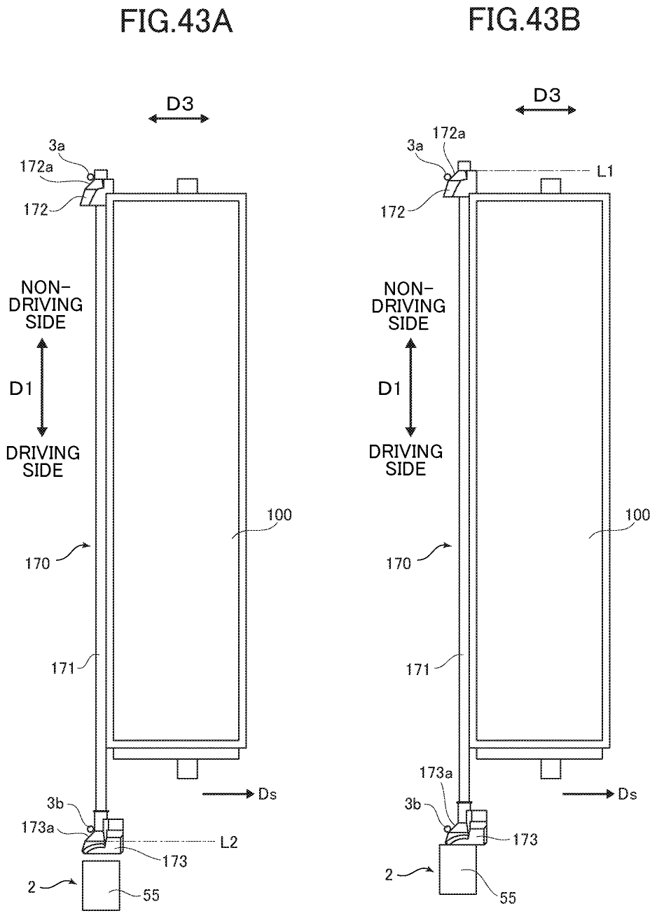

FIGS. 43A and 43B are each a schematic view of the separation member 170 and the toner cartridge 100 in the cartridge attachment/detachment direction D2. FIG. 43A illustrates an abutting state in which the developing roller 6 abuts the photosensitive drum 4. FIG. 43B illustrates a separated state in which the developing roller 6 is separated from the photosensitive drum 4.

As illustrated in FIG. 43A, the toner cartridge 100 is positioned more on the inside (non-driving side) in the longitudinal direction than a straight line L2 indicating the driving-side end portion of the second inclined surface 173a in the abutting state in the drum axis direction D1. In addition, as illustrated in FIG. 43B, the toner cartridge 100 is positioned more on the inside in the longitudinal direction than a straight line L1 indicating the non-driving-side end portion of the first inclined surface 172a in the separated state in the drum axis direction D1. That is, in the drum axis direction D1, the toner cartridge 100 is positioned between the straight line L2 indicating the driving-side end portion of the second inclined surface 173a in the abutting state and the straight line L1 indicating the non-driving-side end portion of the first inclined surface 172a in the separated state.

In addition, as illustrated in FIGS. 43A and 43B, the separation member 170 and the toner cartridge 100 are arranged to be aligned with each other in the tray movement direction D3. The separation member 170 overlaps with the toner cartridge 100 as viewed in the tray movement direction D3.

To be noted, two elements “overlapping with each other” as viewed in a specific direction means that in the case where each element is orthogonally projected onto a virtual plane orthogonal to the direction, the projected area of one element overlaps with the projected area of the other element at least partially.

### Cartridge Tray

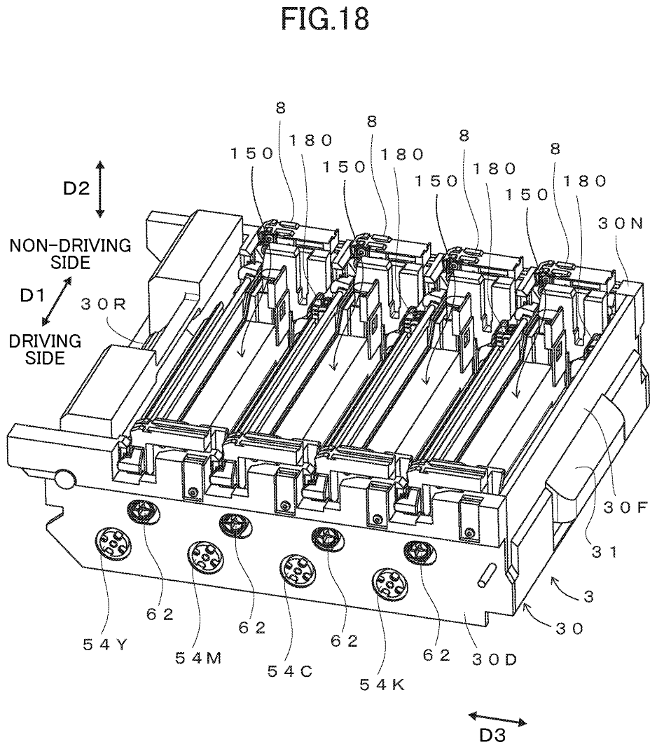

The configuration of the cartridge tray 3 will be described with reference to FIGS. 18 to 32. The cartridge tray 3 is an example of a pull-out unit or a pull-out member attached to the apparatus main body 2 of the image forming apparatus 1 in a manner that the cartridge tray 3 can be pulled out. In addition, the cartridge tray 3 is an example of a process unit including at least one photosensitive drum 4 and at least one developing roller 6. In addition, the cartridge tray 3 is an example of a drum unit including at least one photosensitive drum 4.

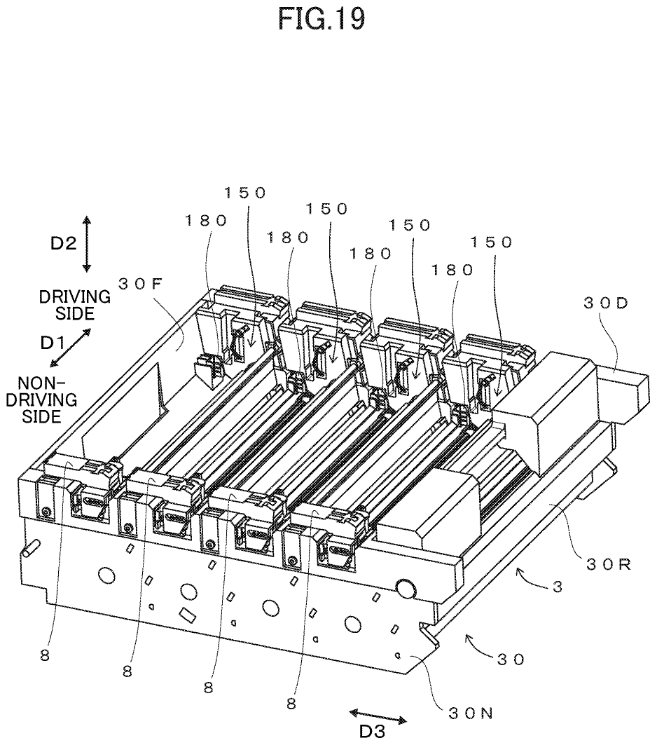

FIGS. 18 and 19 are each a perspective view of the cartridge tray 3 according to the present embodiment. The cartridge tray 3 includes the tray frame 30, the developing units 8, pressurizing units 180, and attachment portions 150. The cartridge tray 3 of the present embodiment includes four developing units 8, eight pressurizing units 180, and four attachment portions 150. Each developing unit 8 is provided with two pressurizing units 180 and one attachment portion 150.

The tray frame 30 is a frame of the cartridge tray 3. The tray frame 30 is an example of a frame (first frame) that supports the photosensitive drum 4. Each developing unit 8 is coupled to the tray frame 30. The frame of the developing unit 8 (developing frame 132 that will be described later) is an example of a second frame movable with respect to the first frame. Each attachment portion 150 is provided in corresponding one of the developing units 8. The attachment portion 150 is also a portion to which the toner cartridge 100 is attached in the cartridge tray 3 (also see FIGS. 9A and 10A).

To be noted, “coupling” in the present disclosure means to attach part of an apparatus to another part to manufacture part of the apparatus or the whole apparatus. That is, “coupling” is a form of “attaching”. Therefore, in the case where the developing unit 8 is a developing cartridge that can be replaced by the user, the “coupling” in the description below can be read as “attaching” in the replacement of the developing unit 8.

The tray frame 30 includes a driving-side frame 30D, a non-driving-side frame 30N, a front frame 30F, and a rear frame 30R. The driving-side frame 30D is provided at the driving-side end of the tray frame 30, and extends in the tray movement direction D3. The non-driving-side frame 30N is provided at the non-driving-side end of the tray frame 30, and extends in the tray movement direction D3. Each photosensitive drum 4, each developing unit 8, and each toner cartridge 100 are positioned between the driving-side frame 30D and the non-driving-side frame 30N in the drum axis direction D1.

The front frame 30F is provided at a front end of the tray frame 30, and extends in the drum axis direction D1. The rear frame 30R is provided at a rear end of the tray frame 30, and extends in the drum axis direction D1. The front end of the driving-side frame 30D and the front end of the non-driving-side frame 30N are interconnected by the front frame 30F, and the rear end of the driving-side frame 30D and the rear end of the non-driving-side frame 30N are interconnected by the rear frame 30R. Each photosensitive drum 4, each developing unit 8, and each toner cartridge 100 are positioned between the front frame 30F and the rear frame 30R in the tray movement direction D3.

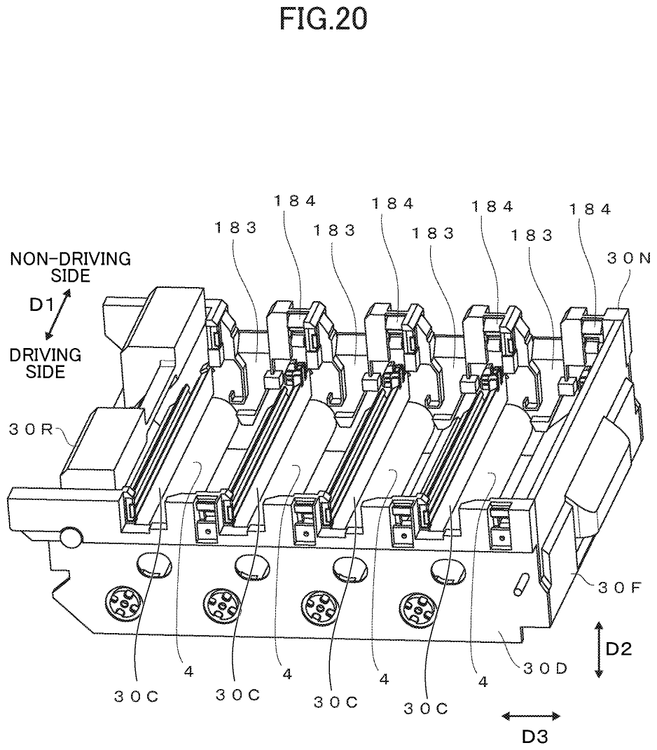

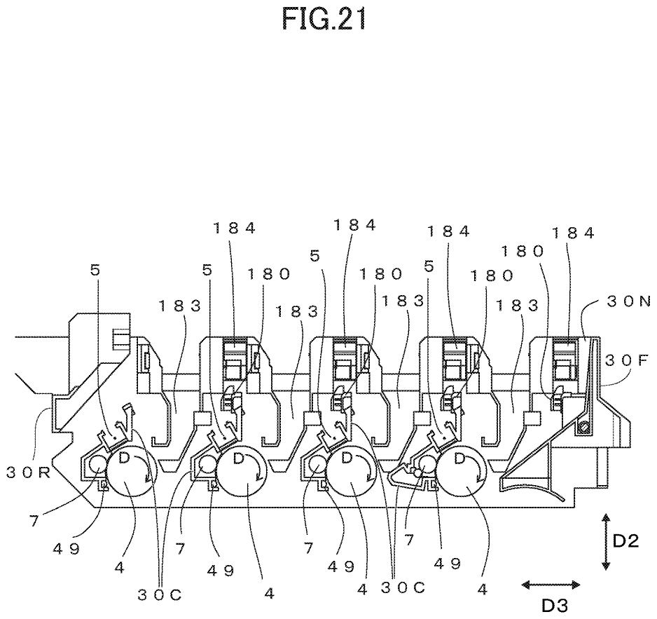

In addition, the tray frame 30 includes an auxiliary frame 30C (charging/cleaning) (FIGS. 20 and 21). The auxiliary frame 30C extends in the drum axis direction D1 between the driving-side frame 30D and the non-driving-side frame 30N.

The auxiliary frame 30C holds a charging means and a cleaning means or constitutes part of the charging means and the cleaning means. The auxiliary frame 30C is provided in correspondence with each of the photosensitive drum 4, and therefore the tray frame 30 includes four auxiliary frames 30C in total. Each auxiliary frame 30C holds one corona charger 5 and one cleaning roller 7.

As illustrated in FIG. 18, the drum input couplings 54Y, 54M, 54C, and 54K and the developing input coupling 62 of each developing unit 8 are exposed on the driving-side side surface of the tray frame 30. In addition, a grip 31 (gripping portion) for the user to grip when attaching and pulling out the cartridge tray 3 to and from the apparatus main body 2 is provided on the front surface of the tray frame 30.

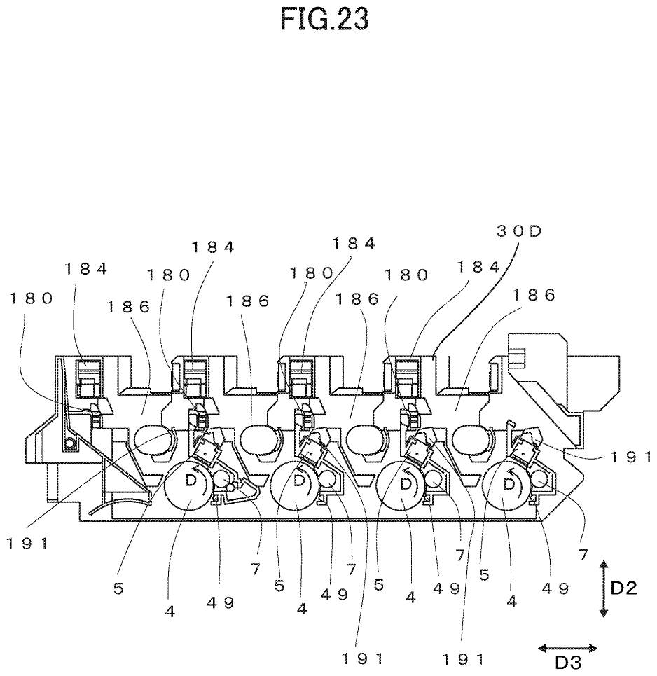

The cartridge tray 3 will be further described with reference to FIGS. 20 to 24. For easier understanding, illustration of the developing units 8 is omitted in FIGS. 20 to 24. FIG. 20 is a perspective view of the cartridge tray 3 as viewed from the driving side. FIG. 21 is a section view of the non-driving side of the cartridge tray 3 as viewed from a center portion of the cartridge tray 3 in the longitudinal direction. FIG. 22 is a perspective view of the cartridge tray 3 as viewed from the non-driving side. FIG. 23 is a section view of the driving side of the cartridge tray 3 as viewed from a center portion of the cartridge tray 3 in the longitudinal direction.

As illustrated in FIGS. 20 to 23, the cartridge tray 3 includes the photosensitive drums 4, the cleaning rollers 7, the corona chargers 5, and pre-exposing members 49. In the present embodiment, the cartridge tray 3 includes four photosensitive drums 4, and one of the cleaning rollers 7, one of the corona chargers 5, and one of the pre-exposing members 49 are provided for each of the photosensitive drum 4. In addition, each photosensitive drum 4, each cleaning roller 7, each corona charger 5, and each pre-exposing member 49 are coupled to the tray frame 30. The tray frame 30 to which the photosensitive drums 4, the cleaning rollers 7, the corona chargers 5, and the pre-exposing members 49 are coupled can be referred to as a drum unit.

The photosensitive drum 4 is an electrophotographic photosensitive member having a cylindrical shape (drum shape). The photosensitive drum 4 is formed by, for example, forming a photosensitive layer from an organic photosensitive material on the outer peripheral portion of a cylindrical base body formed from metal.

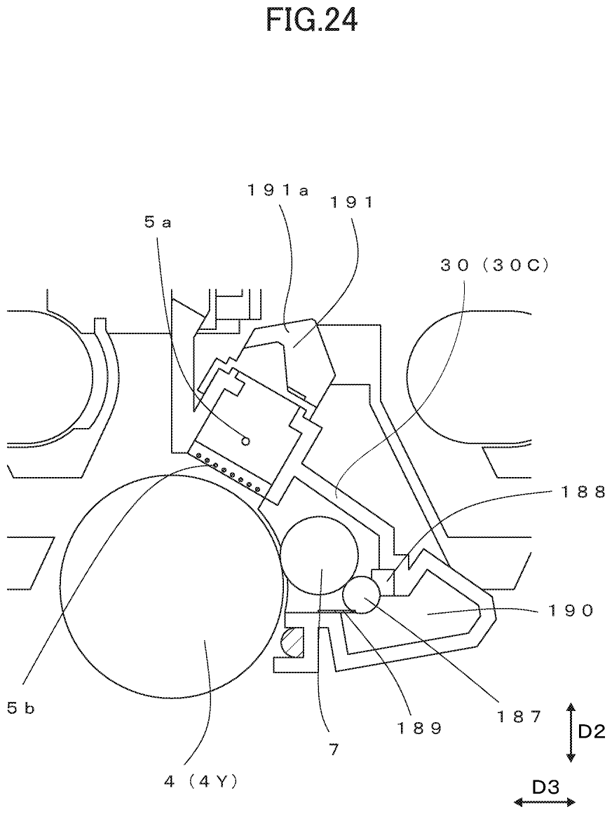

The corona charger 5 includes an electric discharge wire 5a (FIG. 24) extending in the rotation axis direction (drum axis direction D1) of the photosensitive drum 4, and a grid 5b (FIG. 24) that controls the electric discharge of the electric discharge wire 5a. The corona charger 5 is an example of a charging means, and a charging roller that comes into contact with the surface of the photosensitive drum 4 may be used.

The pre-exposing member 49 is a light guiding member that guides the light from a light source provided in the apparatus main body 2 to the surface of the photosensitive drum 4. The potential of the surface of the photosensitive drum 4 is lowered as a result of the light irradiation from the pre-exposing member 49. As a result of this, the electrostatic attaching force of foreign matter (hereinafter simply referred to as foreign matter), such as the toner (transfer residual toner) remaining on the photosensitive drum 4 without being transferred onto the recording medium S or paper dust, to the surface of the photosensitive drum 4 is lowered. To be noted, a light emitting unit including a light source such as a light emitting diode (LED) element may be used as the pre-exposing member 49.

The cleaning roller 7 is a cleaning member that removes foreign matter from the surface of the photosensitive drum 4. As illustrated in FIGS. 21 and 23, the cleaning roller 7 is disposed at a position downstream of the pre-exposing member 49 and upstream of the corona charger 5 in the rotation direction (arrow D direction in the drawings) of the photosensitive drum 4. As the cleaning member, for example, a rubber blade having an edge portion that abuts the surface of the photosensitive drum 4, or a brush roller that rotates while rubbing the surface of the surface of the photosensitive drum 4 may be used.

FIG. 24 is a section view of the cartridge tray 3 illustrating a portion around the cleaning roller 7 corresponding to the yellow photosensitive drum 4Y. The cartridge tray 3 includes a collecting roller 187, a first scraping member 188, and a second scraping member 189. One collecting roller 187, one first scraping member 188, and one second scraping member 189 are provided for each of the cleaning rollers 7.

As illustrated in FIG. 24, the collecting roller 187 is in contact with the surface of the cleaning roller 7. The collecting roller 187 is a metal roller that collects foreign matter attached to the surface of the cleaning roller 7 while rotating. Further, the first scraping member 188 and the second scraping member 189 abut the collecting roller 187. The foreign matter on the surface of the collecting roller 187 is scraped off by the first scraping member 188 and the second scraping member 189. In the present embodiment, the first scraping member 188 is a sponge member, and the second scraping member 189 is a sheet member. The scraped-off foreign matter is stored in a collecting chamber 190 defined by the tray frame 30.

A cleaning member 191 of the electric discharge wire 5a will be described. As illustrated in FIG. 24, the cleaning member 191 includes a wire cleaning portion that abuts the electric discharge wire 5a, a grid cleaning portion that abuts the grid 5b, and a grip portion 191a (operation portion) gripped by the user. The wire cleaning portion and the grid cleaning portion are each formed from, for example, an unwoven fabric. The user grips the grip portion 191a, and slides the cleaning member 191 from a driving-side position (FIG. 22) to a non-driving-side position in the longitudinal direction, and then to the driving-side position. As a result of this, the wire cleaning portion can rub and clean the surface of the electric discharge wire 5a, and the grid cleaning portion can rub and clean the surface of the grid 5b.

Coupling of the developing unit 8 to the cartridge tray 3 will be described. FIGS. 26 and 27 are each a perspective view illustrating a method to couple the developing unit 8 to the cartridge tray 3.

As illustrated in FIGS. 20, 21, and 27, a non-driving-side guide 183, a pressing member 184, and a first guide roller 3a are provided on the inner side surface of the non-driving-side frame 30N of the tray frame 30. In addition, a non-driving-side pressurizing unit 180 is disposed in the vicinity of the inner side surface of the non-driving-side frame 30N. One non-driving-side guide 183, one pressing member 184, one first guide roller 3a, and one non-driving-side pressurizing unit 180 are disposed in correspondence with each of the developing units 8.

As illustrated in FIGS. 22, 23, and 26, a driving-side guide 186, the pressing member 184, a second guide roller 3b, and a cam guide portion 3e are provided on the inner side surface of the driving-side frame 30D of the tray frame 30. In addition, a driving-side pressurizing unit 180 is disposed in the vicinity of the inner side surface of the driving-side frame 30D. One driving-side guide 186, one pressing member 184, one second guide roller 3b, and one driving-side pressurizing unit 180 are disposed in correspondence with each of the developing units 8.

The first guide roller 3a and the second guide roller 3b are abutted portions (first abutted portion and second abutted portion) that the separation member 170 (movable member) of the developing unit 8 abuts. The first guide roller 3a and the second guide roller 3b each function as a guide portion that guides the movement of the developing unit 8 with respect to the tray frame 30. The first guide roller 3a and the second guide roller 3b are each, for example, a cylindrical member formed from metal such as steel. The first guide roller 3a is rotatably supported by the first support member 3c. The second guide roller 3 b is rotatably supported by the second support member 3d. The first guide roller 3 a and the second guide roller 3b rotate about a rotation axis extending in a direction intersecting with (preferably orthogonal to) the drum axis direction D1 that is a driving direction of the separation member 170. In the present embodiment, the first guide roller 3a and the second guide roller 3b rotate about a rotation axis extending in the up-down direction.

The driving-side guide 186 and the non-driving-side guide 183 are each a groove shape or a rail shape extending mainly in a direction intersecting with both the drum axis direction D1 and the tray movement direction D3. In the present embodiment, the driving-side guide 186 and the non-driving-side guide 183 each mainly extend in the cartridge attachment/detachment direction D2. In addition, in the present embodiment, the driving-side guide 186 and the non-driving-side guide 183 each extend in the up-down direction. As will be described later, the driving-side guide 186 and the non-driving-side guide 183 guide the developing unit 8 when coupling the developing unit 8 to the cartridge tray 3.

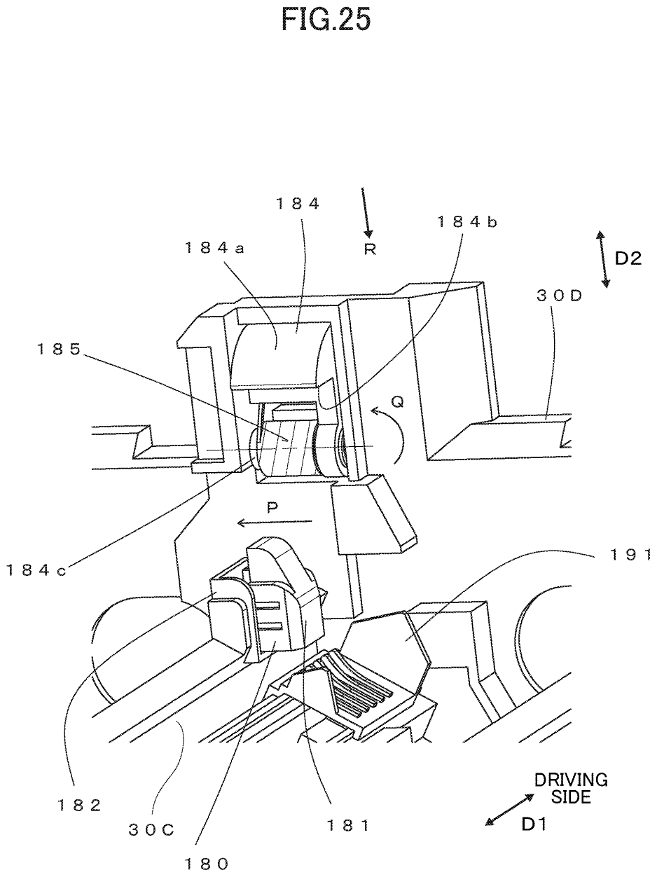

The pressurizing unit 180 will be described with reference to FIG. 25. FIG. 25 is a perspective view of part of the cartridge tray 3 (pressurizing unit 180 and the surroundings thereof).

The pressurizing unit 180 is configured to pressurize the developing unit 8 in a direction to press the developing roller 6 against the photosensitive drum 4. As illustrated in FIG. 25, the pressurizing unit 180 includes a pressurizing member 181 and a base member 182. In addition, the pressurizing unit 180 includes a pressurizing spring disposed between the pressurizing member 181 and the base member 182.

The base member 182 is fixed to the auxiliary frame 30C of the tray frame 30. The pressurizing member 181 is attached to the base member 182, and is supported by the base member 182 in such a manner that the pressurizing member 181 is movable with respect to the tray frame 30. Specifically, the pressurizing member 181 of the present embodiment is movable in a pressurizing direction along the tray movement direction D3 with respect to the tray frame 30.

The pressurizing member 181 and the base member 182 are coupled via, for example, a snap-fit portion. The snap-fit portion includes an elastically deformable claw provided in one of the pressurizing member 181 and the base member 182, and a hole (opening) provided in the other of the pressurizing member 181 and the base member 182 and engaged with the claw. The pressurizing member 181 is movable in an arrow P direction and a direction opposite thereto in the drawings with respect to the base member 182 by an amount corresponding to the clearance provided between the claw and the hole.

In addition, the pressurizing spring is coupled in a state of being compressed between the pressurizing member 181 and the base member 182. The pressurizing member 181 is urged in the direction opposite to the arrow P direction in the drawings by the urging force of the pressurizing spring.

To be noted, although the driving-side pressurizing unit 180 is illustrated in FIG. 25, the non-driving-side pressurizing unit 180 may have the same configuration as on the driving side.

Next, the pressing member 184 will be described with reference to FIG. 25. The pressing member 184 includes a pressed surface 184a, a pressing surface 184b serving as an abutted portion, and a shaft portion 184c.

The pressed surface 184a is a surface that is pressed by the developing unit 8 when attaching the developing unit 8 to the tray frame 30. The pressed surface 184a is a surface facing upstream in the coupling direction R of the developing unit 8 to the tray frame 30.

The pressing surface 184b is a surface that abuts the developing unit 8 in a state in which the developing unit 8 is attached to the tray frame 30, and thus presses the developing frame 132 to suppress detachment thereof from the developing unit 8. The pressing surface 184b is a surface facing downstream in the coupling direction R of the developing unit 8.

The shaft portion 184c is supported by a support portion provided in the driving-side frame 30D of the tray frame 30. The pressing member 184 is pivotable about the shaft portion 184c with respect to the tray frame 30. By the pivot of the pressing member 184, the pressed surface 184a can move between a position (FIG. 25) where the pressed surface 184a enters the movement trajectory of attachment and detachment of the developing unit 8 to and from the tray frame 30 and a position where the pressed surface 184a is retracted to the outside of the movement trajectory. By the pivot of the pressing member 184, the pressing surface 184b can move between a position (FIG. 25) where the pressing surface 184b overlaps with the developing unit 8 attached to the tray frame 30 as viewed in the coupling direction R of the developing unit 8 and a position where the pressing surface 184b does not overlap with the developing unit 8 attached to the tray frame 30.

A pressing spring 185 is attached to the shaft portion 184c. The pressing spring 185 may be a torsion spring that generates a rotational moment about the rotation axis of the pressing member 184. The pressing spring 185 urges the pressing member 184 in an arrow Q direction (direction in which the pressing surface 184b moves toward the front side in a direction orthogonal to the paper surface of FIG. 25) in the drawings with respect to the tray frame 30. In addition, as a result of part of the pressing member 184 abutting a stopper portion provided in the tray frame 30, pivot of the pressing member 184 in the arrow Q direction beyond the position illustrated in FIG. 25 is suppressed.

Although FIG. 25 illustrates only the driving-side pressing member 184, the non-driving-side pressing member 184 may have the same configuration as on the driving side except for being supported by the non-driving-side frame 30N.

### Coupling Process of Developing Unit

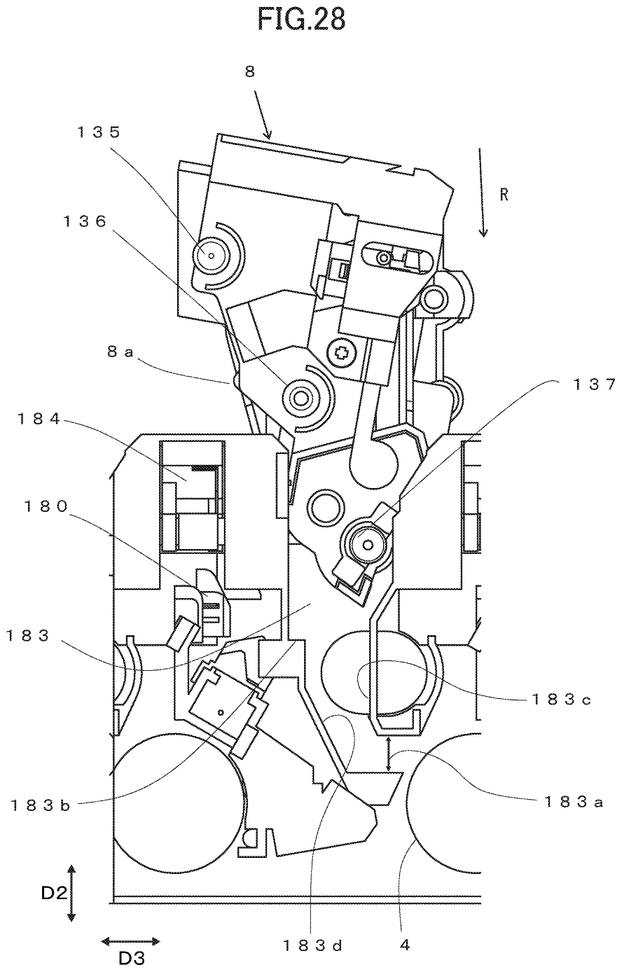

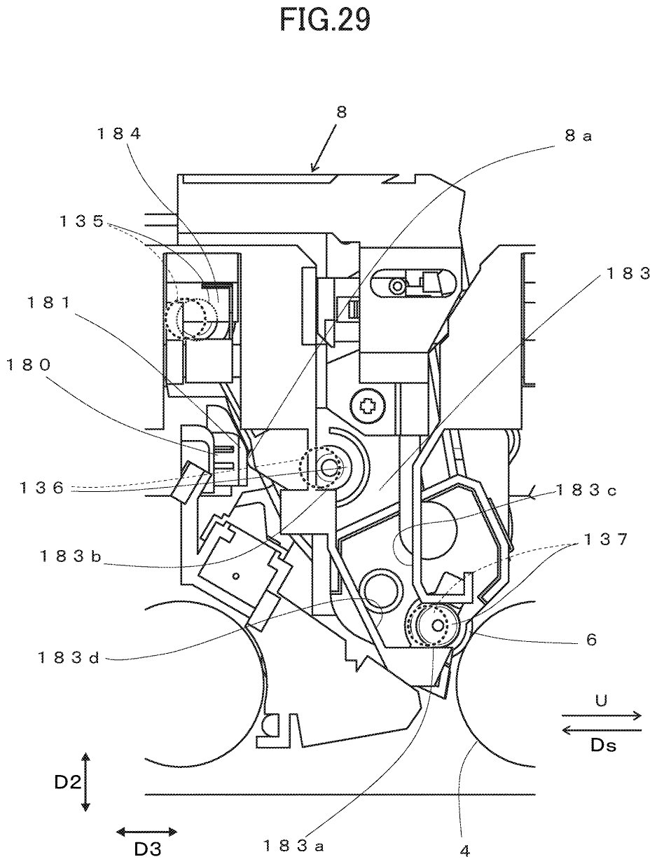

A process of coupling the developing unit 8 to the cartridge tray 3 will be described with reference to FIGS. 28 and 29. FIGS. 28 and 29 are each a schematic view of the cross-section of part of the cartridge tray 3 taken along a plane orthogonal to the drum axis direction D1, and illustrates the coupling process of the developing unit 8 on the non-driving side. FIG. 28 illustrates a state in the middle of the coupling of the developing unit 8. FIG. 29 illustrates a state after the completion of the coupling of the developing unit 8.

As illustrated in FIG. 28, the non-driving-side guide 183 includes a first guide portion 183c, a second guide portion 183d, a positioning portion 183a, and an abutting portion 183b.

The first guide portion 183c and the second guide portion 183d oppose each other in the tray movement direction D3. A groove portion extending mainly in the coupling direction R of the developing unit 8 is formed between the first guide portion 183c and the second guide portion 183d. The third roller 137 passes through this groove portion when attaching the developing unit 8.

The coupling direction R of the developing unit 8 is a direction intersecting with both the longitudinal direction (drum axis direction D1) of the developing unit 8 and the tray movement direction D3. The coupling direction R of the developing unit 8 of the present embodiment is a downward direction in the vertical direction, and is a direction along the cartridge attachment/detachment direction D2 that is the attachment/detachment direction of the toner cartridge 100.

The positioning portion 183a is formed at a downstream end of the non-driving-side guide 183 in the coupling direction R. The positioning portion 183a includes a surface facing upstream in the coupling direction R and a surface facing downstream in the coupling direction R. In other words, the positioning portion 183a forms a groove portion extending in a direction (arrow U direction in FIG. 29) intersecting with the coupling direction R of the developing unit 8 as viewed in the longitudinal direction.

The abutting portion 183b is formed on the upstream side of the second guide portion 183d in the coupling direction R. The abutting portion 183b is a surface facing upstream in the coupling direction R of the developing unit 8. The abutting portion 183b extends in a direction (arrow U direction in FIG. 29) intersecting with the coupling direction R of the developing unit 8.

As illustrated in FIG. 28, in the case of coupling the developing unit 8 to the cartridge tray 3, the developing unit 8 is moved in the coupling direction R such that each roller provided at the non-driving-side end portion of the developing unit 8 moves toward the non-driving-side guide 183 or the pressing member 184 (also see FIG. 26). Specifically, the developing unit 8 is moved such that the third roller 137 on the non-driving side enters the groove portion of the non-driving-side guide 183, the second roller 136 moves toward the abutting portion 183b, and the first roller 135 moves toward the non-driving-side pressing member 184.

As illustrated in FIG. 29, when the third roller 137 reaches the positioning portion 183a serving as an abutted portion of the non-driving-side guide 183, the movement of the developing unit 8 in the coupling direction R is restricted. As a result of the abutment between the third roller 137 and the positioning portion 183a, the position of the developing unit 8 in the coupling direction R is determined. In addition, the second roller 136 abuts the abutting portion 183b serving as an abutted portion of the non-driving-side guide 183.

Here, the developing unit 8 is movable in a direction (arrow U direction and a direction opposite thereto in the drawings) intersecting with the coupling direction R in a state in which the second roller 136 and the third roller 137 are engaged with the non-driving-side guide 183. As a result of the second roller 136 and the third roller 137 being configured to be rotatable as described above, the developing unit 8 can move in the direction intersecting with the coupling direction R more smoothly.

Specifically, the third roller 137 can rotate in contact with the positioning portion 183a of the non-driving-side guide 183. The second roller 136 can rotate in contact with the abutting portion 183b. The developing unit 8 of the present embodiment can move with respect to the tray frame 30 in the arrow U direction and the direction opposite thereto in FIG. 29 in which the positioning portion 183a and the abutting portion 183b extend.

As illustrated in FIG. 29, as a result of the engagement of the third roller 137 with the positioning portion 183a and the abutment of the second roller 136 on the abutting portion 183b, the position of the developing unit 8 as viewed in the longitudinal direction is determined. When the third roller 137 is engaged with the positioning portion 183a and the second roller 136 is abutting the abutting portion 183b, it can be said that the non-driving-side end of the developing unit 8 is at a coupled position.

Although the guide shape on the non-driving side and the coupling process of the developing unit 8 on the non-driving side have been described above, the guide shape on the driving side and the coupling process of the developing unit 8 on the driving side are substantially the same as on the non-driving side.

That is, as illustrated in FIG. 26, the driving-side guide 186 includes a third guide portion 186c, a fourth guide portion 186d, a positioning portion 186a, and an abutting portion 186b.

The third guide portion 186c and the fourth guide portion 186d oppose each other in the tray movement direction D3. A groove portion extending mainly in the coupling direction R of the developing unit 8 is formed between the third guide portion 186c and the fourth guide portion 186d. The sixth roller 140 passes through this groove portion when attaching the developing unit 8.

The positioning portion 186a is formed at a downstream end of the driving-side guide 186 in the coupling direction R. The positioning portion 186a includes a surface facing upstream in the coupling direction R and a surface facing downstream in the coupling direction R. In other words, the positioning portion 186a defines a groove portion extending in a direction (arrow U direction in FIG. 29) intersecting with the coupling direction R of the developing unit 8 as viewed in the longitudinal direction.

The abutting portion 186b is formed on the upstream side of the fourth guide portion 186d in the coupling direction R. The abutting portion 186b is a surface facing upstream in the coupling direction R of the developing unit 8. The abutting portion 186b extends in a direction (arrow U direction in FIG. 29) intersecting with the coupling direction R of the developing unit 8.

In the case of coupling the developing unit 8 to the cartridge tray 3, the developing unit 8 is moved in the coupling direction R such that each roller provided at the driving-side end portion of the developing unit 8 moves toward the driving-side guide 186 or the pressing member 184 (also see FIG. 27). Specifically, the developing unit 8 is moved such that the sixth roller 140 on the driving side enters the groove portion of the driving-side guide 186, the fifth roller 139 moves toward the abutting portion 186b, and the fourth roller 138 moves toward the driving-side pressing member 184.

As illustrated in FIG. 29, when the sixth roller 140 reaches the positioning portion 186a serving as an abutted portion of the driving-side guide 186, the movement of the developing unit 8 in the coupling direction R is restricted. As a result of the abutment on the positioning portion 186a, the position of the developing unit 8 in the coupling direction R is determined. In addition, the fifth roller 139 abuts the abutting portion 186b serving as an abutted portion of the driving-side guide 186.

Here, the developing unit 8 is movable in a direction intersecting with the coupling direction R in a state in which the fifth roller 139 and the sixth roller 140 are engaged with the driving-side guide 186. As a result of the fifth roller 139 and the sixth roller 140 being configured to be rotatable as described above, the developing unit 8 can move in the direction intersecting with the coupling direction R more smoothly.

Specifically, the fifth roller 139 can rotate in contact with the abutting portion 186b of the driving-side guide 186. The sixth roller 140 can rotate in contact with the positioning portion 186a of the driving-side guide 186. The developing unit 8 of the present embodiment can move with respect to the tray frame 30 in the extending direction (arrow U direction in FIG. 29) of the positioning portion 186a and the abutting portion 186b.

As a result of the engagement of the sixth roller 140 with the positioning portion 186a and the abutment of the fifth roller 139 on the abutting portion 186b, the position of the developing unit 8 as viewed in the longitudinal direction is determined. When the sixth roller 140 is engaged with the positioning portion 186a and the fifth roller 139 is abutting the abutting portion 186b, it can be said that the driving-side end of the developing unit 8 is at the coupled position.

In the present embodiment, the coupled position of the developing unit 8 is a position of the developing unit 8 where the driving-side end of the developing unit 8 is at a coupled position and the non-driving-side end of the developing unit 8 is at a coupled position.

The operation of the separation member 170 in the coupling process will be described. The second cam 173 of the separation member 170 is provided with the guided portion 173e (FIG. 42) described above, and the tray frame 30 is provided with the cam guide portion 3e (FIG. 26) described above. In the coupling process of the developing unit 8, the guided portion 173e abuts the cam guide portion 3e.

At least one of the guided portion 173e and the cam guide portion 3e is an inclined surface inclined toward the non-driving side and the downstream side in the coupling direction R of the developing unit 8. As a result of the abutment between the guided portion 173e and the cam guide portion 3e, the separation member 170 receives a force in a direction toward the non-driving side. Therefore, in the coupling process of the developing unit 8, the separation member 170 moves toward the non-driving side against the urging force of the separation urging spring 175 (FIG. 42). As a result of this, the first inclined surface 172a and the second inclined surface 173a of the first cam 172 and the second cam 173 are retracted so as not to come into contact with the first guide roller 3a and the second guide roller 3b (FIG. 43A).

When the developing unit 8 reaches the coupling position, each of the pressed portions 8a (also see FIG. 9A) of the developing unit 8 abuts the pressurizing member 181 of the pressurizing unit 180 as illustrated in FIG. 29. The developing unit 8 is pressed by the pressurizing unit 180, and thus moves in the arrow U direction in the drawings. To be noted, although FIG. 29 only illustrates the non-driving-side pressed portion 8a and the non-driving-side pressurizing unit 180, the driving-side pressed portion 8a (FIG. 9A) is also pressed by the driving-side pressurizing unit 180. As a result of this configuration, the developing roller 6 is pressed against the photosensitive drum 4 by the pressurizing force of the pressurizing unit 180, and the developing unit 8 takes the abutting state. In this manner, the developing unit 8 is positioned at the coupling position.

Each roller (135 to 140) provided in the developing unit 8 can rotate in contact with the tray frame 30 when attaching the developing unit 8 to the tray frame 30 (first frame). As a result of this, the frictional resistance when coupling the developing unit 8 can be reduced, and the operability can be improved.

For example, the third roller 137 on the non-driving side can rotate in contact with the first guide portion 183c or the second guide portion 183d of the non-driving-side guide 183 in accordance with the movement of the developing unit 8 in the coupling direction R. The sixth roller 140 on the driving side can rotate in contact with the third guide portion 186c or the fourth guide portion 186d of the driving-side guide 186 in accordance with the movement of the developing unit 8 in the coupling direction R. In addition, the developing unit 8 having reached the coupling position moves in the arrow U direction in FIG. 29 by the pressurizing force of the pressurizing unit 180. At this time, the first roller 135, the second roller 136, and the third roller 137 on the non-driving side can respectively rotate in contact with the pressing surface 184b of the pressing member 184, the abutting portion 183b, and the positioning portion 183a. In addition, the fourth roller 138, the fifth roller 139, and the sixth roller 140 on the driving side can respectively rotate in contact with the pressing surface 184b of the pressing member 184, the abutting portion 186b, and the positioning portion 186a.

### Operation of Pressing Member

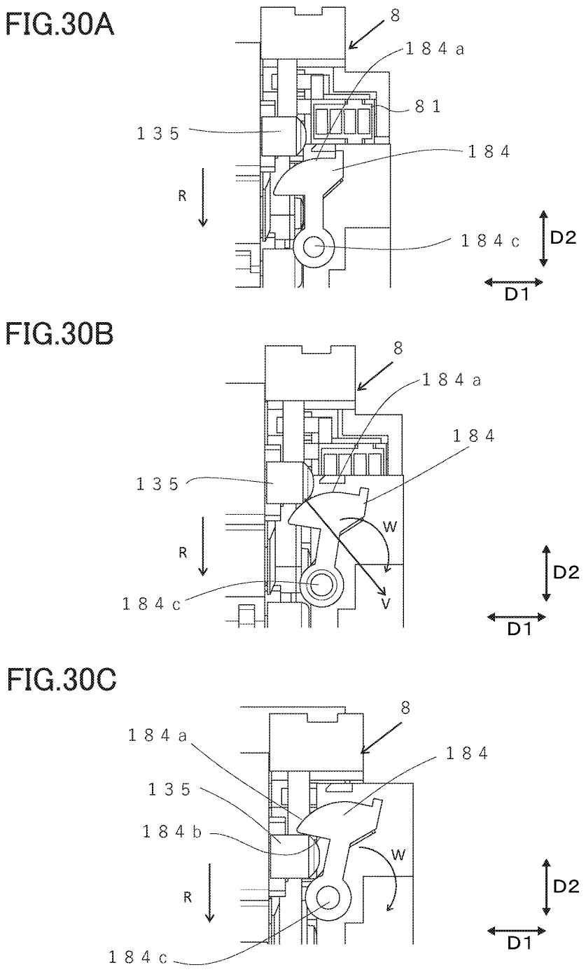

The operation of the pressing member 184 in the coupling process will be described. FIGS. 30A, 30B, and 30C are each a schematic diagram illustrating the coupling process of the developing unit 8 to the cartridge tray 3 step by step and the positional relationship between the pressing member 184 and the first roller 135.

When coupling the developing unit 8, the developing unit 8 is moved in the coupling direction R from the opposite side (upper side in the drawings) of the tray frame 30 in the coupling direction R as illustrated in FIG. 30A. As illustrated in FIG. 30B, the first roller 135 abuts the pressed surface 184a of the pressing member 184. As a result of this, a pressing force in an arrow V direction in the drawings acts on the pressed surface 184a of the pressing member 184 from the first roller 135. As a result of this pressing force, the pressing member 184 rotates in an arrow W direction in the drawings about the shaft portion 184c. As a result of this rotation, the pressed surface 184a of the pressing member 184 retracts from the movement trajectory of the first roller 135 in the coupling of the developing unit 8, and thus allows the passage of the first roller 135.

When the developing unit 8 reaches the coupling position, the first roller 135 passes the pressed surface 184a of the pressing member 184 as illustrated in FIG. 30C. The pressing member 184 rotates in a direction opposite to the arrow W direction in the drawings by the urging force of the pressing spring 185 (see FIG. 25). As a result of this rotation, the pressing surface 184b of the pressing member 184 abuts the upper surface (surface facing upstream in the coupling direction R) of the first roller 135. In addition, the pressing surface 184b presses the first roller 135 by the urging force of the pressing spring 185. As a result of this configuration, the developing unit 8 can be pressed against the tray frame 30.

### Detachment Suppression of Developing Unit

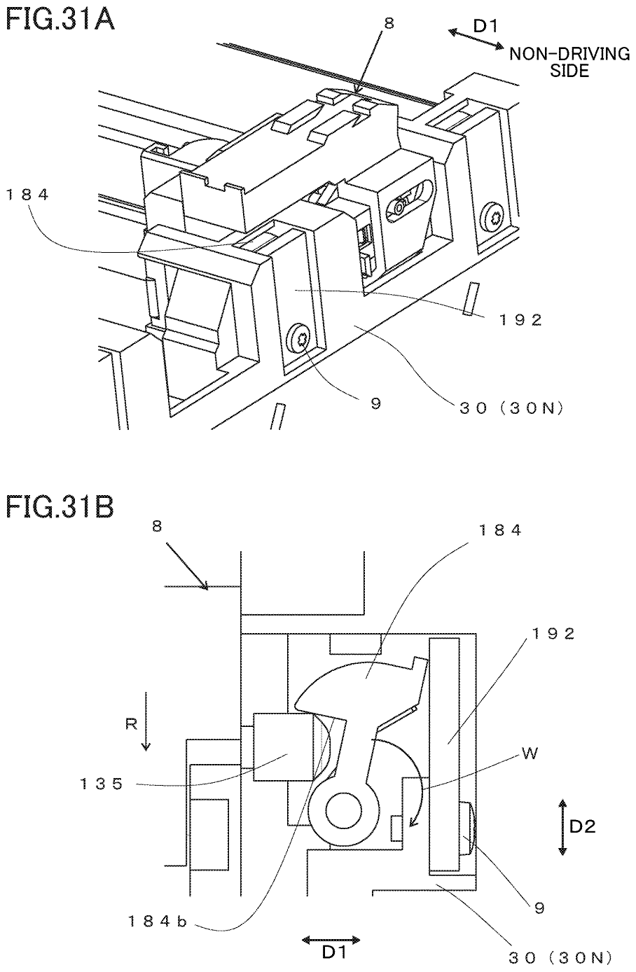

Next, a configuration for suppressing detachment of the developing unit 8 from the cartridge tray 3 will be described with reference to FIGS. 31A and 31B. FIG. 31A is a perspective view of part (retaining portion) of the cartridge tray 3. FIG. 31B is an enlarged view of the retaining portion.

As illustrated in FIGS. 31A and 31B, the cartridge tray 3 includes a locking member 192 serving as a retaining portion. The locking member 192 is attached to the tray frame 30 as illustrated in FIG. 31 after the developing unit 8 is coupled to the coupled position. The locking member 192 is fixed to the non-driving-side frame 30N by using, for example, the screw 9.

As illustrated in FIG. 31B, the locking member 192 restricts the rotation of the pressing member 184 in the arrow W direction in the drawings. The locking member 192 restricts the rotation of the pressing member 184, and thus can suppress detachment of the developing unit 8 from the tray frame 30. To be noted, although FIGS. 31A and 31B illustrate only the retaining portion on the non-driving side, a retaining portion substantially the same as that on the non-driving side is also provided on the driving side.

To be noted, in the present embodiment, although replacement of the developing unit 8 by the user is not considered in principle, for example, the developing unit 8 may be replaced by a worker in a repairing factory. In this case, by untightening the screws 9 and detaching the locking member 192 from the non-driving-side frame 30N, the restriction of the rotation of the pressing member 184 is cancelled. As a result of this, detachment and re-attachment of the developing unit 8 to and from the tray frame 30 can be performed.

### Power Supply to Developing Unit

Here, a configuration to supply power to the developing unit 8 will be described. The developing unit 8 of the present embodiment includes a developing roller 6 and a supply roller 26 as power supply targets that receive power supply from an electric circuit provided in the apparatus main body 2.

When the developing unit 8 is coupled to the cartridge tray 3, the third roller 137 abuts a developing bias contact of the cartridge tray 3. The developing bias contact is electrically connected to a voltage generation circuit of the apparatus main body 2. As described above, the developing bearing 71 and the third roller 137 are formed from a conductive resin, and the metal shaft 26a of the supply roller 26 is supported by the developing bearing 71. That is, the third roller 137 is electrically connected to the developing roller 6 and the supply roller 26 (also see FIGS. 9A, 9B, and 11). Therefore, the voltage (developing bias) generated by the voltage generation circuit is applied to the developing roller 6 and the supply roller 26 via the developing bias contact and the third roller 137.

To be noted, although a configuration in which the third roller 137 is electrically connected to both the developing roller 6 and the supply roller 26 and the same voltage is applied to the developing roller 6 and the supply roller 26 has been described in the present embodiment, a configuration in which the third roller 137 is electrically connected to only one of the developing roller 6 and the supply roller 26 may be employed. In this case, a contact portion different from the third roller 137 may be added to the developing unit 8, and a different voltage may be applied to each of the developing roller 6 and the supply roller 26. In addition, a portion different from the third roller 137 on the outer surface of the developing unit 8 may be configured as a contact portion for supplying power to the power supply targets in the developing unit 8.

### Coupling of Memory Tag Unit

Next, a coupling process of the memory tag unit 80 coupled to the cartridge tray 3 together with the developing unit 8 will be described. FIGS. 32A and 32B are each a perspective view of part (memory tag unit 80 and the surroundings thereof) of the cartridge tray 3. FIG. 32A illustrates a coupling process of the memory tag unit 80. FIG. 32B illustrates a coupling completion state of the memory tag unit 80. For easier understanding, illustration of the holder 85 is omitted in FIGS. 32A and 32B.

As illustrated in FIG. 32A, in a state before the coupling, a distance E between the tag support member 82 of the memory tag unit 80 and the spring receiving member 84 is large due to the urging force of the tag pressing spring 83 (FIG. 17). For example, the tag support member 82 and the spring receiving member 84 take a state in which the claw 84a of the snap-fit portion is abutting an end portion of the opening 82e.

The cartridge tray 3 includes an inclined surface 193 that guides the memory tag unit 80 and a positioning surface 194 that positions the memory tag unit 80. In the present embodiment, the inclined surface 193 and the positioning surface 194 are provided on the non-driving-side frame 30N.

A direction in which the electric contact portion 81a (FIG. 16) of the memory tag 81 and the tray-side contact portion 32 oppose in a state after the coupling will be referred to as a contact opposing direction. At this time, the inclined surface 193 is inclined such that a more downstream portion thereof in the coupling direction R is closer to the tray-side contact portion 32 in the contact opposing direction. The positioning surface 194 extends in the coupling direction R from a downstream end of the inclined surface 193 in the coupling direction R. The contact opposing direction may be parallel to the tray movement direction D3. In addition, the inclined surface 193 may be inclined downward toward the rear side as viewed in the drum axis direction D1. The positioning surface 194 may be a surface extending in the drum axis direction D1 and the vertical direction.

In the process of moving the developing unit 8 in the coupling direction R from the state of FIG. 32A, the memory tag unit 80 enters between the tray-side contact portion 32 and the inclined surface 193 of the cartridge tray 3. Then, the spring receiving member 84 of the memory tag unit 80 abuts the inclined surface 193, and moves closer to the tag support member 82. That is, as the memory tag unit 80 moves in the coupling direction R, the distance E between the tag support member 82 and the spring receiving member 84 decreases. The claw 84a moves away from the end portion of the opening 82e. In addition, the deformation amount (compression amount) of the tag pressing spring 83 increases.

In a state in which the developing unit 8 is coupled to the coupled position, the spring receiving member 84 abuts the positioning surface 194 of the cartridge tray 3. That is, the memory tag unit 80 is sandwiched between the tray-side contact portion 32 and the positioning surface 194. In this coupling completion state, the electric contact portion 81a of the memory tag 81 is pressed against the tray-side contact portion 32 by the urging force of the tag pressing spring 83.

In addition, as described above, the memory tag unit 80 is movably supported with respect to the frame of the developing unit 8. Therefore, even in the case where the developing unit 8 moves with respect to the tray frame 30 by the separation operation of the developing unit 8 or the like, the contact between the electric contact portion 81a of the memory tag 81 and the tray-side contact portion 32 can be maintained.

More specifically, in the separation operation of the developing unit 8 that will be described later, the developing unit 8 moves in a direction orthogonal to the drum axis direction D1 with respect to the tray frame 30. The movement direction of the developing unit 8 in the separation operation will be referred to as a separation direction Ds. The separation direction Ds in the present embodiment is a direction in which the third roller 137 moves along the positioning portion 183a (FIG. 29). In addition, the separation direction Ds of the developing unit 8 in the present embodiment is a direction opposite to the arrow U direction of FIG. 29.

The memory tag unit 80 is supported by the holder 85 and the holder base 86 serving as support portions described above to be movable in a direction parallel to the separation direction Ds with respect to the developing frame 132. That is, as illustrated in FIG. 32B, the engagement between the first posture regulation boss 82a and the first posture regulation hole 85a allows relative movement of the memory tag unit 80 in the separation direction Ds and a direction opposite thereto with respect to the developing frame 132. Similarly, the engagement between the second posture regulation boss 82b and the second posture regulation hole 86a and the engagement between the third posture regulation boss 82c and the third posture regulation hole 86b (see FIG. 17) allow relative movement of the memory tag unit 80 in the separation direction Ds and a direction opposite thereto with respect to the developing frame 132. Therefore, when the developing frame 132 of the developing unit 8 moves in the separation direction Ds by the separation operation, the memory tag unit 80 relatively moves in the direction opposite to the separation direction Ds with respect to the developing frame 132, and thus contact between the memory tag 81 and the tray-side contact portion 32 can be maintained. In addition, as a result of the bosses of the memory tag unit 80 being engaged with the holes of the support portions (85 and 86) at a plurality of positions around the electric contact portion 81a as viewed in the contact opposing direction, the posture of the memory tag unit 80 can be stabilized more, and thus a contact failure can be suppressed.

### Attachment of Toner Cartridge

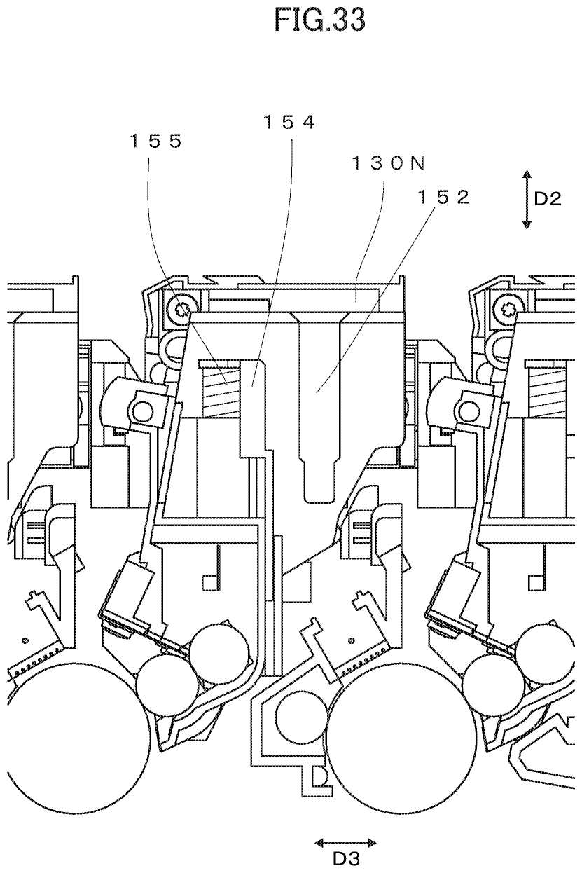

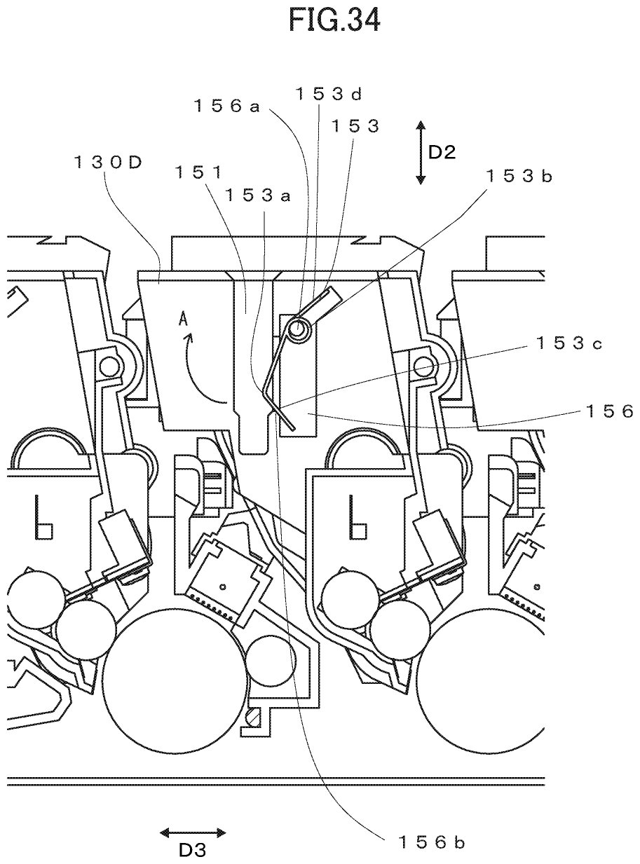

A configuration related to the attachment of the toner cartridge 100 to the cartridge tray 3 will be described. FIG. 33 is a section view of the cartridge tray 3 in which the non-driving side thereof is viewed from the center portion in the longitudinal direction. FIG. 34 is a section view of the cartridge tray 3 in which the driving side thereof is viewed from the center portion in the longitudinal direction.

As illustrated in FIG. 33, a groove 152 is provided on the inner side surface of the second side portion 130N of the developing unit 8 (also see FIG. 10). As illustrated in FIG. 34, a groove 151, a locking spring 153, a spring accommodating portion 156, and a spring support protrusion 156a are provided on the inner side surface of the first side portion 130D of the developing unit 8 (also see FIG. 9). The grooves 151 and 152 extend in the cartridge attachment/detachment direction D2.

The locking spring 153 is an urging member that generates an urging force for restricting detachment of the toner cartridge 100. A torsion spring can be used as the locking spring 153. The locking spring 153 that is a torsion spring includes a coil portion 153b, a movable arm including a locking portion 153a and an abutting portion 153c, and a fixed arm 153d.

As illustrated in FIG. 34, the distal end of the movable arm of the locking spring 153 is accommodated in the spring accommodating portion 156 that is a recess portion formed in the inner side surface of the first side portion 130D. The fixed arm 153d is held in the recess portion formed in the inner side surface of the first side portion 130D. The coil portion 153b is supported by the spring support protrusion 156a provided in the spring accommodating portion 156 so as not to come off from the spring support protrusion 156a. The locking spring 153 is coupled in a state in which the abutting portion 153c is in pressure contact with the abutted portion 156b of the spring accommodating portion 156 by the urging force generated by the coil portion 153b. In addition, in the coupled state, the locking portion 153a protrudes in a direction opposite to the arrow B direction as compared with the abutting portion 153c.

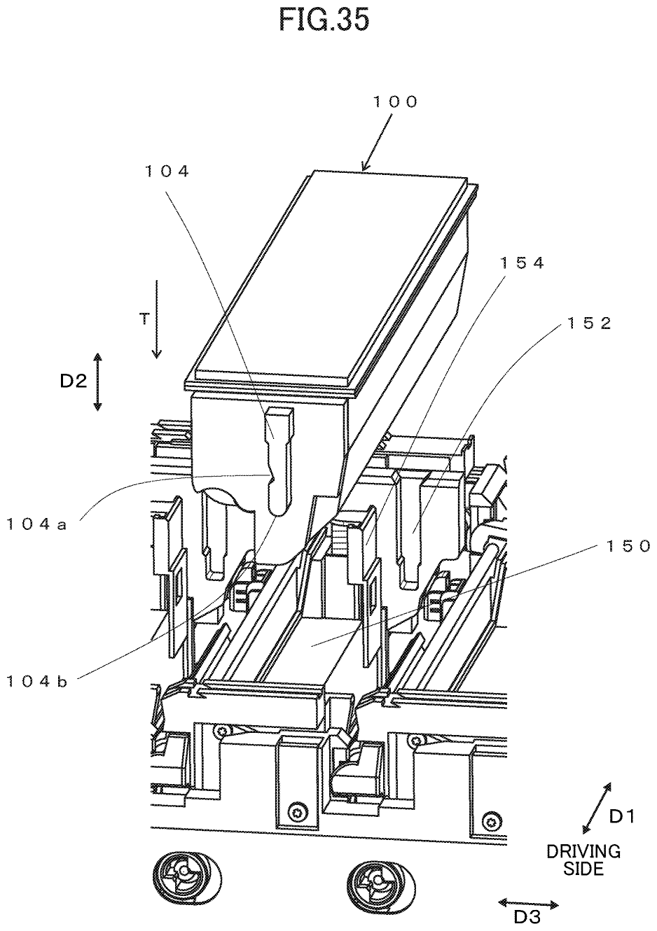

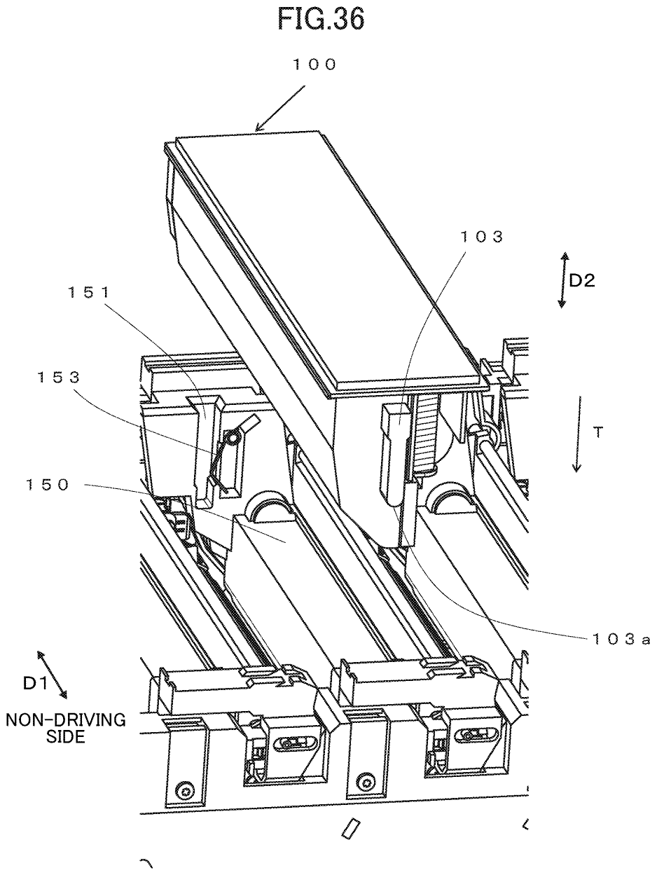

FIGS. 35 and 36 are each a perspective view illustrating the process of attaching the toner cartridge 100 to the cartridge tray 3. As illustrated in FIGS. 35 and 36, the user moves the toner cartridge 100 in the attachment direction T such that the guide 103 on the non-driving side of the toner cartridge 100 enters the groove 152 of the developing unit 8 and the guide 104 on the driving side enters the groove 151 of the developing unit 8. The attachment direction T is the cartridge attachment/detachment direction D2 and a direction downward in the vertical direction.

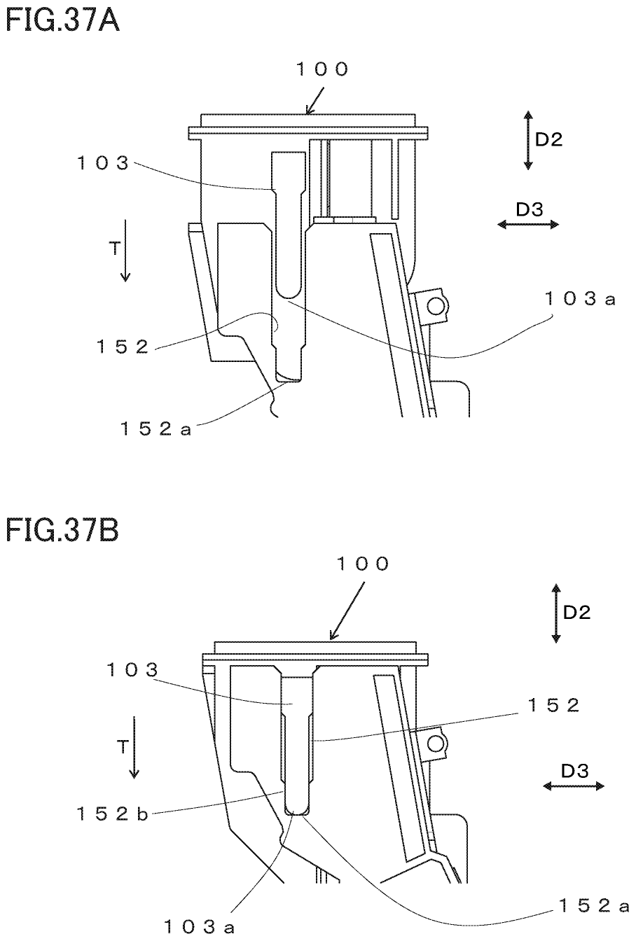

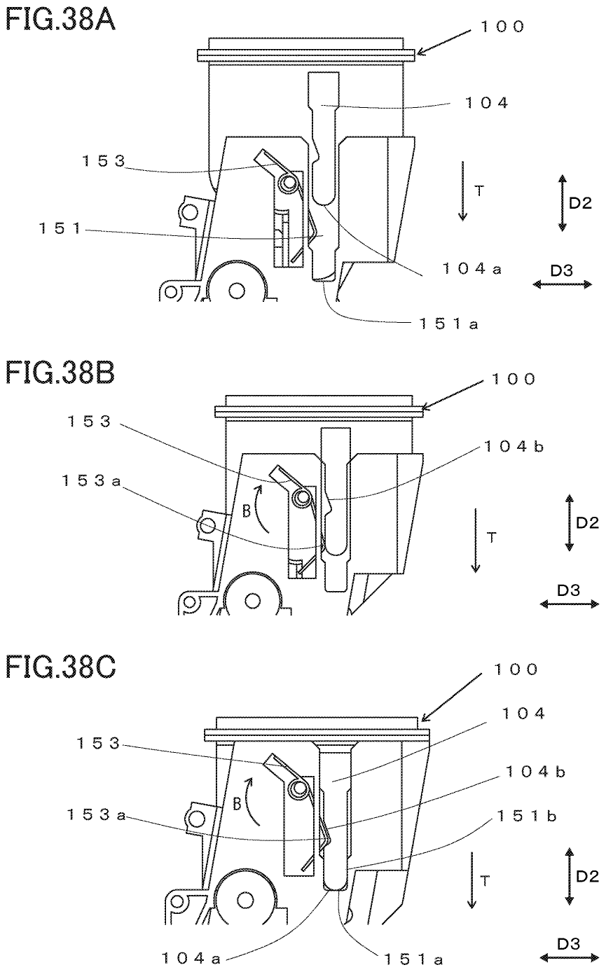

The attachment process of the toner cartridge 100 will be described further with reference to FIGS. 37A, 37B, 38A, 38B, and 38C. FIGS. 37A and 37B illustrate the attachment process of the toner cartridge 100 on the non-driving side. FIGS. 38A, 38B, and 38C illustrate the attachment process of the toner cartridge 100 on the driving side. For easier understanding, only part of the toner cartridge 100 and the developing unit 8 is illustrated in FIGS. 37A, 37B, 38A, 38B, and 38C.

As illustrated in FIG. 37A, on the non-driving side, the guide 103 of the toner cartridge 100 moves in the attachment direction T in the groove 152 of the developing unit 8. As illustrated in FIG. 37B, when the distal end portion 103a of the guide 103 in the attachment direction T abuts an abutting surface 152a provided at the bottom of the groove 152, the position of the toner cartridge 100 in the attachment direction T is determined. In addition, a positioning portion 152b is provided at a downstream portion of the groove 152 in the attachment direction T. In the positioning portion 152b, the groove width (width in the left-right direction in the drawings) is smaller than that of the upstream portion of the groove 152, and for example, is formed in a width approximately equal to that of the distal end portion 103a of the guide 103. Therefore, in a state in which the distal end portion 103a of the guide 103 is abutting the abutting surface 152a, the position of the toner cartridge 100 in a direction orthogonal to both the drum axis direction D1 and the attachment direction T is determined by the engagement between the guide 103 and the positioning portion 152b.

As illustrated in FIG. 38A, on the driving side, the guide 104 of the toner cartridge 100 proceeds in the attachment direction T in the groove 151 of the developing unit 8. As illustrated in FIG. 38C, when the distal end portion 104a of the guide 104 in the attachment direction T abuts the abutting surface 151a provided at the bottom of the groove 151, the position of the toner cartridge 100 in the attachment direction T is determined. In addition, a positioning portion 151b is provided at a downstream portion of the groove 151 in the attachment direction T. In the positioning portion 151b, the groove width (width in the left-right direction in the drawings) is smaller than that of the upstream portion of the groove 151, and for example, is formed in a width approximately equal to that of the distal end portion 104a of the guide 104. Therefore, in a state in which the distal end portion 104a of the guide 104 is abutting the abutting surface 151a, the position of the toner cartridge 100 in a direction orthogonal to both the drum axis direction D1 and the attachment direction T is determined by the engagement between the guide 104 and the positioning portion 151b.

The position of the toner cartridge 100 where the distal end portions 103a and 104a of the guides 103 and 104 abut the abutting surfaces 152a and 151a of the grooves 152 and 151 will be referred to as an attached position of the toner cartridge 100. Toner is supplied from the toner cartridge 100 to the developing unit 8 in a state in which the toner cartridge 100 is at the attached position.

As illustrated in FIG. 38B, the guide 104 abuts the locking portion 153a of the locking spring 153 while the toner cartridge 100 moves toward the attached position. The locking spring 153 is elastically deformed by being pressed by the guide 104, and the locking portion 153a moves in the arrow B direction in the drawings. That is, the locking portion 153a retracts from the movement trajectory of the guide 104 so as to allow passage of the toner cartridge 100.

Then, when the toner cartridge 100 reaches the attached position, as illustrated in FIG. 38C, the locking spring 153 is released from the pressing by the guide 104. Then, the locking portion 153a moves in a direction opposite to the arrow B direction in the drawings, and engages with a locking groove 104b provided in the guide 104. In a state in which the toner cartridge 100 is at the attached position, the locking portion 153a overlaps with the inner wall of the locking groove 104b as viewed in the attachment direction T. In other words, in a state in which the toner cartridge 100 is at the attached position, the surface of the locking groove 104b facing upstream in the attachment direction T and the surface of the locking portion 153a facing downstream in the attachment direction T oppose each other. According to this configuration, unintentional detachment of the toner cartridge 100 from the developing unit 8 can be suppressed (toner cartridge 100 can be retained).

When detaching the toner cartridge 100, the user grips the toner cartridge 100 and pulls the toner cartridge 100 in the direction opposite to the attachment direction T. Then, when the force of the guide 104 pressing the locking portion 153a surpasses the urging force of the locking spring 153, the locking spring 153 is elastically deformed, and the locking portion 153a moves in the direction opposite to the arrow B direction in the drawings and is separated from the locking groove 104b. As a result of this, the toner cartridge 100 can be detached from the developing unit 8.

### Shutter Operation

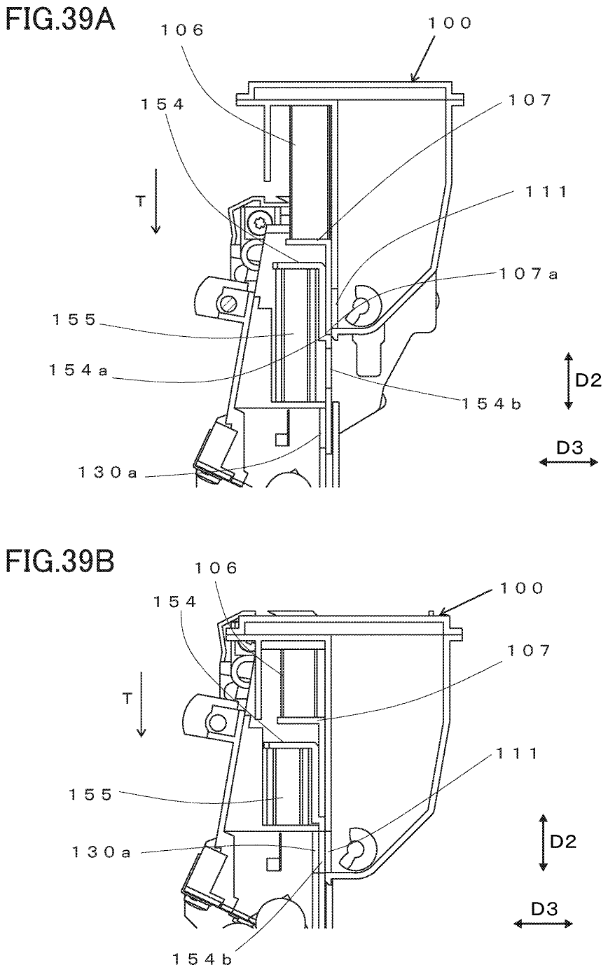

The discharge port shutter 107 of the toner cartridge 100 and the inlet port shutter 154 of the developing unit 8 will be further described with reference to FIGS. 39A and 39B. FIGS. 39A and 39B are each a section view of the toner cartridge 100 and the developing unit 8 taken along a plane passing through the discharge port shutter 107 and orthogonal to the longitudinal direction. FIG. 39A illustrates a state in the middle of attachment of the toner cartridge 100. FIG. 39B illustrates a state (attachment completion state) in which the toner cartridge 100 is at the attached position.

As illustrated in FIG. 39A, in a state in which the toner cartridge 100 is not attached to the cartridge tray 3, the discharge port shutter 107 and the inlet port shutter 154 are held at closed positions by the urging force of the shutter springs 106 and 155. In the attachment process of the toner cartridge 100, the force receiving portion 107a of the discharge port shutter 107 abuts the pressed portion 154a of the inlet port shutter 154. The force receiving portion 107a faces downstream in the attachment direction T of the toner cartridge 100, and the pressed portion 154a faces upstream in the attachment direction T.

When the toner cartridge 100 is further moved in the attachment direction T from the state of FIG. 39A, the discharge port shutter 107 and the inlet port shutter 154 each start moving. At the abutment portion between the force receiving portion 107a and the pressed portion 154a, the discharge port shutter 107 receives a force in a direction opposite to the attachment direction T from the inlet port shutter 154, and the inlet port shutter 154 receives a force in the attachment direction T from the discharge port shutter 107. As a result of this, the discharge port shutter 107 moves from the closed position to the open position against the urging force of the shutter spring 106 as illustrated in FIG. 39B. In addition, the inlet port shutter 154 moves from the closed position to the open position against the urging force of the shutter spring 155.

As illustrated in FIG. 39B, when the toner cartridge 100 is at the attached position, the discharge port 111 of the toner cartridge 100 and the toner inlet port 130a of the developing unit 8 are both open and oppose each other. The inner space (toner storage portion 110) of the toner cartridge 100 and the inner space (developing chamber 133) of the developing unit 8 communicate with each other via the discharge port 111 and the toner inlet port 130a. Therefore, toner replenishment of the developing unit 8 from the toner cartridge 100 is allowed.

### Drive Transmission to Toner Cartridge

Drive transmission from the developing unit 8 to the toner cartridge 100 will be described with reference to FIG. 40. FIG. 40 is a section view of the developing unit 8 and the toner cartridge 100 in a cross-section orthogonal to the longitudinal direction (plane passing through at least one of the gear train 100G of the toner cartridge 100).

As illustrated in FIG. 40, the toner cartridge 100 is provided with the gear train 100G, and the developing unit 8 is provided with a cartridge driving gear 161. In the case where the developing unit 8 is viewed in the attachment direction T of the toner cartridge 100 in a state in which the toner cartridge 100 is not attached, at least part of the cartridge driving gear 161 is exposed to the outside of the developing frame 132 (also see FIG. 5A). In addition, in the case where the toner cartridge 100 is viewed in a direction opposite to the attachment direction T, at least part of the drive input gear 120 is exposed to the outside of the frame 100F (storage frame 102) of the toner cartridge 100 (also see FIG. 9A).

When the toner cartridge 100 is attached to the developing unit 8 of the cartridge tray 3, the cartridge driving gear 161 engages with the drive input gear 120. As a result of this, a state in which drive is transmitted from the drive source of the apparatus main body 2 to the toner cartridge 100 via the developing unit 8 can be realized by a simple operation of attaching the toner cartridge 100 in the attachment direction T.

Specifically, when a driving force is input from the motor M1 (FIG. 1) of the apparatus main body 2 to the developing unit 8, the driving force is transmitted to the drive input gear 120 of the toner cartridge 100 via the cartridge driving gear 161. The driving force input to the drive input gear 120 is distributed to the toner agitation member 108 and the toner conveyance member 109 by the gear train 100G (also see FIG. 8), and the toner agitation member 108 and the toner conveyance member 109 are rotationally driven.

Position of Rolling Member in Longitudinal direction

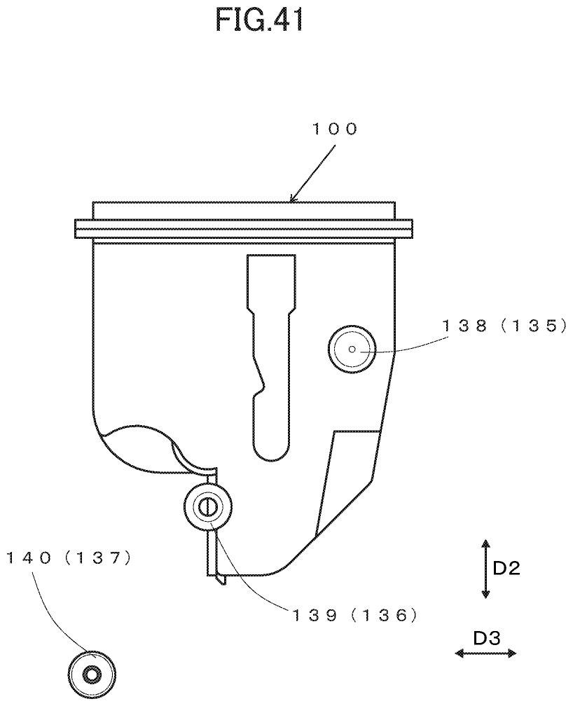

The positional relationship between the toner cartridge 100 and each rolling member of the developing unit 8 in the attachment completion state of the toner cartridge 100 will be described. FIG. 41 is a schematic view of part of the developing unit 8 and the toner cartridge 100 as viewed in the longitudinal direction (drum axis direction D1) in the attachment completion state of the toner cartridge 100. In FIG. 41, only the fourth roller 138, the fifth roller 139, and the sixth roller 140 that are rolling members on the driving side in the developing unit 8 are illustrated.

As illustrated in FIG. 41, as viewed in the longitudinal direction (drum axis direction D1) in the attachment completion state of the toner cartridge 100, at least one rolling member provided in the developing unit 8 overlaps with the toner cartridge 100. In the present embodiment, the fourth roller 138 and the fifth roller 139 among the rolling members on the driving side overlap with the toner cartridge 100. In the present embodiment, the sixth roller 140 is positioned outside the outline of the toner cartridge 100. Also on the non-driving side, the first roller 135 and the second roller 136 overlap with the toner cartridge 100 as viewed in the longitudinal direction (drum axis direction D1) in the attachment completion state of the toner cartridge 100. To be noted, the number and combination of the rolling members that overlap with the toner cartridge 100 are not limited to the example described above.

As described above, each rolling member (135 to 140) of the developing unit 8 has a function related to holding, positioning, and moving of the developing unit 8 with respect to the tray frame 30. In addition, when attaching or detaching the toner cartridge 100, the developing unit 8 receives a force from the toner cartridge 100. Members (position where the force acts) that receive force in the developing unit 8 from the toner cartridge 100 when attaching or detaching the toner cartridge 100 include the grooves 151 and 152, the inlet port shutter 154, the cartridge driving gear 161, and the locking spring 153. To be noted, the members that receive the force and the position where the force acts can change in accordance with the specific configuration of the developing unit 8 and the toner cartridge 100.

Since at least one rolling member overlaps with the toner cartridge 100 as viewed in the longitudinal direction, at least one rolling member is at a position near the position where the force acts on the developing unit 8 when attaching or detaching the toner cartridge 100. Therefore, even if the developing unit 8 receives force as a result of attachment or detachment of the toner cartridge 100, the tray frame 30 can hold the developing unit 8 more stably, and thus the posture change of the developing unit 8 can be suppressed.

To be noted, although an example in which the rolling members on the driving side overlap with the rolling members on the non-driving side is illustrated in FIG. 41, a positional relationship in which the rolling members on the driving side do not overlap with the rolling members on the non-driving side may be employed. That is, in the illustrated example, the first roller 135, the second roller 136, and the third roller 137 on the driving side respectively overlap with the fourth roller 138, the fifth roller 139, and the sixth roller 140. The configuration is not limited to this, and for example, a positional relationship in which the first roller 135 does not overlap with the fourth roller 138 as viewed in the longitudinal direction may be employed.

### Switch Between Abutting State and Separated State by Separation Member

An operation to switch the developing unit 8 between the abutting state and the separated state by using the separation member 170 will be described.

Switching the developing unit 8 from the abutting state to the separated state will be referred to as a developing separation operation or simply a “separation operation”. Switching the developing unit 8 from the separated state to the abutting state will be referred to as a developing abutment operation or simply an “abutment operation”. In the separation operation, the developing unit 8 moves from the abutting position to the separated position, and the developing roller 6 is separated from the photosensitive drum 4. In the abutment operation, the developing unit 8 moves from the separated position to the abutting position, and the developing roller 6 approaches and abuts the photosensitive drum 4.

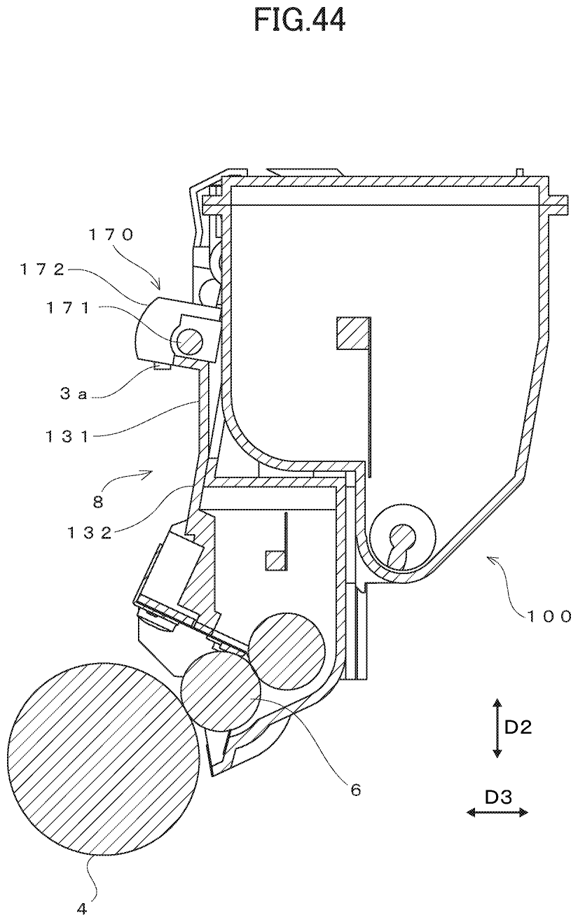

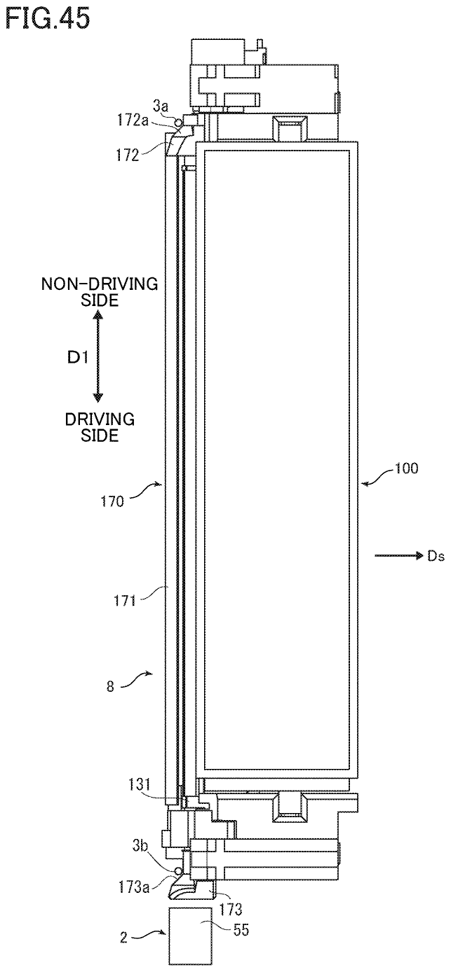

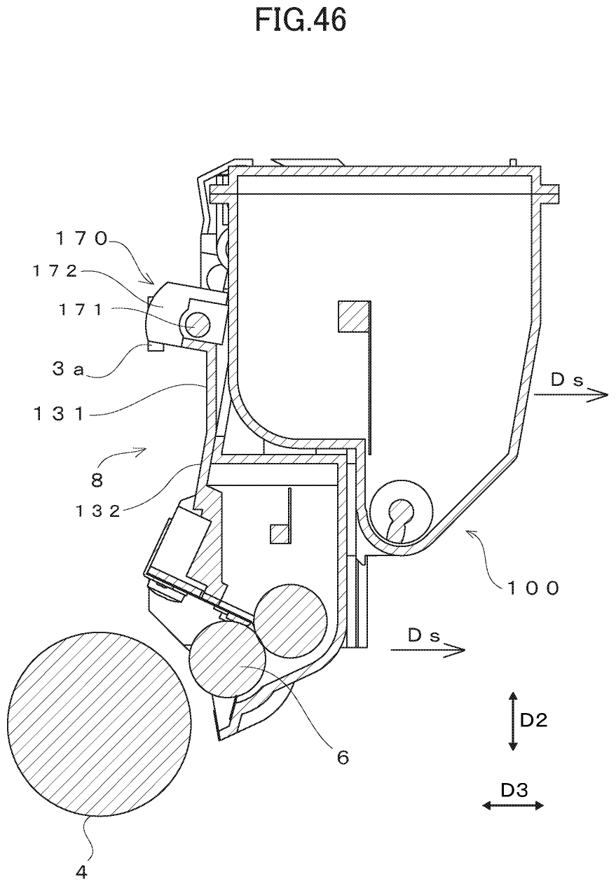

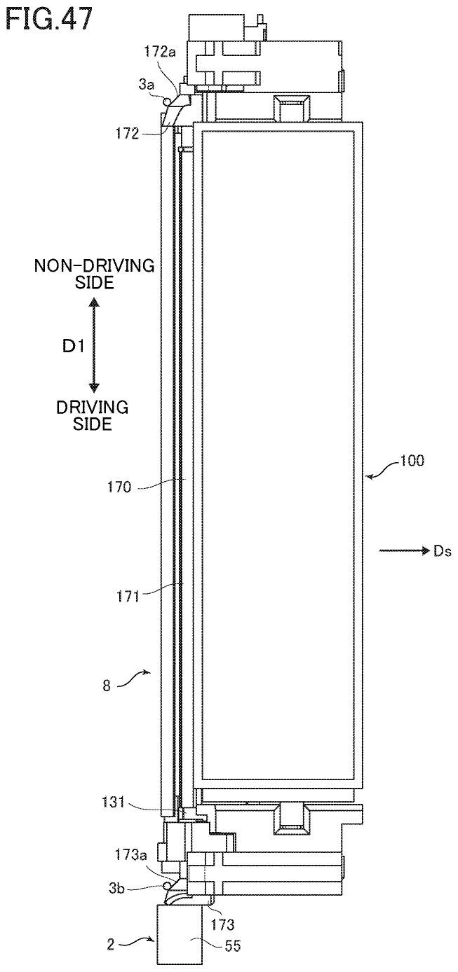

FIGS. 44 and 45 are each a diagram illustrating the abutting state of the developing unit 8. FIGS. 46 and 47 are each a diagram illustrating the separated state of the developing unit 8. FIGS. 44 and 46 are each a section view of the photosensitive drum 4, the developing unit 8, and the toner cartridge 100 as viewed in the longitudinal direction. FIGS. 45 and 47 are each a diagram illustrating the developing unit 8, the toner cartridge 100, and the force applying member 55 as viewed in the cartridge attachment/detachment direction D2.

The separation member 170 is movable between a driving-side position (first position) illustrated in FIG. 45 and a non-driving-side position (second position) illustrated in FIG. 47 with respect to the developing frame 132. The non-driving-side position is a position that is on the non-driving side in the drum axis direction D1 with respect to the driving-side position.

As illustrated in FIGS. 45 and 47, the apparatus main body 2 includes the force applying member 55 that applies a force to the separation member 170. The apparatus main body 2 of the present embodiment includes four force applying members 55 disposed at positions respectively corresponding to the second cams 173 of the four developing units 8. The force applying member 55 is configured to be movable in the drum axis direction D1 between a standby position (retracted position) illustrated in FIG. 45 and a pressing position (FIG. 47) that is on the non-driving side of the standby position. In the present embodiment, the force applying member 55 at the standby position is not in contact with the second cam 173, and the force applying member 55 comes into contact with the second cam 173 in the course of movement from the standby position to the pressing position to move the separation member 170 toward the non-driving side.

The drive source for moving the force applying member 55 is not particularly limited, and a plunger solenoid or a motor may be used as the drive source. In the case of using a plunger solenoid provided in the apparatus main body 2 as the drive source, the force applying member 55 may be a plunger (or a member that moves in conjunction with the plunger). In the case of using a motor provided in the apparatus main body 2 as the drive source, the force applying member 55 may be a member that is connected to the motor via, for example, a rack-and-pinion mechanism, and that reciprocates in the drum axis direction D1 by the driving force of the motor. This motor may be the motor M1 (FIG. 1) that drives the photosensitive drum 4 and the developing roller 6.

When the developing unit 8 is coupled to the cartridge tray 3, the developing roller 6 abuts the photosensitive drum 4 as illustrated in FIG. 44. In the abutting state of the developing unit 8, as illustrated in FIG. 45, the first inclined surface 172a of the first cam 172 does not come into contact with the first guide roller 3a, and the second inclined surface 173a of the second cam 173 does not come into contact with the second guide roller 3b. In addition, the force applying member 55 is at the standby position immediately after the developing unit 8 is coupled to the cartridge tray 3.

In the case of separating the developing roller 6 from the photosensitive drum 4, the force applying member 55 moves from the standby position to the pressing position as illustrated in FIGS. 46 and 47. When the second cam 173 is pressed by the force applying member 55, the separation member 170 moves toward the non-driving side in the drum axis direction D1. At this time, the separation member 170 moves toward the non-driving side in the drum axis direction D1 with respect to the developing frame 132 (sub frame 131) and the developing roller 6 against the urging force of the separation urging spring 175. Then, the first inclined surface 172a of the first cam 172 comes into contact with the first guide roller 3a, and the second inclined surface 173a of the second cam 173 comes into contact with the second guide roller 3b.

As a result of the inclination of the first inclined surface 172a and the second inclined surface 173a, the first cam 172 and the second cam 173 receive a force in the separation direction Ds from the first guide roller 3a and the second guide roller 3b in accordance with the movement of the separation member 170 toward the non-driving side.

The separation member 170 is relatively movable in the drum axis direction D1 with respect to the developing frame 132 (sub frame 131), and the relative movement thereof in the separation direction Ds is restricted. Therefore, the developing frame 132 moves in the separation direction Ds by the force in the separation direction Ds that the separation member 170 receives from the first guide roller 3a and the second guide roller 3b serving as guide portions provided in the tray frame 30.

As described above, when the force applying member 55 is moved from the standby position to the pressing position, the separation member 170 moves in the separation direction Ds together with the developing frame 132 while moving toward the non-driving side with respect to the developing frame 132 in the drum axis direction D1. As a result of this, the developing roller 6 supported by the developing frame 132 moves in the separation direction Ds and is separated from the photosensitive drum 4 (FIG. 46). In other words, when the separation member 170 (movable member) moves from the driving-side position (first position) toward the non-driving-side position (second position), the first cam 172 and the second cam 173 (first abutting portion and second abutting portion) respectively abut the first guide roller 3a and the second guide roller 3b (first abutted portion and second abutted portion) and receive a force in the separation direction Ds (intersecting direction). As a result of this, the developing frame 132 moves in the separation direction Ds together with the separation member 170, and the developing roller 6 is separated from the photosensitive drum 4. To be noted, the developing unit 8 can move in the separation direction Ds against the pressurizing force of the pressurizing unit 180 (FIG. 25) by the force that the separation member 170 receives from the first guide roller 3a and the second guide roller 3b.

As described above, by moving the force applying member 55 from the standby position to the pressurizing position, the developing unit 8 can be switched from the abutting state to the separated state. In other words, the separation operation of the developing unit 8 is performed by moving the force applying member 55 from the standby position to the pressurizing position.

In contrast, when the force applying member 55 is moved from the pressing position to the standby position, the separation member 170 moves toward the driving side in the drum axis direction D1 by the urging force of the separation urging spring 175 of the separation member 170. In addition, the separation member 170 moves also in a direction opposite to the separation direction Ds along the inclination of the first inclined surface 172a and the second inclined surface 173a by the pressurizing force in the direction opposite to the separation direction Ds received from the pressurizing unit 180. The separation member 170 moves in the direction opposite to the separation direction Ds together with the developing frame 132 while moving toward the driving side with respect to the developing frame 132 in the drum axis direction D1. As a result of this, the developing roller 6 supported by the developing frame 132 moves in the direction opposite to the separation direction Ds and abuts the photosensitive drum 4 (FIG. 44).

As described above, by moving the force applying member 55 from the pressing position to the standby position, the developing unit 8 can be switched from the separated state to the abutting state. In other words, the abutment operation of the developing unit 8 is performed by moving the force applying member 55 from the pressing position to the standby position.

### Overview of First Embodiment

For example, the configuration described in the present embodiment has the following advantages. To be noted, the following advantages are merely examples, and it goes without saying that the present embodiment has various advantages that are obvious from the configuration thereof.

When moving the developing unit 8, the first guide roller 3a and the second guide roller 3b each rotate about an axis intersecting with the drum axis direction D1. As a result of this, for example, as compared with a configuration in which the first inclined surface 172a and the second inclined surface 173a of the developing unit 8 receive a force in the separation direction Ds by sliding on guide portions fixed to the tray frame 30, the frictional resistance between the developing unit 8 and the tray frame 30 is reduced.

That is, by providing the first guide roller 3a and the second guide roller 3b that rotate in contact with the developing unit 8 during the separation operation of the developing unit 8, the movement of the developing unit 8 can be made smoother. In addition, by providing the first guide roller 3a and the second guide roller 3b that rotate in contact with the developing unit 8 during the abutment operation of the developing unit 8, the movement of the developing unit 8 can be made smoother.

In addition, at least one rolling member (135 to 140) of the developing unit 8 can rotate in contact with the tray frame 30 (first frame) when the developing roller 6 comes into contact with or separates from the photosensitive drum 4. As a result of this, for example, as compared with a case where an unrotatable cylindrical member provided in the developing unit 8 comes into contact with the tray frame 30, the frictional resistance between the developing unit 8 and the tray frame 30 can be reduced, and the movement of the developing unit 8 can be made smoother. During the separation operation and the abutment operation of the developing unit 8, although all the rolling members (135 to 140) provided in the developing unit 8 may rotate, a configuration in which only some of the rolling members rotate in contact with the tray frame 30 may be employed.

For example, as illustrated in FIG. 29, when the developing unit 8 moves in the separation direction Ds by the separation operation, the first roller 135, the second roller 136, and the third roller 137 on the non-driving side each move in the separation direction Ds (the positions thereof after the movement are indicated by broken lines). At this time, the second roller 136 and the third roller 137 can respectively rotate in contact with the abutting portion 183b of the non-driving-side guide 183 and the positioning portion 183a of the non-driving-side guide 183. Also when the developing unit 8 moves in the direction (arrow U direction) opposite to the separation direction Ds by the abutment operation, the second roller 136 and the third roller 137 can respectively rotate in contact with the abutting portion 183b and the positioning portion 183a. Similarly, the fifth roller 139 and the sixth roller 140 on the driving side can respectively rotate in contact with the abutting portion 186b and the positioning portion 186a during the separation operation and the abutment operation. Further, during the separation operation and the abutment operation, the first roller 135 and the fourth roller 138 can rotate in contact with the pressing surface 184b of the pressing members 184 on the driving side and the non-driving-side attached to the tray frame 30.

In the present embodiment, the abutting portion 183b, the positioning portion 183a, the abutting portion 186b, and the positioning portion 186a are each an example of an abutting surface extending in the intersecting direction (in the present embodiment, the separation direction Ds and the direction opposite thereto) intersecting with the drum axis direction D1. Each rolling member serving as a rotary member described above rotates in contact with the abutting surface when the developing roller 6 comes into contact with or separates from the photosensitive drum 4. As a result of this, the movement of the developing unit 8 in the intersecting direction can be made smoother.

That is, by providing a rolling member that rotates in contact with the tray frame 30 during the separation operation of the developing unit 8 in the developing unit 8, the movement of the developing unit 8 can be made smoother. In addition, by providing a rolling member that rotates in contact with the tray frame 30 during the abutment operation of the developing unit 8 in the developing unit 8, the movement of the developing unit 8 can be made smoother.

In addition, in the present embodiment, the toner cartridge 100 moves in the separation direction Ds together with the developing unit 8 in a state in which the toner cartridge 100 is attached to the attachment portion 150 of the developing unit 8. Since not only the weight of the developing unit 8 but also the weight of the toner cartridge 100 is put on the contact portion between the developing unit 8 and the tray frame 30, a normal force generated at the contact portion is large. Therefore, the movement of the developing unit 8 and the toner cartridge 100 can be made smoother by a configuration that reduces the frictional resistance between the developing unit 8 and the tray frame 30 described above.

Regarding the separation member 170, the first cam 172 and the second cam 173 are provided at respective end portions of the shaft 171. Therefore, when switching the developing unit 8 between the separated state and the abutting state, inclination of the separation member 170 in which the shaft 171 obliquely intersects with the drum axis direction D1 can be suppressed. Since the inclination of the separation member 170 is suppressed, the inclination of the developing frame 132 and the developing roller 6 can be suppressed.

By suppressing the inclination of the developing frame 132, increase in the frictional resistance in the movement of the developing unit 8 caused by the inclination of the developing frame 132 can be suppressed, and smoother movement of the developing unit 8 can be realized. In addition, if the developing roller 6 is inclined and the driving-side end or the non-driving-side end of the developing roller 6 is separated from the photosensitive drum 4 in a state after the abutment operation, an image defect such as unevenness of density of the toner image in the drum axis direction D1 can occur. The configuration of the present embodiment can contribute to realization of high image quality by the suppression of the inclination of the developing roller 6.

In addition, since the first cam 172 and the second cam 173 are provided at respective end portions of the shaft 171, the driving side and the non-driving side of the developing unit 8 can be moved together by applying a force in the drum axis direction D1 from one side of the separation member 170 in the drum axis direction D1. Therefore, for example, as compared with a case where independent force applying members that respectively drive the first cam 172 and the second cam 173 are respectively provided on the driving side and the non-driving side of the developing unit 8, the mechanism for applying the force to the separation member 170 can be simplified. Therefore, the configuration of the present embodiment can contribute to reduction of the cost and the size of the image forming apparatus 1.

In addition, the separation member 170 and the rotary members (rolling members) that are members related to the movement of the developing unit 8 and the toner cartridge 100 are provided in the developing unit 8. As a comparative example of the present embodiment, a configuration in which the separation member 170 and the rotary members (rolling members) are provided in the toner cartridge 100 and the abutting state and the separated state are switched as a result of the developing unit 8 moving together with the toner cartridge 100 can be considered. As compared with the comparative example, the present embodiment does not require the separation member 170 and the rotary members (rolling members) to be provided in the toner cartridge 100. That is, since the configuration can be simplified by reducing the number of parts in the toner cartridge 100 that is more frequently replaced than the developing unit 8, the running cost of the image forming apparatus 1 can be reduced.

The toner cartridge 100 is positioned between the position (L2 of FIG. 43A) of the driving-side end of the second inclined surface 173a in the abutting state and the position (L1 of FIG. 43B) of the non-driving-side end of the first inclined surface 172a in the separated state in the drum axis direction D1. In other words, in the drum axis direction D1 (first direction), the toner cartridge 100 is positioned between the end portion position (L2) on the driving side (second end side) of the second inclined surface 173a when the separation member 170 (movable member) is at the driving-side end position (first position) and the end portion position (L1) on the non-driving side (first end side) of the first inclined surface 172a when the separation member 170 (movable member) is at the non-driving-side end position (second position). That is, the area occupied by the toner cartridge 100 falls within a range that is on the inside of outer ends of a range in which the inclined surfaces provided at respective ends of the separation member 170 in the drum axis direction D1 moves.

Here, designing an image forming apparatus of a developing cartridge system in which the developing unit 8 is attachable to and detachable from part (drum unit) of the cartridge tray 3 other than the developing unit 8 by using the configuration of the present embodiment can be considered. In this case, since the range occupied by the tone cartridge 100 in the present embodiment is on the inside of the two outer ends of the range described above, the configuration of the present embodiment can be also used for the configuration of the two ends of the developing unit 8 in the drum axis direction D1. Therefore, the same parts can be used and thus the cost can be reduced.

As viewed in the attachment direction of the toner cartridge 100 to the cartridge tray 3, the separation member 170 and the toner cartridge 100 are aligned with each other in a direction (for example, the tray movement direction D3) orthogonal to the drum axis direction D1 (first direction) (FIGS. 43A and 43B). As a result of this arrangement, the separation member 170 does not interrupt the attachment and detachment of the toner cartridge 100, and thus the attachment and detachment of the toner cartridge 100 to and from the cartridge tray 3 can be performed more easily.

In the drum axis direction D1 (longitudinal direction), the rotary members (rolling members) of the developing unit 8 are disposed on the outside of the toner cartridge 100. In other words, in the drum axis direction D1 (first direction), the rotary members (rolling members) are disposed on the outside of a range from one end to the other end of the toner cartridge 100 attached to the attachment portion 150 in the drum axis direction D1.

In the present embodiment, each rolling member (135 to 140) of the developing unit 8 is provided on the outside of the first side portion 130D and the second side portion 130N of the developing frame 132 in the longitudinal direction (FIGS. 9A and 10A). In contrast, the toner cartridge 100 is attached to the attachment portion 150 between the first side portion 130D and the second side portion 130N of the developing frame 132. In the case where a rotary member (rolling member) protrudes to the inside with respect to the first side portion 130D or the second side portion 130N, providing a recess portion, a cutout shape, or the like for avoiding interference with the rotary member (rolling member) in the toner cartridge 100 can be considered. In contrast, according to the present embodiment, a recess portion, a cutout shape, or the like for avoiding interference does not need to be provided in the toner cartridge 100, thus the capacity of the toner cartridge 100 can be increased, or the shapes of the parts of the toner cartridge 100 can be simplified.

As viewed in the drum axis direction D1 (first direction), at least one rotary member (rolling member) of the developing unit 8 is at a position overlapping with the toner cartridge 100 (FIG. 41). That is, at least one rolling member is positioned at a position close to the position where a force acts on the developing unit 8 when attaching or detaching the toner cartridge 100. Therefore, even when the developing unit 8 receives a force by the attachment or detachment of the toner cartridge 100, the tray frame 30 can hold the developing unit 8 more stably, and thus the posture change of the developing unit 8 can be suppressed.

As viewed in the drum axis direction D1 (longitudinal direction), at least one rotary member (rolling member) among a plurality of rotary members (rolling members) is disposed at a position farther from the photosensitive drum 4 than the developing roller 6 is. For example, as illustrated in FIG. 9B, the distance from the first roller 135 or the second roller 136 to the photosensitive drum 4 is larger than the distance from the developing roller 6 to the photosensitive drum 4. In addition, as illustrated in FIG. 10B, the distance from the fourth roller 138 or the fifth roller 139 to the photosensitive drum 4 is larger than the distance from the developing roller 6 to the photosensitive drum 4. Also in the separated state of the developing unit 8, these rotary members (rolling members) are positioned farther from the photosensitive drum 4 than the developing roller 6 is.

As a result of the rotary member (rolling member) being positioned farther from the photosensitive drum 4 than the developing roller 6 is, the posture change of the developing unit 8 during the separation operation can be reduced, and the behavior of the developing unit 8 can be stabilized more.

### Modification Examples

In the first embodiment, a configuration in which detachment of the developing unit 8 from the cartridge tray 3 by the user is not considered has been described. The configuration is not limited to this, and for example, by omitting the locking member 192, an image forming apparatus of a developing cartridge system in which the developing unit 8 is attachable to and detachable from part (drum unit) of the cartridge tray 3 excluding the developing unit 8 may be designed. According to this configuration, the developing unit 8 can be replaced by the user when consumption of members in the developing unit 8 progresses, and thus high image quality can be maintained for a long period.

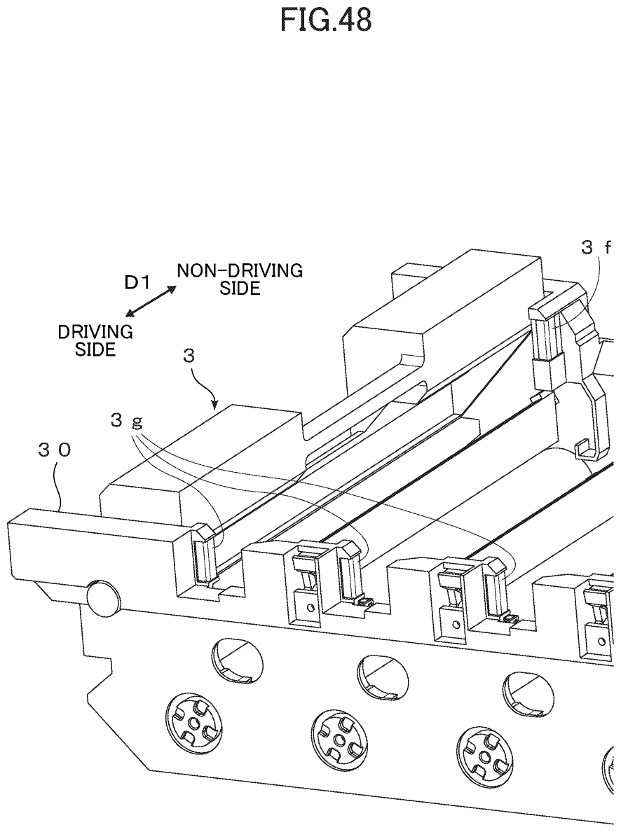

In the first embodiment, a configuration in which a first guide roller 3a and a second guide roller 3b serving as rotatable guide portions (first abutted portion and second abutted portion) are provided in the tray frame 30 has been described. However, as illustrated in FIG. 48, a first guide portion 3f and a second guide portion 3g fixed to the tray frame 30 may be used. Except that the first guide portion 3f and the second guide portion 3g do not rotate in contact with the first cam 172 and the second cam 173 when the separation member 170 is moved, the function of the first guide portion 3f and the second guide portion 3g is the same as that of the first guide roller 3a and the second guide roller 3b in the first embodiment. The first guide portion 3f and the second guide portion 3g configured in this manner may be formed from metal such as a metal plate or resin such as polyacetal (POM). By using the first guide portion 3f and the second guide portion 3g that do not rotate, the cost of the cartridge tray 3 can be reduced.

In the first embodiment, the separation member 170 includes the first cam 172 and the second cam 173 at respective end portions thereof in the drum axis direction D1. However, the separation member 170 may include only one cam corresponding to the first cam 172 or the second cam 173 of the first embodiment at one of the two end portions thereof in the drum axis direction D1. Also in this configuration, the separation operation and the abutment operation of the developing unit 8 can be realized in accordance with the movement of the separation member 170 in the drum axis direction D1 if one of the first inclined surface 172a and the second inclined surface 173a is provided. In addition, for example, the shaft 171, the first cam 172, and the second cam 173 may be integrally formed from a resin material.

Each element described in the modification examples described above may be appropriately combined as long as the combination is not contradictory.

### Second Embodiment

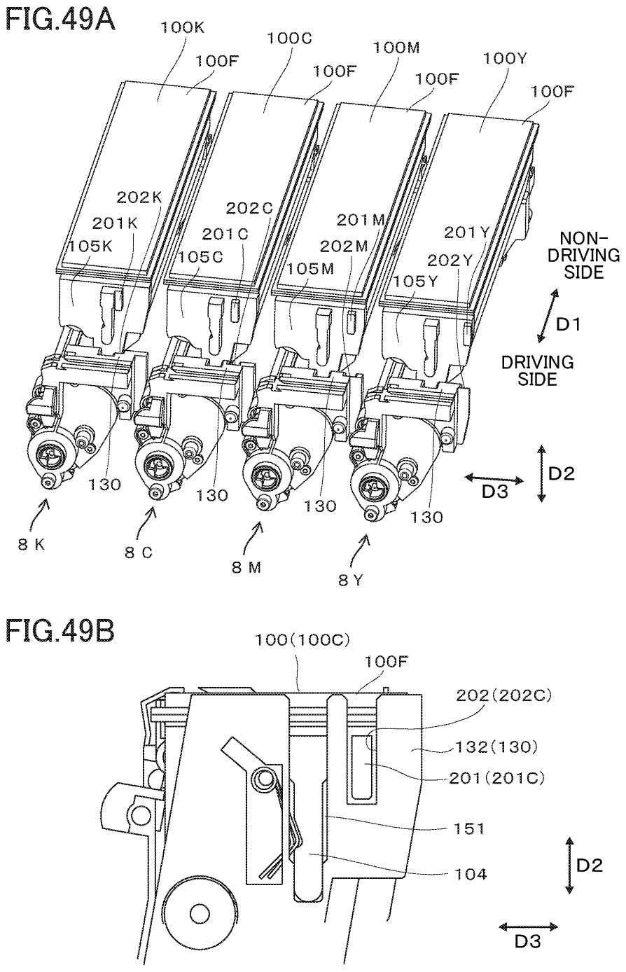

As another embodiment (second embodiment), an image forming apparatus 1 having a configuration related to suppression of erroneous attachment of the toner cartridge 100 will be described with reference to FIGS. 49A to 53. In the description below, it is assumed that elements denoted by the same reference signs as in the first embodiment have basically the same configurations and functions as in the first embodiment unless described otherwise, and part different from the first embodiment will be mainly described.

FIG. 49A is a perspective view of four toner cartridges 100Y, 100M, 100C, and 100K and four developing units 8Y, 8M, 8C, and 8K included in the image forming apparatus 1. FIG. 49B is a section view of an engagement portion between one toner cartridge 100 and one developing unit 8 as viewed in the drum axis direction D1 (longitudinal direction). In FIG. 49A, the toner cartridges 100Y, 100M, 100C, and 100K are respectively arranged above corresponding ones of the developing units 8Y, 8M, 8C, and 8K.

As illustrated in FIG. 49B, the cover member 105 of each toner cartridge 100 is provide with a protrusion 201 serving as an engaging portion. That is, as illustrated in FIG. 49A, the toner cartridge 100Y includes a first protrusion 201Y. The toner cartridge 100M includes a second protrusion 201M. The toner cartridge 100C includes a third protrusion 201C. The toner cartridge 100K includes a fourth protrusion 201K.

The four protrusions 201Y, 201M, 201C, and 201K are each disposed at a different position in the toner cartridge 100 depending on the type of the toner cartridge 100 (toner color). Specifically, the positions of the protrusions 201Y, 201M, 201C, and 201K with respect to the frame 100F of the toner cartridge 100 differ from each other in a direction (tray movement direction D3) orthogonal to both the longitudinal direction (drum axis direction D1) and the cartridge attachment/detachment direction D2.

In other words, the position of the first engaging portion with respect to the frame of the first toner cartridge and the position of the second engaging portion with respect to the frame of the second toner cartridge are different. For example, the toner cartridge 100K will be referred to as a first toner cartridge, and the toner cartridge 100C will be referred to as a second toner cartridge. In this case, the first engaging portion of the first toner cartridge 100K is the protrusion 201K serving as a first protrusion portion extending in the attachment direction T. The second engaging portion of the second toner cartridge 100C is the protrusion 201C serving as a second protrusion portion extending in the attachment direction T. A first groove portion 202K serving as a first engaged portion extending in the attachment direction T and a second groove portion 202C serving as a second engaged portion extending in the attachment direction T are provided in the cartridge tray 3. Further, in a direction intersecting with the attachment direction, the position of the protrusion 201K (first protrusion portion) with respect to the frame of the first toner cartridge 100K and the position of the protrusion 201C (second protrusion portion) with respect to the frame of the second toner cartridge 100C are different.

The first protrusion 201Y is disposed at one end (front end) of the frame 100F of the toner cartridge 100Y. The second protrusion 201M is disposed at a first interval from one end toward the other end of the frame 100F of the toner cartridge 100M. The third protrusion 201C is disposed at a second interval larger than the first interval from one end toward the other end of the frame 100F of the toner cartridge 100C. The fourth protrusion 201K is disposed at a third interval larger than the second interval from one end toward the other end of the frame 100F of the toner cartridge 100K.

A groove portion 202 (FIG. 49B) serving as an engaged portion is formed in the developing frame 132 (main frame 130) of each developing unit 8. The groove portion 202 of each developing unit 8 is provided so as to engage with the protrusion 201 of the corresponding one of the toner cartridges 100. The four groove portions 202 are disposed at different positions in accordance with the type of the developing unit 8 (toner color). That is, as illustrated in FIG. 49A, the groove portion 202Y of the developing unit 8Y is formed at a position corresponding to the protrusion 201Y of the toner cartridge 100Y. The groove portion 202M of the developing unit 8M is formed at a position corresponding to the protrusion 201M of the toner cartridge 100M. The groove portion 202C of the developing unit 8C is formed at a position corresponding to the protrusion 201C of the toner cartridge 100C. The groove portion 202K of the developing unit 8K is formed at a position corresponding to the protrusion 201K of the toner cartridge 100K.

The plurality of protrusions 201 and the plurality of groove portions 202 are configured to engage with each other when the developing unit 8 and the toner cartridge 100 are coupled in a correct combination and not engage with each other when the developing unit 8 and the toner cartridge 100 are coupled in an incorrect combination. That is, the protrusion 201 and the groove portion 202 engage with each other in only four combinations of the protrusion 201Y and the groove portion 202Y, the protrusion 201M and the groove portion 202M, the protrusion 201C and the groove portion 202C, and the protrusion 201K and the groove portion 202K.

To be noted, although a configuration in which the position of the protrusion 201 and the position of the groove portion 202 differ depending on the toner color has been described in the present embodiment, a different configuration may be used as long as the engagement between the engaging portion and the engaged portion is allowed only in the correct combinations. For example, the shape of the protrusion 201 and the shape of the groove portion 202 may differ depending on the toner color. In addition, for example, the combination of the position and shape of the protrusion 201 and the combination of the position and shape of the groove portion 202 may differ depending on the toner color.

FIG. 49B illustrates the developing unit 8C and the toner cartridge 100C as an example of a section view illustrating the developing unit 8 and the toner cartridge 100 correctly attached to the developing unit 8.

As illustrated in FIG. 49B, a clearance is set between the outer surface of the protrusion 201 (201C) and the inner wall of the groove portion 202 (202C). By setting this clearance, the protrusion 201 and the groove portion 202 can be engaged with each other without interrupting the positioning of the toner cartridge 100 by the engagement between the guide 104 and the groove 151 described in the first embodiment.

In FIG. 49B, an example in which the protrusion 201 and the groove portion 202 are engaged in the attachment completion state of the toner cartridge 100 is illustrated. The configuration is not limited to this, and a configuration in which the protrusion 201 (engaging portion) and the groove portion 202 (engaged portion) are engaged in the attachment process of the toner cartridge 100 and are not engaged in the attachment completion state may be employed.

In addition, the developing unit 8 may be coupled to the cartridge tray 3 similarly to the first embodiment, or a developing cartridge attachable to and detachable from the tray frame 30.

### Interference in Erroneous Attachment

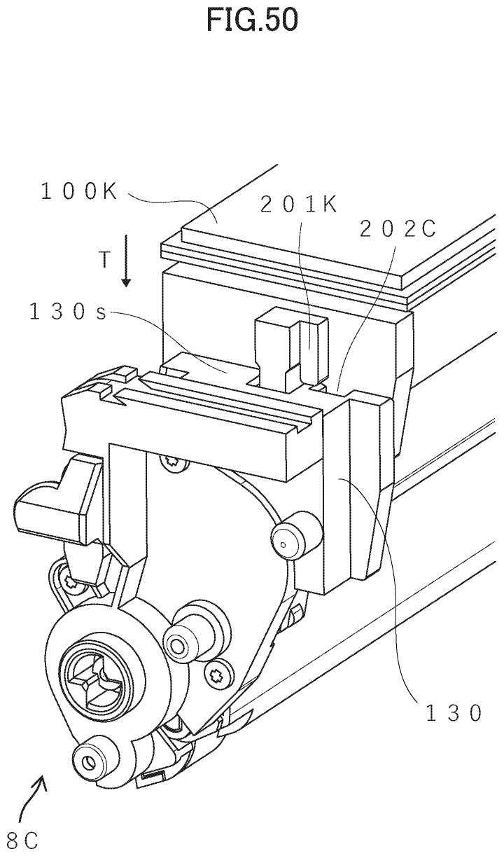

A case where it is attempted to attach the toner cartridge 100 to the developing unit 8 in an incorrect combination will be described with reference to FIG. 50. Here, as an example of an incorrect combination, a case where it is attempted to attach the toner cartridge 100K to the developing unit 8C will be described. FIG. 50 is a perspective view of part of the developing unit 8C and part of the toner cartridge 100K.

As illustrated in FIG. 50, the protrusion 201K of the toner cartridge 100K is at a position not corresponding to the groove portion 202C of the developing unit 8C. Therefore, when it is attempted to attach the toner cartridge 100K to the developing unit 8C, the protrusion 201K does not enter the groove portion 202C, and comes into contact with the upper surface 130s of the main frame 130 on the outside of the groove portion 202C. As a result of the interference between the protrusion 201K and the main frame 130, further movement of the toner cartridge 100K in the attachment direction T from the state of FIG. 50 is interrupted. That is, since the protrusion 201K does not engage with the groove portion 202C, the toner cartridge 100K cannot be attached to the developing unit 8C.

As a result of the interference between the protrusion 201K and the main frame 130, the movement of the toner cartridge 100K in the attachment direction T is interrupted before the discharge port shutter 107 moves from the closed position to the open position (see FIG. 39A). In addition, as a result of the interference between the protrusion 201K and the main frame 130, the movement of the toner cartridge 100K in the attachment direction T is interrupted before the inlet port shutter 154 moves from the closed position to the open position (see FIG. 39A). As described above, since the attachment of the toner cartridge 100K is interrupted before the discharge port 111 and the toner inlet port 130a are opened, mixing of the black toner in the toner cartridge 100K with the cyan toner in the developing unit 8C can be suppressed. Also in the cases where it is attempted to attach the toner cartridge 100 to the developing unit 8 in other incorrect combinations, attachment of the toner cartridge 100 is interrupted before the discharge port 111 and the toner inlet port 130a are opened, and mixing of colors of toner can be suppressed.

It may be preferable that the positional relationship between the protrusion 201, the groove portion 202, the force receiving portion 107a, and the pressed portion 154a is set such that the movement of the toner cartridge 100 in the attachment direction T is interrupted before the force receiving portion 107a and the pressed portion 154a (FIG. 39A) come into contact with each other. As a result of this, in the case where it is attempted to attach the toner cartridge 100 to the developing unit 8 in an incorrect combination, toner leakage from the toner cartridge 100 can be suppressed.

### Interference With Body Opening

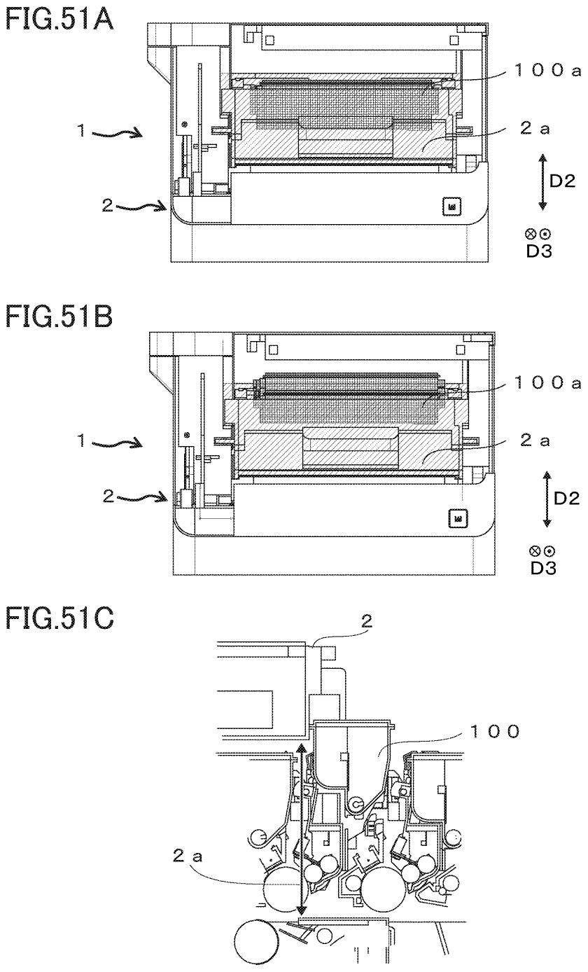

The relationship between the position of the toner cartridge 100 and the opening of the apparatus main body 2 in the case where it is attempted to attach the toner cartridge 100 to the developing unit 8 in an incorrect combination will be described with reference to FIGS. 51A to 51C. FIGS. 51A and 51B are each a section view of the image forming apparatus 1 in a plane orthogonal to the tray movement direction D3. FIG. 51C is a section view of the image forming apparatus 1 in a plane orthogonal to the drum axis direction D1 corresponding to the state of FIG. 51B.

The position of the toner cartridge 100 in the case where the toner cartridge 100 is attached to the developing unit 8 in a correct combination will be referred to as a normal position. The position of the toner cartridge 100 when the movement of the toner cartridge 100 in the attachment direction T is interrupted by the interference between the protrusion 201 and the main frame 130 in the case where it is attempted to attach the toner cartridge 100 to the developing unit 8 in an incorrect combination will be referred to as an abnormal position.

In the case where the toner cartridge 100 is at the normal position, a projected area 100a (region with square hatching) of the toner cartridge 100 as viewed in the tray movement direction D3 falls within the body opening 2a (region with diagonal hatching) of the apparatus main body 2 as illustrated in FIG. 51A. Therefore, the cartridge tray 3 can be inserted from the outer position to the inner position without the toner cartridge 100 touching the opening edge of the body opening 2a. To be noted, the body opening 2a is an opening provided in the apparatus main body 2, and allows the cartridge tray 3 to move between the inner position and the outer position with respect to the apparatus main body 2 (also see FIGS. 2A and 2B).

In the case where the toner cartridge 100 is at the abnormal position, at least part of the projected area 100a (region with square hatching) of the toner cartridge 100 as viewed in the tray movement direction D3 protrudes to the outside of the body opening 2a (region with diagonal hatching) as illustrated in FIG. 51B. Therefore, the toner cartridge 100 touches the opening edge of the body opening 2a as illustrated in FIG. 51C, and the cartridge tray 3 cannot be inserted from the outer position to the inner position. Since the attachment of the cartridge tray 3 is interrupted, the user can be provided with an opportunity to realize that the toner cartridge 100 of a wrong type is attached.

In addition, the toner cartridge 100 positioned at the abnormal position protrudes higher than the toner cartridge 100 positioned at the normal position. Therefore, the user can easily visually recognize that the toner cartridge 100 of a wrong type is attached.

### Overview of Present Embodiment

The image forming apparatus 1 according to the present embodiment has the following configuration. One of the plurality of toner cartridges 100Y, 100M, 100C, and 100K included in the image forming apparatus 1 can be referred to as a first toner cartridge, and another one of the toner cartridges can be referred to as a second toner cartridge. For example, in the description below, the toner cartridge 100K will be referred to as a first toner cartridge, and the toner cartridge 100C will be referred to as a second toner cartridge.

The first toner cartridge 100K includes the protrusion 201K serving as a first engaging portion, and the second toner cartridge 100C includes the protrusion 201C serving as a second engaging portion. The cartridge tray 3 (pull-out unit) includes a first attachment portion (attachment portion 150 of the developing unit 8K), a second attachment portion (attachment portion 150 of the developing unit 8C), the groove portion 202K serving as a first engaged portion, and the groove portion 202C serving as a second engaged portion.

In the case where the first toner cartridge 100K is attached to the first attachment portion, the protrusion 201K (first engaging portion) engages with the groove portion 202K (first engaged portion). In addition, in this case, the entirety of the first toner cartridge 100K is inside the body opening 2a as viewed in the movement direction (tray movement direction D3) of the cartridge tray 3.

Similarly, in the case where the second toner cartridge 100C is attached to the second attachment portion, the protrusion 201C (second engaging portion) engages with the groove portion 202C (second engaged portion). In addition, in this case, the entirety of the second toner cartridge 100C is inside the body opening 2a as viewed in the movement direction (tray movement direction D3) of the cartridge tray 3.

In contrast, in the case where the first toner cartridge 100K is attached to the second attachment portion, the protrusion 201K (first engaging portion) does not engage with the groove portion 202C (second engaged portion). In addition, in this case, at least part of the first toner cartridge 100K is outside the body opening 2a as viewed in the movement direction (tray movement direction D3) of the cartridge tray 3.

Similarly, in the case where the second toner cartridge 100C is attached to the first attachment portion, the protrusion 201C (second engaging portion) does not engage with the groove portion 202K (first engaged portion). In addition, in this case, at least part of the second toner cartridge 100C is outside the body opening 2a as viewed in the movement direction (tray movement direction D3) of the cartridge tray 3.

Therefore, when the first toner cartridge 100K and the second toner cartridge 100C are attached to correct positions, the attachment of the cartridge tray 3 to the apparatus main body 2 is allowed. In contrast, when the first toner cartridge 100K or the second toner cartridge 100C is attached to an incorrect position, the attachment of the cartridge tray 3 to the apparatus main body 2 is interrupted, and therefore the user can be provided with an opportunity to notice the erroneous attachment of the toner cartridge.

In addition, the first toner cartridge 100K includes the discharge port shutter 107 serving as a shutter that covers the discharge port 111. In a state in which the first toner cartridge 100K is not attached to the first attachment portion, the discharge port shutter 107 is at the closed position. In the process of attaching the first toner cartridge 100K to the first attachment portion, the discharge port shutter 107 abuts part of the cartridge tray (pull-out unit), and thus the discharge port shutter 107 moves from the closed position to the open position. In addition, in the case where the first toner cartridge 100K is attached to the second attachment portion, the protrusion 201K (first engaging portion) comes into contact with the cartridge tray 3 before the discharge port shutter 107 abuts part of the cartridge tray 3 (pull-out unit), and thus the movement of the first toner cartridge 100K in the attachment direction T is interrupted. In this manner, toner leakage can be suppressed.

Here, although the toner cartridges 100K and 100C have been described as examples, the types and number of the toner cartridges are not limited to this, and the present technique is applicable to an image forming apparatus including a plurality of toner cartridges.

### Modification Examples

In the second embodiment, a configuration in which attachment of the toner cartridge 100 of a wrong type is suppressed by an engaged portion provided in the developing unit 8 has been described. As a modification example, a configuration in which attachment of the toner cartridge 100 of a wrong type is suppressed by an engaged portion provided in the tray frame 30 of the cartridge tray 3 will been described.

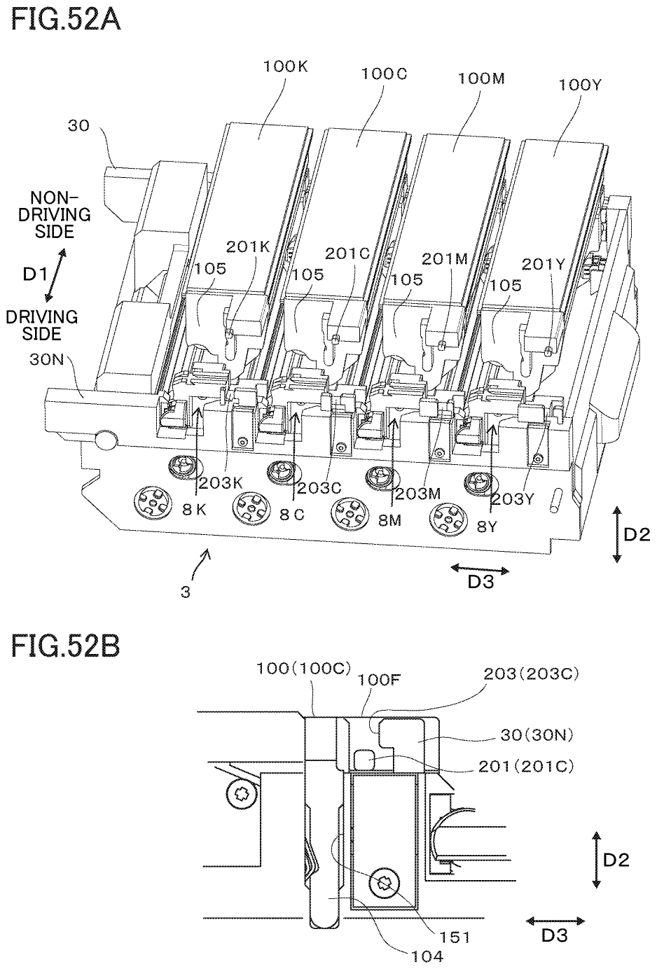

FIG. 52A is a perspective view of the four toner cartridges 100Y, 100M, 100C, and 100K and the cartridge tray 3 included in the image forming apparatus 1 of the present modification example. FIG. 52B is a section view of the engagement portion between one toner cartridge 100 and one developing unit 8 as viewed in the drum axis direction D1 (longitudinal direction). FIG. 52A illustrates the toner cartridges 100Y, 100M, 100C, and 100K respectively arranged above corresponding ones of the developing units 8Y, 8M, 8C, and 8K.

As illustrated in FIG. 52B, the cover member 105 of each toner cartridge 100 is provide with the protrusion 201 serving as an engagement portion. That is, as illustrated in FIG. 52A, the toner cartridge 100Y includes the first protrusion 201Y. The toner cartridge 100M includes the second protrusion 201M. The toner cartridge 100C includes the third protrusion 201C. The toner cartridge 100K includes the fourth protrusion 201K.

The four protrusions 201Y, 201M, 201C, and 201K are each disposed at different position in the toner cartridge 100 depending on the type of the toner cartridge 100 (toner color). Specifically, the positions of the protrusions 201Y, 201M, 201C, and 201K with respect to the frame 100F of the toner cartridge 100 differ from each other in a direction (tray movement direction D3) orthogonal to both the longitudinal direction (drum axis direction D1) and the cartridge attachment/detachment direction D2.

The first protrusion 201Y is disposed at one end (front end) of the frame 100F of the toner cartridge 100Y. The second protrusion 201M is disposed at a first interval from one end toward the other end of the frame 100F of the toner cartridge 100M. The third protrusion 201C is disposed at a second interval larger than the first interval from one end toward the other end of the frame 100F of the toner cartridge 100C. The fourth protrusion 201K is disposed at a third interval larger than the second interval from one end toward the other end of the frame 100F of the toner cartridge 100K.

Groove portions 203 (FIG. 52B) serving as engaged portions are formed in the tray frame 30 (driving-side frame 30D) of the cartridge tray 3. Each groove portion 203 is provided so as to engage with the protrusion 201 of the corresponding one of the toner cartridges 100. The four groove portions 203 are disposed at different positions in accordance with the type of the corresponding toner cartridge 100 (toner color). That is, as illustrated in FIG. 52A, the first groove portion 203Y is formed at a position corresponding to the protrusion 201Y of the toner cartridge 100Y. The second groove portion 203M is formed at a position corresponding to the protrusion 201M of the toner cartridge 100M. The third groove portion 203C is formed at a position corresponding to the protrusion 201C of the toner cartridge 100C. The fourth groove portion 203K is formed at a position corresponding to the protrusion 201K of the toner cartridge 100K.

The plurality of protrusions 201 and the plurality of groove portions 203 are configured to engage with each other when the developing unit 8 and the toner cartridge 100 are coupled in a correct combination and not engage with each other when the developing unit 8 and the toner cartridge 100 are coupled in an incorrect combination. That is, the protrusion 201 and the groove portion 203 engage with each other in only four combinations of the protrusion 201Y and the groove portion 203Y, the protrusion 201M and the groove portion 203M, the protrusion 201C and the groove portion 203C, and the protrusion 201K and the groove portion 203K.

To be noted, although a configuration in which the position of the protrusion 201 and the position of the groove portion 203 differ depending on the toner color has been described in the present embodiment, a different configuration may be used as long as the engagement between the engaging portion and the engaged portion is allowed only in the correct combinations. For example, the shape of the protrusion 201 and the shape of the groove portion 203 may differ depending on the toner color. In addition, for example, the combination of the position and shape of the protrusion 201 and the combination of the position and shape of the groove portion 203 may differ depending on the toner color.

FIG. 52B illustrates the toner cartridge 100C as an example of a section view of the toner cartridge 100 correctly attached to the cartridge tray 3.

As illustrated in FIG. 52B, a clearance is set between the outer surface of the protrusion 201 (201C) and the inner wall of the groove portion 203 (203C). By setting this clearance, the protrusion 201 and the groove portion 203 can be engaged with each other without interrupting the positioning of the toner cartridge 100 by the engagement between the guide 104 and the groove 151 described in the first embodiment.

In FIG. 52B, an example in which the protrusion 201 and the groove portion 203 are engaged in the attachment completion state of the toner cartridge 100 is illustrated. The configuration is not limited to this, and a configuration in which the protrusion 201 (engaging portion) and the groove portion 203 (engaged portion) are engaged in the attachment process of the toner cartridge 100 and are not engaged in the attachment completion state may be employed.

In addition, the developing unit 8 may be coupled to the cartridge tray 3 similarly to the first embodiment, or may be a developing cartridge attachable to and detachable from the tray frame 30.

### Interference in Erroneous Attachment

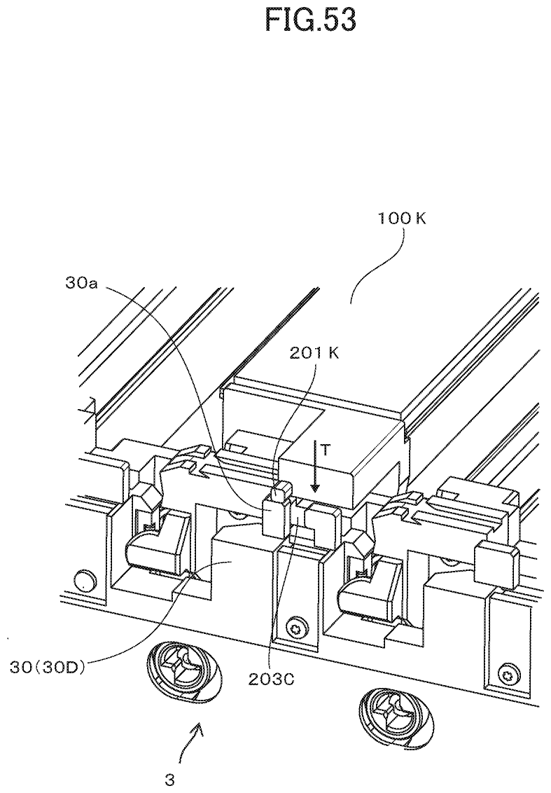

A case where it is attempted to attach the toner cartridge 100 to a wrong position will be described with reference to FIG. 53. Here, a case where it is attempted to erroneously attach the toner cartridge 100K to a position to which the toner cartridge 100C is supposed to be attached will be described. FIG. 53 is a perspective view of part of the cartridge tray 3 and the toner cartridge 100K.

As illustrated in FIG. 53, the protrusion 201K of the toner cartridge 100K is at a position not corresponding to the groove portion 203C. Therefore, when it is attempted to attach the toner cartridge 100K, the protrusion 201K does not enter the groove portion 203C, and comes into contact with part (contact portion 30a) of the tray frame 30 on the outside of the groove portion 203C. As a result of the interference between the protrusion 201K and the tray frame 30, further movement of the toner cartridge 100K in the attachment direction T from the state of FIG. 53 can be interrupted. That is, since the protrusion 201K does not engage with the groove portion 203C, the toner cartridge 100K cannot be attached to the cartridge tray 3.

As a result of the interference between the protrusion 201K and the tray frame 30, the movement of the toner cartridge 100K in the attachment direction T is interrupted before the discharge port shutter 107 moves from the closed position to the open position (see FIG. 39A). In addition, as a result of the interference between the protrusion 201K and the tray frame 30, the movement of the toner cartridge 100K in the attachment direction T is interrupted before the inlet port shutter 154 moves from the closed position to the open position (see FIG. 39A). As described above, since the attachment of the toner cartridge 100K is interrupted before the discharge port 111 and the toner inlet port 130a are opened, mixing of the black toner in the toner cartridge 100K with the cyan toner in the developing unit 8C can be suppressed. Also in the cases where it is attempted to attach the toner cartridge 100 to the developing unit 8 in other incorrect combinations, attachment of the toner cartridge 100 is interrupted before the discharge port 111 and the toner inlet port 130a are opened, and mixing of colors of toner can be suppressed.

It may be preferable that the positional relationship regarding the protrusion 201, the groove portion 203, the force receiving portion 107a, and the pressed portion 154a is set such that the movement of the toner cartridge 100 in the attachment direction T is restricted before the force receiving portion 107a and the pressed portion 154a (FIG. 39A) come into contact with each other. As a result of this, in the case where it is attempted to attach the toner cartridge 100 to a wrong position, toner leakage from the toner cartridge 100 can be suppressed.

The position of the toner cartridge 100 in the case where the toner cartridge 100 is attached to a correct position on the cartridge tray 3 will be referred to as a normal position. The position (FIG. 53) of the toner cartridge 100 when the movement of the toner cartridge 100 in the attachment direction T is interrupted by the interference between the protrusion 201 and the tray frame 30 in the case where it is attempted to attach the toner cartridge 100 to a wrong position on the cartridge tray 3 will be referred to as an abnormal position.

Similarly to the second embodiment, in the case where the toner cartridge 100 is at the abnormal position, attachment of the cartridge tray 3 to the apparatus main body 2 is interrupted by the interference of the toner cartridge 100 with the opening edge of the body opening 2a. As a result of this, the user can be provided with an opportunity to realize that the toner cartridge 100 is attached to a wrong position.

### Other Embodiments

The present disclosure is not limited to the embodiments described above, and for example, all or some of the different embodiments described above may be combined for implementation.

An image forming apparatus that can meet various needs has been desired in recent years.

According to the present disclosure, a new embodiment of the image forming apparatus can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-071833, filed Apr. 23, 2025, which is hereby incorporated by reference herein in its entirety.

What is claimed is:

1. An image forming apparatus comprising:
an apparatus main body;
a pull-out unit that includes a photosensitive drum configured to rotate about a rotation axis extending in a first direction, a first frame configured to support the photosensitive drum, and a developing unit, and that is movable between an inner position where the pull-out unit is accommodated in the apparatus main body and an outer position to which the pull-out unit is pulled out from the inner position toward an outside of the apparatus main body; and
a toner cartridge that is configured to store toner to be supplied to the developing unit and that is attachable to and detachable from the developing unit in a case where the pull-out unit is at the outer position,
wherein the developing unit includes
(i) a developing roller configured to supply the toner to the photosensitive drum,
(ii) a second frame configured to support the developing roller and movable with respect to the first frame such that the developing roller comes into contact with and separates from the photosensitive drum, and
(iii) a rotary member disposed to protrude in the first direction with respect to an end surface of the second frame in the first direction and configured to rotate in contact with the first frame in a case where the developing roller comes into contact with or separates from the photosensitive drum.

2. The image forming apparatus according to claim 1,
wherein the toner cartridge is configured to move together with the second frame in the case where the developing roller comes into contact with or separates from the photosensitive drum.

3. The image forming apparatus according to claim 1,
wherein the first frame includes an abutting surface extending in an intersecting direction intersecting with the first direction, and
wherein the rotary member rotates in contact with the abutting surface in the case where the developing roller comes into contact with or separates from the photosensitive drum.

4. The image forming apparatus according to claim 1,
wherein in a case where the rotary member is a first rotary member, the image forming apparatus further comprises:
a second rotary member disposed on an opposite side to the first rotary member in the first direction with respect to the second frame and configured to rotate in contact with the first frame in the case where the developing roller comes into contact with or separates from the photosensitive drum.

5. An image forming apparatus comprising:
an apparatus main body;
a pull-out unit that includes a photosensitive drum configured to rotate about a rotation axis extending in a first direction, a first frame configured to support the photosensitive drum, and a developing unit, and that is movable between an inner position where the pull-out unit is accommodated in the apparatus main body and an outer position to which the pull-out unit is pulled out from the inner position toward an outside of the apparatus main body; and
a toner cartridge that is configured to store toner to be supplied to the developing unit and that is attachable to and detachable from the developing unit in a case where the pull-out unit is at the outer position,
wherein the developing unit includes
(i) a developing roller configured to supply the toner to the photosensitive drum,
(ii) a second frame configured to support the developing roller and movable with respect to the first frame such that the developing roller comes into contact with and separates from the photosensitive drum, and
(iii) a rotary member disposed to protrude in the first direction with respect to an end surface of the second frame in the first direction and configured to rotate in contact with the first frame in a case of attaching the developing unit to the first frame.

6. The image forming apparatus according to claim 1,
wherein the rotary member is disposed outside a range from one end to another end in the first direction of the toner cartridge attached to the developing unit.

7. The image forming apparatus according to claim 1,
wherein the rotary member overlaps with the toner cartridge as viewed in the first direction.

8. The image forming apparatus according to claim 1,
wherein the second frame is provided with a shaft portion extending in the first direction, and
wherein the rotary member is supported by the shaft portion, and configured to rotate about the shaft portion.

9. An image forming apparatus comprising:
an apparatus main body;
a pull-out unit that includes a photosensitive drum configured to rotate about a rotation axis extending in a first direction, a first frame configured to support the photosensitive drum, and a developing unit, and that is movable between an inner position where the pull-out unit is accommodated in the apparatus main body and an outer position to which the pull-out unit is pulled out from the inner position toward an outside of the apparatus main body; and
a toner cartridge that is configured to store toner to be supplied to the developing unit and that is attachable to and detachable from the developing unit in a case where the pull-out unit is at the outer position,
wherein the developing unit includes
(i) a developing roller configured to supply the toner to the photosensitive drum,
(ii) a second frame configured to support the developing roller and movable in an intersecting direction intersecting with the first direction with respect to the first frame, and
(iii) a movable member that is movable in the first direction between a first position and a second position with respect to the second frame and configured to move in the intersecting direction together with the second frame, the movable member including a shaft extending in the first direction, a first abutting portion provided on a first end side of the shaft in the first direction, and a second abutting portion provided on a second end side of the shaft in the first direction,
wherein the first frame is provided with a first abutted portion and a second abutted portion,
wherein the developing roller is configured to abut the photosensitive drum in a case where the movable member is positioned at the first position, and
wherein the first abutting portion and the second abutting portion are configured to abut the first abutted portion and the second abutted portion, respectively, to receive force in the intersecting direction in a case where the movable member moves from the first position toward the second position, such that the developing roller separates from the photosensitive drum.

10. The image forming apparatus according to claim 9,
wherein the first abutting portion includes a first inclined surface inclined such that a distance from an outer surface of the shaft to the first inclined surface in a direction orthogonal to the first direction increases as the first inclined surface extends in a direction from the first end side toward the second end side with respect to the first direction, and
wherein the second abutting portion includes a second inclined surface inclined such that a distance from the outer surface of the shaft to the second inclined surface in a direction orthogonal to the first direction increases as the second inclined surface extends in the direction from the first end side toward the second end side with respect to the first direction.

11. The image forming apparatus according to claim 10,
wherein in the first direction, the toner cartridge is positioned between (a) a position of an end portion of the second inclined surface on the second end side in a case where the movable member is at the first position and (b) a position of an end portion of the first inclined surface on the first end side in a case where the movable member is at the second position.

12. The image forming apparatus according to claim 9,
wherein the movable member and the toner cartridge are aligned in a direction orthogonal to the first direction as viewed in a direction in which the toner cartridge is attached to the pull-out unit.

13. The image forming apparatus according to claim 9,
wherein the movable member overlaps with the toner cartridge as viewed in a movement direction of the pull-out unit in which the pull-out unit moves between the inner position and the outer position.

14. The image forming apparatus according to claim 9,
wherein each of the first abutted portion and the second abutted portion is a guide roller rotatably attached to the first frame.

15. An image forming apparatus comprising:
an apparatus main body having an opening;
a pull-out unit that includes a first attachment portion and a second attachment portion and that is movable between an inner position and an outer position through the opening, the inner position being a position where the pull-out unit is accommodated in the apparatus main body, the outer position being a position to which the pull-out unit is pulled out from the inner position toward an outside of the apparatus main body;
a first toner cartridge that is configured to store first toner and that is attachable to and detachable from the first attachment portion in a case where the pull-out unit is at the outer position; and
a second toner cartridge that is configured to store second toner and that is attachable to and detachable from the second attachment portion in the case where the pull-out unit is at the outer position,
wherein the first toner cartridge includes a first engaging portion,
wherein the second toner cartridge includes a second engaging portion,
wherein the pull-out unit includes a first engaged portion and a second engaged portion,
wherein in a case where the first toner cartridge is attached to the first attachment portion, the first engaging portion engages with the first engaged portion, and entirety of the first toner cartridge is inside the opening as viewed in a movement direction in which the pull-out unit moves from the outer position toward the inner position,
wherein in a case where the second toner cartridge is attached to the second attachment portion, the second engaging portion engages with the second engaged portion, and entirety of the second toner cartridge is inside the opening as viewed in the movement direction,
wherein in a case where the first toner cartridge is attached to the second attachment portion, the first engaging portion does not engage with the second engaged portion, and at least part of the first toner cartridge is outside the opening as viewed in the movement direction, and
wherein in a case where the second toner cartridge is attached to the first attachment portion, the second engaging portion does not engage with the first engaged portion, and at least part of the second toner cartridge is outside the opening as viewed in the movement direction.

16. The image forming apparatus according to claim 15,
wherein the first toner cartridge includes a toner storage portion configured to store the first toner and provided with a discharge port, and a shutter movable between a closed position to close the discharge port and an open position to open the discharge port,
wherein the shutter is at the closed position in a state in which the first toner cartridge is not attached to the first attachment portion,
wherein in a process of attaching the first toner cartridge to the first attachment portion, the shutter abuts the pull-out unit and thus moves from the closed position to the open position, and
wherein in a case of attaching the first toner cartridge to the second attachment portion, the first engaging portion comes into contact with the pull-out unit before the shutter abuts the pull-out unit, and thus movement of the first toner cartridge in a direction in which the first toner cartridge is attached to the pull-out unit is interrupted.

17. The image forming apparatus according to claim 15,
wherein a position of the first engaging portion with respect to a frame of the first toner cartridge and a position of the second engaging portion with respect to a frame of the second toner cartridge are different.

18. The image forming apparatus according to claim 17,
wherein the first engaging portion is a first protrusion portion extending in an attachment direction of the first toner cartridge to the first attachment portion,
wherein the first engaged portion is a first groove portion configured to receive the first protrusion portion,
wherein the second engaging portion is a second protrusion portion extending in the attachment direction,
wherein the second engaged portion is a second groove portion configured to receive the second protrusion portion, and
wherein in a direction intersecting with the attachment direction, a position of the first protrusion portion with respect to the frame of the first toner cartridge and a position of the second protrusion portion with respect to the frame of the second toner cartridge are different.

19. The image forming apparatus according to claim 15,
wherein the first engaging portion and the second engaging portion are different in shape.

20. The image forming apparatus according to claim 15,
wherein the pull-out unit includes a first photosensitive drum, a first developing unit configured to supply the first toner to the first photosensitive drum, a second photosensitive drum, and a second developing unit configured to supply the second toner to the second photosensitive drum.
